(19) United States
(12) Patent Application Publication
(10) Pub. No.: US 2014/0371931 A1
(43) Pub. Date: Dec. 18, 2014

(54) W5RS: Anlinx & Milinx & Zilinx - the 23Less Green Technology for FSOC of Scalable iPindow of iPhome & Scalable Smart Window of Smart Home with Wire/Wireless/Solar/Battery Communication, Power Supplies & Conversions

(71) Applicants: Mei-Jech Lin, San Jose, CA (US); Eric Yu-Shiao Tarng, San Jose, CA (US); Alfred Yu-Chi Tarng, San Jose, CA (US); Angela Yu-Shiu Tarng, San Jose, CA (US); Huang-Chang Tarng, San Jose, CA (US)

(72) Inventors: Mei-Jech Lin, San Jose, CA (US); Eric Yu-Shiao Tarng, San Jose, CA (US); Alfred Yu-Chi Tarng, San Jose, CA (US); Angela Yu-Shiu Tarng, San Jose, CA (US); Huang-Chang Tarng, San Jose, CA (US)

(21) Appl. No.: 13/918,989

(22) Filed: Jun. 16, 2013

(51) Int. Cl. G05B 15/02; H01L 31/04

(52) U.S. Cl. CPC G05B 15/02; H02S 10/00
USPC 700/287

(57) ABSTRACT

For Scalable iPindow of iPhome & Scalable Smart Window of Smart Home, the Wireless Window 5R System W5RS is constituted of smart Multimedia Window, smart Electrochromic Window and smart Solar Window, etc. The smart Solar Window harvests solar energy to be electric energy to provide power to smart Multimedia Window and smart Electrochromic Window, etc. “W5RS” is the next generation standard. “5S” represents “Smart Solar Supply Silicon System”. “W5” represents “Wireless Wireline Weave Wishful Window”. “5R” represents “Recycling Resonant Resynchronization Rectifying Regulator”. “W5RS” is the killer application and “5R” is the killer core technology. For the WPC Qi and A4WP wireless power supply standards, the novel 5R can have the AC/DC power efficiency 95% which is the highest. The 23Less Green Technology are Noiseless Field System On Chip FSOC, Curtainless Window, Bladeless Turbofan, Brakeless Vehicle, Sawless LNA, Resistorless, Capless, Inductorless, Diodeless Random Number Generator, Xtaless Clock Generator, Clockless Switch Mode Power Supply, Ground-Bounceless I/O, Switch Lossless Rectifier, Power-Lossless PA, Rippleless and EMI-Less Battery Charger, Overshootless and Rippleless LDO.

### RELATED APPLICATIONS

This patent application is the Continuation in Part application claims priorities of application Ser. No. 12/422,719 filed Apr. 13, 2009, U.S. patent application Ser. No. 12/317,973, filed Dec. 31, 2008, now U.S. Pat. No. 8,089,324 issued on Jan. 3, 2012; U.S. patent application Ser. No. 12/291,984, filed Nov. 12, 2008, U.S. patent application Ser. No. 12/291,618, filed Nov. 12, 2008, now U.S. Pat. No. 7,876,188 issued on Jan. 25, 2011; U.S. patent application Ser. No. 12/288,770, filed Oct. 23, 2008, now U.S. Pat. No. 7,663,349 issued on Feb. 16, 2010; U.S. patent application Ser. No. 12/229,412, filed Aug. 23, 2008, now U.S. Pat. No. 8,089,323 issued on Jan. 3, 2012; U.S. patent application Ser. No. 12/082,601, filed Apr. 12, 2008; U.S. patent application Ser. No. 12/079,179, filed Mar. 25, 2008, now U.S. Pat. No. 8,089,353 issued on Jan. 3, 2012; U.S. patent application Ser. No. 11/593,271, filed Nov. 6, 2006, now U.S. Pat. No. 7,511,589; U.S. patent application Ser. No. 11/500,125, filed Aug. 5, 2006, now U.S. Pat. No. 7,525,392 issued on Apr. 28, 2009; U.S. patent application Ser. No. 892,358, filed Jul. 14, 1997, now U.S. Pat. No. 5,850,093; U.S. patent application Ser. No. 12/854,800, filed Mar. 23, 1992, now U.S. Pat. No. 5,280,200; U.S. patent application Ser. No. 81,074, filed Jun. 22, 1993, now U.S. Pat. No. 5,793,125; U.S. patent application Ser. No. 577,792, filed Sep. 5, 1990, now U.S. Pat. No. 5,198,691; U.S. patent application Ser. No. 577,791, filed Sep. 5, 1990, now U.S. Pat. No. 5,111,076; which herein incorporated by references in its entirety.

### BACKGROUND

1. Field of Invention

A Wireless Window 5R System W5RS is constituted of Multimedia Window. Electrochromic Window and Solar Window, etc. The Solar Cell Window harvests solar energy to be electric energy to provide power to Multimedia Window and Electrochromic Window. The electrical energy further provides to smart grid and mobile devices. W5RS is the new standard promoted by the innovative company Tang System. “W5” represents “Wireless Wireline Weave Wishful Window”. “5R” represents “Recycling Resonant Resynchronization Rectifying Regulator”. “5S” represents “Smart Solar Supply Silicon System”. “W5RS” is the killer product application of Silicon Valley and “5R” is the killer core IP technology of Silicon Valley. Even for the WPC Qi and A4WP wireless power supply standards, the novel “single stage” 5R can have the AC/DC power efficiency as high as 95% which is the highest record in all the world.

Green Technology means low power and low pollution. The 23Less core Green Technology includes the core technology of the 5R Recycling Resonant Resynchronization Rectifier Regulator for Green Power & Noise of Green Chip of the Scalable iPindow of iPhome & Scalable Smart Window. Green Technology is the low power, low noise, low pollution, recycling not only the resources but also the energy. The low pollution includes both low noisy and resource saving. The energy supplied for the house warming or cooling is the largest power consumption. The largest amount energy is released from the window of the house. We need to have the “self-contained and self-adaptive adjustable” Scalable iPindow of iPhome & Scalable Smart Window of Smart Home to adjust the light and heat in and out of the house. The smart window & iPindow had better to be “self-contained” that it doesn't need the external energy and extra wiring supplied to the self-adaptive adjustable iPindow/smart window. It is the Scalable iPindow of iPhome & Scalable Smart Window of Smart Home having wireless connection. Both the light and heat are transmitted through or reflected from the iPindow/smart window. The “self-contained and self-adaptive adjustable” control of the light and heat of the Scalable iPindow of iPhome & Scalable Smart Window of Smart Home is the cutting-edge next-generation integrated building management. The ElectroChromic EC window has the leaking current and the window controller has the stand-by power consumption. So, to be the green technology, the Scalable iPindow of iPhome & Scalable Smart Window of Smart Home has to be energy self-contained. The Solar smart window of the Scalable iPindow of iPhome & Scalable Smart Window of Smart Home can convert the sunlight energy to be the energy of battery, smart grid and electrochromic EC window, etc.

However, the barriers for the Scalable iPindow of iPhome & Scalable Smart Window of Smart Home are the cost, noise, comfort, functions, entertainment and power consumption of smart window. To have the individual control of the light, each light has the individual switch. To have the light dimmer control, the light switch is the dimmer switch. The Scalable iPindow of iPhome & Scalable Smart Window of Smart Home needs to cooperate with the dimmer light to have the light control that the Scalable iPindow of iPhome & Scalable Smart Window of Smart Home needs to be dimmer window. Each window needs one window controller to drive each dimmer window individually.

So, the green technology needs to improve the house energy to fill up the energy requirement. It needs to convert the conventional window to be the iPindow/Smart Window. It needs to incorporate the dimmer light, dimmer window, multimedia window and solar window, etc to be wireless network. The green technology for the smart window of multimedia window, solar window and EC window, etc includes the power, wireless in a noiseless and power saving RF platform, etc. Converting the AC sinusoidal wave power energy to DC energy with high power efficiency being larger than 95% is the cutting-edge 5R core technology of all the world.

The controller costs a lot that it has to be the integrated chip to save the cost budget. To integrate the controller to be integrated chip, it has to have the noise isolation technology. To have the wireless connection of the window, the RF power amplifier of the window controller needs to be very power efficient. The WiFi PA has only less than 15% power efficiency. For the WiFi standard, our Power-Lossless conjugated PA has the power efficiency more than 75% which is the record of the world. Furthermore, our Sawless LNA low noise amplifier works in the noiseless integrated chip with our Power-Lossless conjugated PA that our noise isolation technology is the key technology for the next-generation cutting-edge FSOC.

As the semiconductor device process continues shrinking down, the mask price and process price are much higher. The revenue of one-generation product cannot recover the investment. It needs the revenue of several generations product to cover the Non-recurring engineering (NRE) cost. So, all the chips will be forced to be FSOC. ASIC is Application Specific Integrated Circuit. FPGA is Field Programmable Gate Array and FSOC is the Field-System-On-Chip. For the Green Technology, FSOC will merge ASIC and FPGA together to be the last chip, Field-System-On-Chip. So far, there are ASIC and FPGA two categories. In the future, it will have FSOC. Field-System-On-Chip, only.

The 23Less Green Technologies for the FSOC of Scalable iPindow of iPhome & Scalable Smart Window of Smart Home with Wire/Wireless/Solar/Battery Power Supply & Conversion are as follows.

(1) Xtaless Clock;

(2) Inductorless SMPS;

(3) Capless LDO;

(4) Injectionless Lock PLL;

(5) Diodeless Random Generator;

(6) Resistorless Current Sensor;

(7) RF-Noiseless Window Driver;

(8) Rippleless Battery Charger;

(9) Curtainless Smart Window

(10) Brakeless Motor Vehicle

(11) H-Bridgeless AC|DC converter

(12) Filmless Touch Screen;

(13) Touchless Screen;

(14) Ground BounceLess I/O

(15) PowerLoss-Less 5R: Recycling Resonant Resynchronous Rectifier Regulator;

(16) Humidity-EMI-Less Xtaless LC Clock with plastic package;

(17) bladeless turbofan;

(18) H-Bridgeless Microinverter;

(19) Overshootless LDO

(20) Rippleless LDO

(21) Sawless LNA

(22) PowerLoss-Less PA

(23) Defectless Uniform multi-state dimmer EC Glass

FSOC of Anlinx, Milinx and Zilinx is the last Field-System-On-Chip. The Field-System-On-Chip FSOC of Anlinx, Milinx and Zilinx is based on the 23Less green technology to integrate the FPGA with ASIC to be the last field programmable FSOC. Thanks to the cooperative works of Dr. Mei Jech Lin, Eric Yu-Shiao Tarng, Alfred Yu-Chi Tarng, Angela Yu-Shiu Tarng, Huang-Chang Tarng, the revolutionary innovations had developed to be the FSOC of Anlinx, Milinx and Zilinx. The substrate noise is the barrier for the further system integration of the RF, AF, and Mixed Signal circuits with the FPGA. The RF, AF, Mixed Signal circuits still stay as the ASIC. However, to merge ASIC and FPGA together to be the FSOC, it needs the Noise Isolation Technology of Green Technology. With our 23Less Green Technology, we can generate the Noiseless Field Programmable Integrated Circuit FSOC. With our ultrasonic assisted deposition, platening and hardening process, the Defectless Uniform multi-state dimmer EC Glass can be achieved to make the smart EC Window to be able to be commercialized.

2. Description of Prior Art

W5RS is the new standard promoted by the innovative company Tang System. W5 is “Wireless, Wireline, Weave, Wishful, Window”. 5R is “Recycling, Resonant, Resynchronization, Rectifying, Regulator”. S is System and Supply. A Wireless Window 5R System W5RS is constituted of Multimedia Window, Electrochromic Window and Solar Window. The Solar Cell Window harvests solar energy to be electric energy to provide power to Multimedia Window and Electrochromic Window. The electrical energy further provides to smart grid and mobile devices. Before, the system integration among the multiple smart windows doesn't exist at all. The smart solar window doesn't exist. Electrochromic window consumes a lot of power due to the leakage of the electrochromic thin-film battery of the electrochromic glass. Multimedia window is not compatible with Electrochromic window. The Solar Window energy doesn't provide to smart grid and mobile devices, either.

Furthermore, the FPGA cannot integrate the ADC on the same chip. The switch noise generated by the FPGA will destroy all the performance of the high performance of ADC. Therefore, there is no high performance ADC on FPGA. The other RF/AF/analog cannot be integrated on FPGA, either. All these ADC and RF/AF/analog circuits are left to be on the ASIC chip. The chips are the noise generators. All the noise generated by the chips is dumped on the board. There is an implicit assumption that the board is the ground having the infinite capacitance. However, this implicit assumption is no more true as the mobile products becomes thin and small, there is no more the big board to serve as the ideal ground. Since there is no isolation technology in the conventional chip that the ASIC still has to be used. The noise isolation of the conventional chip adopts the multiple power and ground buses.

The thin film battery and Electronic Chromatic EC window technology have developed more than 80 years. However, due to the versatile technical barriers, the thin film and Electronic Chromatic EC window cannot be accepted by the market yet. One piece of small thin film battery and/or Electronic Chromatic EC window cost several hundred US dollars. It is out of consideration to be popular commercialization. Furthermore, the thin Film battery and Electronic Chromatic EC window also consumes power and is not user friendly. There is no industrial standard of the building management for the thin film battery and Electronic Chromatic EC window yet.

Furthermore, the thin Film Battery, Solar window and Electronic Chromatic EC window have the most difficult problem to be the “uniformity” of the thin Film Battery and Electronic Chromatic EC window. In the middle state, the non-uniformity of the Electronic Chromatic EC window will show up. To avoid the show up of the defect of the non-uniformity, the thin Film Battery, Solar window and Electronic Chromatic EC window operates at bi-state, bleach or color. Furthermore, as there are local defects, there is serious leakage that thin Film Battery, solar window and the Electronic Chromatic EC window failing to function.

### OBJECTS AND ADVANTAGES

The object is to promote the W5RS to be the international standard for the next generation green technology. A Wireless Window 5R System W5RS is constituted of Multimedia Window, Electrochromic Window and Solar Window. The Solar Cell Window harvests solar energy to be electric energy to provide power to Multimedia Window and Electrochromic Window. The electrical energy further provides to smart grid and mobile devices. Furthermore, this integration is extended to the Green Fields of the Scalable iPindow of iPhome & Scalable Smart Window of Smart Home to save the national energy consumption by more than 20% and have communication capabilities of phone, internet and TV services. Even for the WPC Qi and A4WP wireless power supply standards, the novel single stage 5R can have the AC/DC power efficiency as high as 95% which is the highest record in the world. “5S” represents “Smart Solar Supply Silicon System”. “W5” represents “Wireless Wireline Weave Wishful Window”. “5R” represents “Recycling Resonant Resynchronization Rectifying Regulator”. “W5RS” is the killer application product of Silicon Valley and “5R” is the killer core IP technology of Silicon Valley. Using the noise isolation technology to build up the platform to integrate all the FPGA and ASIC together to be FSOC. The green technology provides the complete set solution to save all the world energy consumption by more than half.

### DRAWING FIGURES

FIG. 1 (A) is the overall system of the Green Technology for the Scalable iPindow of iPhome & Scalable Smart Window of Smart Home includes multimedia window, the solar cell window, ventilation window, smart fan controller, humidity controller, the touch screen, touchless screen, battery and thin-film battery, smart fan EC window and dimmer light, etc; (B) is the architecture of the Scalable iPindow of iPhome & Scalable Smart Window of Smart Home; (C) is the Field System On Chip FSOC for the Scalable iPindow of iPhome & Scalable Smart Window of Smart Home which includes a lot of sub-modules listed at the bottom; (D) is the system and architecture of the multimedia iPindow of iPhome & multimedia Smart Window of Smart Home; (E1) is the cross-section of the touch-screen; (E2) is the top-view of the conventional touch-screen; (E3) is the top-view of the filmless touch-screen; (E4) is the touch on the top of the filmless touch-screen; (E5) is the equivalent circuit of the touch on the top of the filmless touch-screen; (E6) is the pulsing wave propagating in the conducting layer of the filmless touch screen; (F1) is the smart fan having the bladeless turbofan and humidity/de-humidity/filter air-conditional multi-function; (F2) is the section view of the smart fan embedded in the smart window; (F3) is the working principle of the bladeless turbofan; (F4A) is the diode characteristic curves over temperature; (F4B) is the temperature sensor circuit to measure the on-chip temperature for the smart ventilation window, etc; (G1) is the smart plug made of the FSOC; (G2) is the analogy between the phone plug and power plug; (G3) is the combinatory Phone Plug and Power Plug made of the FSOC for the Scalable iPindow of iPhome & Scalable Smart Window of Smart Home; (H1) is the AC/DC conversion of the rectifier and micro-inverter, etc with the H-bridge; (H2) is the Unipolar-DC/Bipolar-DC conversion of the battery charger and window driver, etc with H-bridge; (I) is the global view of the power conversions among different power resources; (J1) is the block diagram of the H-Bridgeless power conversion; (J2) is the circuit of H-Bridgeless power conversion injecting the power; (J3) is the circuit of H-Bridgeless power conversion extracting the power; (J4) is the timing diagram for the triggering action of the H-Bridgeless power conversion; (K) is one illustrated example to show the fundamental working principal of power re-cycling between the huge SMPS output switches to reduce the power switch loss especially in high-frequency switching operation; (L1) is the W5RS Window 5R System using the Wireless 5R Recycling Resonant Resynchronization Rectifier Regulator Supply and programmable LDOs of Analog LDO and Digital LDO; (L2) is the waveforms of the Analog LDO for the power supply of analog circuit of bandgap circuit, etc; (L3) is the waveform of the Digital LDO for the power supply of digital circuit of microprocessor, etc; (L4) is the comparisons between Analog LDO and Digital LDO.

FIG. 2 is the frequency impact on the Green Technology. (A) is the low frequency clock/signal waveform; (B) is the high frequency clock/signal waveform; (C) is the chain reaction mechanism of the frequency effect impact on the system integration; (D) is the performance degrade as the function of the frequency for the analog/ADC or RF/LNA circuit performance.

FIG. 3 is the conventional system; (A) is the partition of the system to be chips; (B) is the signal level and the substrate noise level of the chips.

FIG. 4 is the impact of the substrate noise coupling; (A) is the analog chip; (B) is the digital chip having the substrate noise; (C) is the substrate noise coupling in the integration of the analog chip and the digital chip; (D) is the noise coupling mechanism of the substrate noise.

FIG. 5 is the conventional digital and FPGA switching noise; (A) is the switching noise generated by the digital and/or FPGA chips; (B) is the switch noise augmented by the decoupling capacitor.

FIG. 6 is the introduction of the noise isolation technique; (A) is the conventional digital chip having the ground node (0 node) set at the board (B) is the ground nodes (0 node) in the SPICE simulation is set at the substrate of the chip; (C) is the noise isolation having the ground node (0 node) set at the board; (D) is the analogy of the magnetic shield for the heat isolation in the fusion chamber; (E) is the electric shield for the noise isolation in the planar chip.

FIG. 7 is the fundamental pattern of the noise isolation technique; (A) is the noise isolation for the digital chip having the noiseless substrate; the Kirchhoff's Current Law (KCL) shows that I_{U}=I_{B} that only one current regulator is needed; (B) is the analog circuit can co-exist in the same chip having noiseless substrate.

FIG. 8 is the substrate model; (A) is the substrate; (B) is the electric model for the substrate; (C) is the noise coupling in substrate model for noise isolation with separate ground buses; (D) is the hydraulic model for the noise coupling in substrate model for noise isolation with separate ground buses; (E) is the hydraulic model for the noise isolation technique; (F) is the electric model for the Noise Isolation Technology.

FIG. 9 is the analysis of the power and ground voltages in the noise-isolation technique; it proves that there is no substrate noise injection into the substrate; (A) is the capacitor with the current loop of charging and discharging; (B) is the capacitor with the current loop having the ground node of charging and discharging; (C) is the capacitor with the current loop having the ground node and substrate of charging and discharging; (D) is the Electric Field analogy of the Noise Isolation Technology; (E) is the power and ground voltages in the system integration with the noise isolation technology.

FIG. 10 is the comparisons to make the differential between the current regulator noise isolation platform and the voltage regulator analog-digital multi-power-bus platform; (A) is the noise isolation technique with the current regulator; (B) is the conventional analog chip to use the voltage regulator to get rid of the power supply noise by the factor PSRR power supply rejection ratio; (C) is the table of comparisons between the current regulator of the noise isolation technique and the voltage regulator of the analog chip in the noisy board environment; (D) is the switching operation of the voltage regulator; (E) is the switching operation of the current regulator.

FIG. 11 The comparison of voltage source and current source; (A) is the voltage source; (B) is the current source; (C) is the current source of the current regulator; (D) is the adaptive current source of the current regulator.

FIG. 12 is the comparisons of the current regulator and voltage regulator; (A) is the digital switching noises in the power supply; (B) is the spectrum of the power supply having the digital switching noise; (C1) is the waveforms of signals of current regulator; (C2) is the block diagram of the current regulator; (C3) is the spectrum of the input noise signal for the current regulator; (C4) is the spectrum of the control signal for the current regulator; (D1) is the waveforms of signals of voltage regulator; (D2) is the block diagram of the voltage regulator; (D3) is the spectrum of the input noise signal for the voltage regulator; (D4) is the spectrum of the control signal for the voltage regulator.

FIG. 13 is the average current generator for the current regulator; (A) is current average; (B) is the voltage average; (C) is the current average of the current regulator being implemented with the voltage average, (D1) is the preferred implementation of the current regulator which the pre-filter serves as the average function; (D2) is the alternative implementation of the current regulator which the post-filter serves as the average function; (D3) is the cascading current regulator which has the pre-filter, post-filter for the feedback signal and the filter for the feed forward output current.

FIG. 14 is the different ways to implement the average function; (A) is the block diagram of the average; (B) is the window function in the time domain to implement the average with the integration and divider; (C) is the timing window function to implement the average function; (D) is the low pass filter to implement the average function; (E1) is the waveform of the digital switching noise; (E2) is the sampling to implement the average function; (F) is the current regulator adopting the filter as shown in the FIG. 14D and the sampling as shown in FIG. 14E2 to get the average current for the P-P type cascading current regulator; (G) is the alternative implementation of the current regulator adopting the filter as shown in the FIG. 14D and the sampling as shown in FIG. 14E2 to get the average current for the P-N type cascading current regulator. It is noted that the current regulator having the filter Fp and Fn; the voltage regulator doesn't have filter.

FIG. 15 is the fundamental current regulator; (A) is the architecture of the current regulator; (B) is the circuit and system of the current regulator.

FIG. 16 the current regulator is for the digital circuit or whole chip; the voltage regulator is for the analog or RF circuit; (A) is the architecture having the current regulator and voltage regulator; (B) is the circuit and system having the current regulator and voltage regulator.

FIG. 17 is the cascade current regulator for the digital circuit or whole chip and the voltage regulator for the analog or RF circuit; (A) is the architecture of the cascade current regulator and voltage regulator; (B) is the circuit of the cascade current regulator and voltage regulator.

FIG. 18 is the cascade current regulator for the digital circuit or whole chip; (A) is the system block diagram of the cascade current regulator; (B) is the architecture of the cascade current regulator; (C) is the circuit of the cascade current regulator; (D) is the simulation of power and ground curves of the conventional Power and Ground plan; (E) is the simulation of power and ground curves of the Noise Isolation Technology.

FIG. 19 is the cascade of current regulator and the voltage regulator; (A) is the system of the cascade current regulator and voltage regulator; (B) is the architecture of the cascade current regulator and voltage regulator; (C) is the circuit of the cascade current regulator and voltage regulator.

FIG. 20 is the cascade of current regulator and the switch mode power supply; (A) is the system of the cascade current regulator and the switch mode power supply; (B) is the architecture of the cascade current regulator and the switch mode power supply; (C) is the circuit of the cascade current regulator and the switch mode power supply.

FIG. 21 is the comparison of the conventional power supply with the current regulator power supply; (A) is the switch mode power supply for the digital circuit or cascade connecting with voltage regulator; (B) is the voltage regulator power for the analog circuit or RF circuit, (C1) is the signal flow block diagram of the current regulator of which signal flowing direction is reverse of the voltage regulator; (C2) is the re-drawing of the signal flow block diagram of the current regulator of which signal flowing direction is in the left-to-right normal direction.

FIG. 22 is the current regulator; (A) is the current regulator having the constant current; (B) is the spectrum of the current regulator having the constant current.

FIG. 23 is the slow varying current regulator; (A) is the current regulator having the slow varying current; (B) is the spectrum of the current regulator having the slow varying current.

FIG. 24 is the on-chip of the versatile arrangements of the multi-power supplies; (A) is the current regulator is located at the upper power layer; (B) is the current regulator is located at the lower power layer (C) is the multi-current regulator is located at the upper and lower power layer; (D) is the hierarchical view of the multi-current regulator; (E) is the circuit model for the current regulator generating the voltage source to the digital circuit, etc; (F) is the general platform for the multiple current sources.

FIG. 25 is the N-type fundamental current regulator as the CR in bottom ground layer shown in FIG. 24B; (A) is the architecture of the N-type current regulator; (B) is the circuit and system of the N-type current regulator.

FIG. 26 is the cascade current regulator or the hierarchical current regulator as shown in FIG. 24D; (A) is the system block diagram of the cascade current regulator or the hierarchical current regulator; (B) is the architecture of the cascade current regulator or the hierarchical current regulator; (C) is the circuit of the cascade current regulator or the hierarchical current regulator; (D1) the design hierarchy in conventional I/O; (D2) the design hierarchy in ground-bounce-less I/O; (E) the substrate-noise-less Power and Ground P&G-Plan; (F) the ground-bounce-less I/O; (G) the Programmable A&D LDO having Analog &Digital, Brake/Accelerating/Wheeling programmable LDO; (H) the alternative design of the Programmable A&D LDO having Analog &Digital, Brake/Accelerating/Wheeling programmable LDO with trans-impedance cascade Amplifier.

FIG. 27 (A) is the general current regulator noise isolation platform; (B) is the conventional mixed signal chip; (C) is the CR wrapper of the current regulator noise isolation platform for the conventional mixed signal chip.

FIG. 28 is the conventional system; (A) is the partition of the chips; (B) is the A|D waveform of the ADC or DAC; (C) is the SIP waveform of the SERDES.

FIG. 29 is the system integration of the A|D, S|P with FPGA, DSP or Embedded Controller, etc; (A) is the chip partition with the system integration of the A|D, S|P with FPGA, DSP or Embedded Controller, etc; (B) is the platform of the system integration of the A|D, S|P with FPGA, DSP or Embedded Controller, etc.

FIG. 30 is the system integration of all the RF, AF, AD with FPGA, DSP or Embedded Controller, etc; (A) is the system integration of all the RF, AF, A|D with FPGA, DSP or Embedded Controller, etc; (B) is the platform of the system integration of all the RF, AF, A|D, S|P with FPGA, DSP and Embedded Controller, etc.

FIG. 31 (A) is the Xtaless Clock circuit with the embedded Noise Isolation Technology to implemented in the system integration as shown in FIG. 30A; (B) the timing diagram of the Injectionless lock PLL; (C) is the block diagram of the Injectionless lock PLL; (D) is the comparison between the conventional PLL and the Injectionless lock PLL; (E1) the wandering of oscillatory wave; (E2) is the normal oscillatory wave; (F1) is the spectra growth of idea oscillatory wave; (F2) is the spectra growth of the square wave; (F3) is the spectra growth due to the parametric inductance and capacitance; (G1) is the historical review of Xtaless Clock theory; (G2) is the route of map of the Xtaless Clock development.

FIG. 32 is the comparison of the performance of the super-drive ADC with the conventional and comparator based ADC; (A) is the multiplying digital-to-analog converter MDAC of the conventional pipeline ADC; (B) is the multiplying digital-to-analog converter MDAC of the comparator based ADC; (C) is the multiplying digital-to-analog converter MDAC of the super-drive ADC; (D) is the comparison of speed of the super-drive ADC with the conventional and comparator based ADC; (E) is the comparison of speed, accuracy and power of the super-drive ADC with the conventional and comparator based ADC; (F) is the schematics of the MDAC of the super-drive ADC.

FIG. 33 is the low power ultra-fast dynamic power supply for the high peak-average-ratio PAR radio frequency RF signal power amplifier and high power-efficiency RF & Power Amplifier system; (A) is the waveform having high PAR signals; (B) is the RF system having high power efficiency Power Amplifier; (C) is the circuit of the low power ultra-fast dynamic power supply for the power amplifier to have the high power efficiency and low power operation.

FIG. 34 is the operation characteristics of the Thin-Film Battery and/or ElectroChromic EC window; (A) is the layered structure of the Thin-Film Battery and/or EC window; (B) is the electrical model of the Thin-Film Battery and/or EC window; (C) is the signal flow of the temperature compensated Thin-Film Battery and/or EC window switching algorithm; (D) is the optical hysteresis curve of Thin-Film Battery and/or EC window; (E) is the operation of the Thin-Film Battery and/or EC window.

FIG. 35 is the switching operation of Thin-Film Battery and/or EC window; (A) is bi-polar operation of the Thin-Film Battery and/or EC window; (B) is the unipolar operation of the Thin-Film Battery and/or EC window; (C) is the non-linear unipolar operation of the Thin-Film Battery and/or EC window; (D1) is the unipolar operation for the positive voltage; (D2) is the unipolar operation for the negative voltage.

FIG. 36 is the Battery and/or EC window unipolar operation with the H-Bridge; (A) is the unipolar operation of the region 1 charging up Battery and/or EC window in FIG. 35A and FIG. 35B; (B) is the unipolar operation of the region 2 hold Battery and/or EC window in FIG. 35A and FIG. 35B; (C) is the unipolar operation of the discharging Battery and/or EC window of region 3 in FIG. 35A and FIG. 35B; (D) is the unipolar operation of the charging up Battery and/or EC window of region 4 in FIG. 35A and FIG. 35B; (E) is the unipolar operation of the hold Battery and/or EC window of region 5 in FIG. 35A and FIG. 35B; (F) is the unipolar operation of the discharging Battery and/or EC window of region 6 in FIG. 35A and FIG. 35B.

FIG. 37 is to show the H-Bridge operator operating on the power circuit to generate the EC window controller; (A1) is the analog buffer circuit with the H operator; (A2) is the H-Bridge operator operating on the analog buffer to generate the voltage ramping circuit; (B1) is the buck converter circuit with the H operator; (B2) is the H-Bridge operator operating on the capacitor load of the buck converter to generate the voltage ramping or current charging circuit; (C1) is the buck converter circuit with the H operator operating on the inductor and capacitor, etc; (C2) is the H-Bridge operator operating on the inductor and capacitor load of the buck converter to generate the voltage ramping or current charging circuit; (D1) is the buck converter circuit with the H operator operating on the whole buck converter; (D2) is the H-Bridge operator operating on the buck converter to generate the voltage ramping or current charging circuit.

FIG. 38 (A) is conventional wrong way to drive a big load with the unit-gain amplifier having the output voltage varying continuously as the analog signal; (B1) is the correct way to drive a big load with analog buffer having the output voltage varying continuously as the analog signal; (B2) is the PMU Power Management Unit having the Switch Mode Power Supply SMPS and Low Drop Voltage Regulator LDVR to supply power to the Battery type device such as battery, thin film battery and electrochromic glass devices, etc having the output voltage to be constant having the Vo=constant with ripple; (B3) is the PMU Power Management Unit having the Switch Mode Power Supply SMPS and Analog Buffer to supply power to the Battery type device such as battery, thin film battery and electrochromic glass devices, etc having the output voltage to be equal to input voltage without ripple; (B4) is the PMU Power Management Unit having the Switch Mode Power Supply SMPS and LDO typed Analog Buffer to supply power to the Battery type device such as battery, thin film battery and electrochromic glass devices, etc having the output voltage to be equal to input voltage without ripple; (B5) is the block diagram of the Analog Buffer; (B6) is the detailed schematics of the Analog Buffer; (B7) is the SMPS, LDO type Analog Buffer and H-Bridge; (B8) is the SMPS and H-Bridge with LDO type Analog Buffer embedded in the H-Bridge; (B9) is the SMPS, LDO type Analog Buffer and H-Bridge; (B10) is the analog signal embedded in the H-Bridge; (B11) is the LDO typed analog buffer embedded in the H-Bridge for the high accurate voltage control; (C1) is the block diagram of the Rippleless battery charger and RF-Noiseless EC window controller, etc to be the Switch Mode Power Supply combining with Low Drop Voltage Regulator (LDVR) type Analog Buffer to be the Rippleless battery charger and RF-Noiseless EC window controller, (C2) is the design platform for the Rippleless battery charger and RF-Noiseless battery charger and/or EC window controller which includes the LDVR type mode Analog Buffer, SMPS type mode and current-limited mode, voltage-limited current charging mode, current-limited voltage ramping mode, etc; (D1) is the architecture of the H-Bridge buck converter type battery charger and/or EC window controller; (D2) is the block diagram of the H-Bridge buck converter type EC window controller; (D3) is the embedded battery charger and/or window controller; (D4) is the operation of the embedded battery charger and/or window controller; (E1) is the algorithm of the current-limited voltage ramping in charging up phase; (E2) is the algorithm of the current-limited voltage ramping in discharging phase; (F1) is the algorithm of the voltage-limited current charging in charging up phase; (F2) is the algorithm of the voltage-limited current charging in discharging phase.

FIG. 39 is the super-performance battery, thin-film battery and EC window driver, etc which can be developed to be the dedicated chip for the battery, thin-film battery and window controller, etc; (A) is the block diagram for the current-limited super-performance battery, thin-film battery and/or voltage-ramping EC window controller, etc; (B) is the block diagram for the for the current-limited super-performance battery, thin-film battery and/or voltage-limited current-charging EC window controller, etc; (C) is the bleaching/discharging process; (D) is the coloring/charging process; (E) is the complete super-performance battery, thin-film battery and/or EC window driver, etc.

FIG. 40 is the analysis of the analog buffer type voltage ramping; (A) is the analogy of analog buffer with the power supply system; (B) is the power supply of the analog buffer voltage ramping battery charger and/or EC window controller; (C) is the waveform of the analog buffer type voltage ramping operation; (D) is the analog buffer circuit for the voltage ramping battery charger and/or EC window controller.

FIG. 41 (A) is the triple-wire/two-wire power/signal connection for long distance connection to drive device; (B) is the wire architecture of the triple-wire/two-wire power/signal connection for long distance connection to drive device.

FIG. 42 (A) is the energy injection into AC line; (B1) is the energy injection into AC line at the peak voltage of the AC line; (B2) is the energy injection into AC line at the valley voltage of the AC line.

FIG. 43 (A) is the energy extraction out of AC line; (B1) is the energy extraction out of AC line at the peak voltage of the AC line; (B2) is the energy extraction out of AC line at the valley voltage of the AC line.

FIG. 44 (A) is the Rectifier-DC/DC-Regulator; (B) is the 5R Recycling Resonant Re-synchronous Rectifier Regulator with the controlled capacitors for frequency tuning; (C) is the timing diagram of the 5R.

FIG. 45 is the fundamental advanced operational principles of 5R Recycling Resonant Re-synchronous Rectifier Regulator; (A1) is the fundamental Oscillatory Resonator; (A2) is the equivalent fundamental Oscillatory Resonator having two different ends. V_{DC} and Ground; (A3) is the fundamental 5R Oscillatory Resonator which can be derived from FIG. 45A2; (A4) is the basic 5R Recycling Resonant Resynchronization Rectifying Regulator which can be derived from FIG. 45A3; (B1) is the Recycling Resonant mechanism for the switch of DC/DC converter; (B2) is the timing diagram of the Recycling Resonant mechanism for the switch of DC/DC converter; (C1) is the resonant oscillation of the LC resonator of the wireless power receiver; (C2A) is the rectifier operation without the bias voltage; (C2B) is the rectifier operation with the bias voltage; (D1) is the resonant voltage, current and power of the ideal resonant circuit as shown in FIG. 45D2; (D2) is the ideal resonant circuit; (E1) is the resonant voltage, current and power of the resonant circuit having the diodes which emulates the rectifier circuit having H-bridge having Schottky diode; (E2) is the resonant circuit having the diodes which emulates the rectifier circuit having H-bridge having Schottky diode; (F1) is the resonant voltage, current and power of the resonant circuit having the active MOS which emulates the rectifier circuit having H-bridge having MOS; (F2) is the resonant circuit having MOS device which emulates the rectifier circuit having H-bridge having MOS; (G1) is the resonant voltage, current and power of the resonant circuit having the active MOS which emulates the rectifier circuit having H-bridge having MOS with wave-shaper switching driver; (G2) is the resonant circuit having the MOS which emulates the rectifier circuit having H-bridge having MOS with wave-shaper switching driver; (H1) is the rectifier having regulated output voltage capability with H-bridge having MOS with wave-shaper switching driver as shown in FIG. 45H2; (H2) is the fundamental wave-shaper; (I1) is the rectifier having regulated output voltage capability with H-bridge having MOS with wave-shaper switching driver as shown in FIG. 45I2; (I2) is the mutual-latching enhanced wave-shaper; (J1) is the rectifier with multi-voltage Inductor-Free DC/DC converter; (J2) is the waveform of the multi-voltage Inductor-Free DC/DC converter; (K) is the complete set of 5R Recycling Resonant Resynchronization Rectifying Regulator having the rectifier, multi-voltage Inductor-Free DC/DC converter and Digital/Analog Programmable LDO integrated single power-conversion stage; (L1) is the complete schematics of the 5R Recycling Resonant Re-synchronous Rectifier Register having the complete set of Analog Signal Process/Power Factor Correction ASP/PFC wave shaper; (L2) is the alternative design of 5R circuit with Schottky Diodes; (L3) is the alternative design of 5R circuit with active MOS; (L4) is the alternative design of 5R circuit with Schottky Diodes; (L5) is the alternative design of 5R circuit with active MOS; (M) is the complete schematics of the 5R Recycling Resonant Re-synchronous Rectifier Register having the complete set of Analog Signal Process/Power Factor Correction ASP/PFC wave shaper. SMPS and A&D programmable LDO; (N) is the functional block diagram of the 5R Recycling Resonant Re-synchronous Rectifier Register having the complete set of Analog Signal Process/Power Factor Correction ASP/PFC wave shaper, SMNPS and A&D programmable LDO; (O) is the generic wave shaper of WS; (P) is the gate-activated switching buffer or driver type wave shaper; (Q) is the source-activated switch-energy recycling wave shaper WS2; (R) is the operational mechanism analysis of wave shaper.

FIG. 46 is the operation of the self-cleaning sputtering chamber; (A) is the characteristics of the gas reaction sputtering process; (B) is the detonating phenomena in the gas reaction sputtering chamber; (C) is the self-cleaning sputtering process; (D) is the block diagram of the system of the self-cleaning sputtering chamber.

FIG. 47 is the high performance EC window manufacturing process; (A) is the recursive/pipeline manufacturing process flow for the high performance EC window manufacturing process; (B) is the section view without the plating and hardening process; (C) is the section view with the plating and hardening process.

FIG. 48 is the Anlinx & Milinx & Zilinx FSOC with the 11Less Green Technology for of Smart Window (A) is the platform of the Anlinx & Milinx & Zilinx FSOC having the 11Less Green Technology for of Smart Window; (B) is the Anlinx & Milinx & Zilinx FSOC having the IP wrapper of Noise Isolation Technology for 11Less Green Technology for of Smart Window.

### DESCRIPTION AND OPERATION

The smart home of iPhome has the smart window/iPindow. The smart window is constituted of the multiple smart windows such as smart multimedia window, smart solar window and smart electrochromic window, etc. The smart window is based on the W5RS Wireless Window 5R System. “5S” represents “Smart Solar Supply Silicon System”. “W5” represents “Wireless Wireline Weave Wishful Window”. “5R” represents “Recycling Resonant Resynchronization Rectifying Regulator”. “W5RS” is the killer product applications of Silicon Valley and “5R” is the killer core IP technologies of Silicon Valley. Even for the WPC Qi and A4WP wireless power supply standards of cellular phone, the novel “single-stage 5R” can have the AC/DC power efficiency as high as 95% which is the highest record in the world. The Green Technology is the reduction of energy consumption, noise generation and resource saving. The green technology integration system comprises an Intelligent Graphic Unit IGU. The Intelligent Graphical Unit IGU further comprises the multimedia window, electrochromic window and the solar cell window, etc. The electrical energy generated by Smart Solar Window can provide to Smart Multimedia Window and Smart Electrochromic Window, etc. Furthermore, the electrical energy generated by the Smart Solar Window can provide to the smart grid with wireline power line and provide to the mobile devices with wireless power supply.

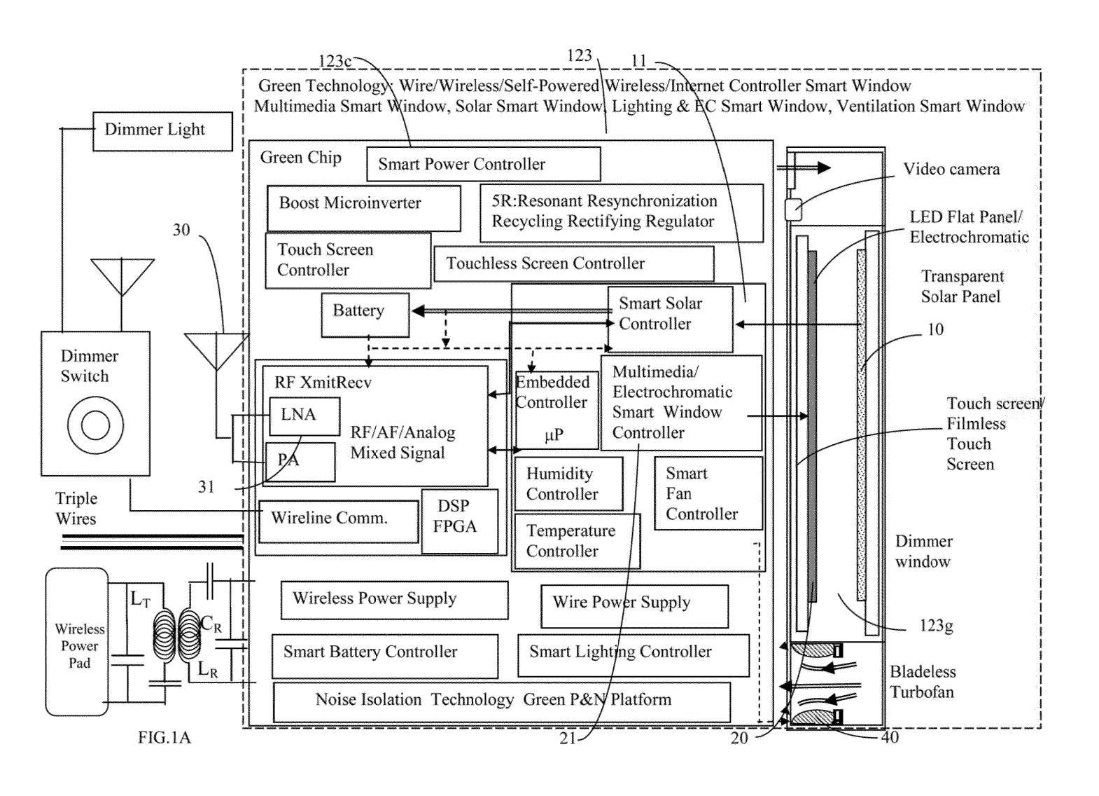

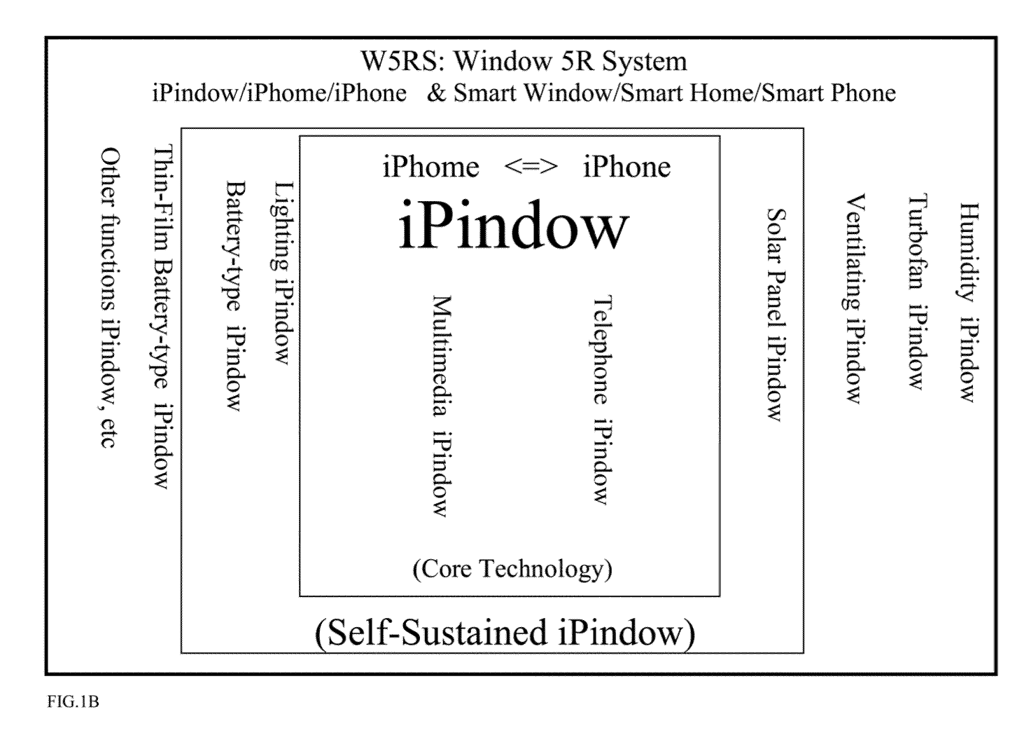

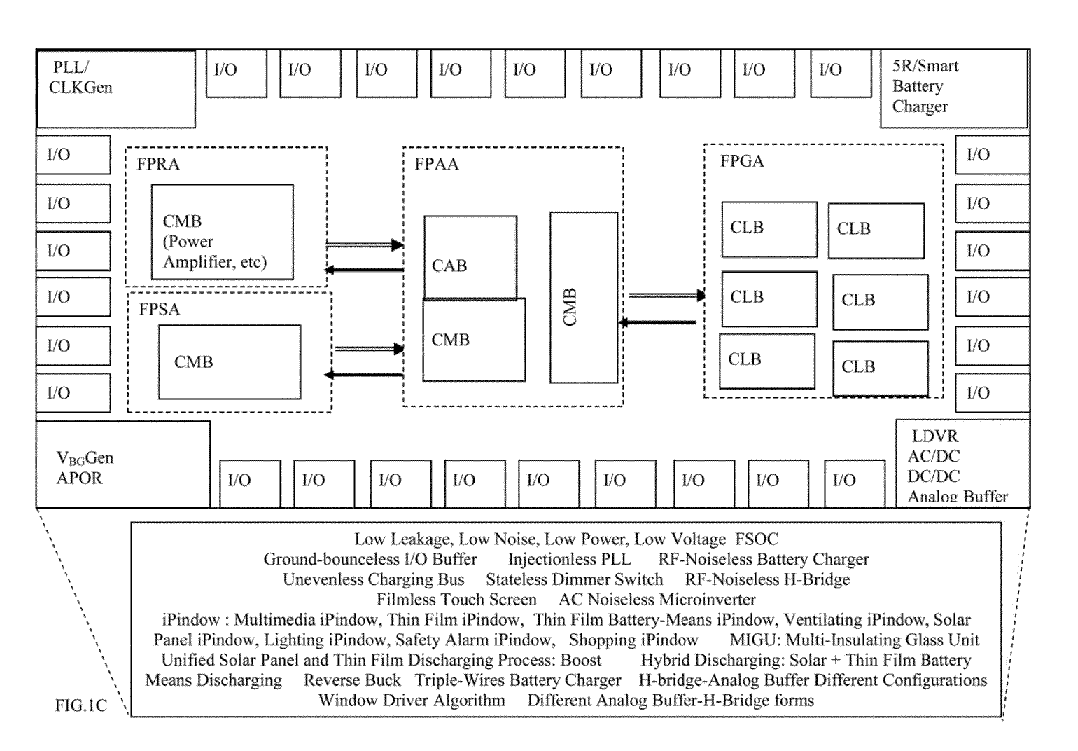

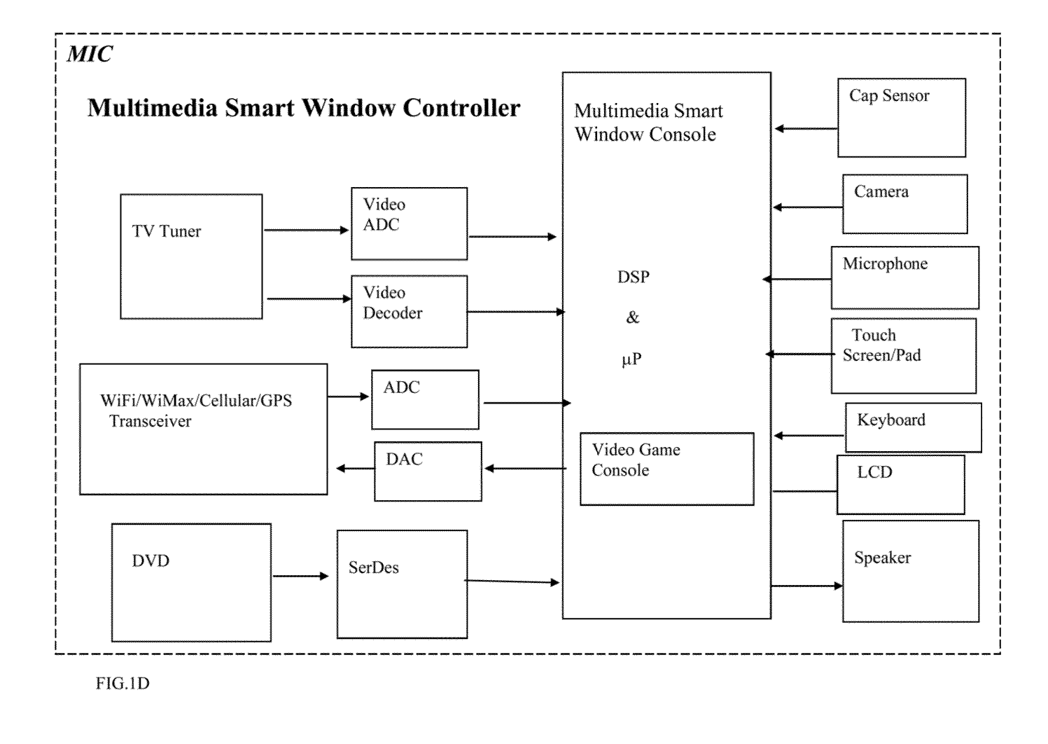

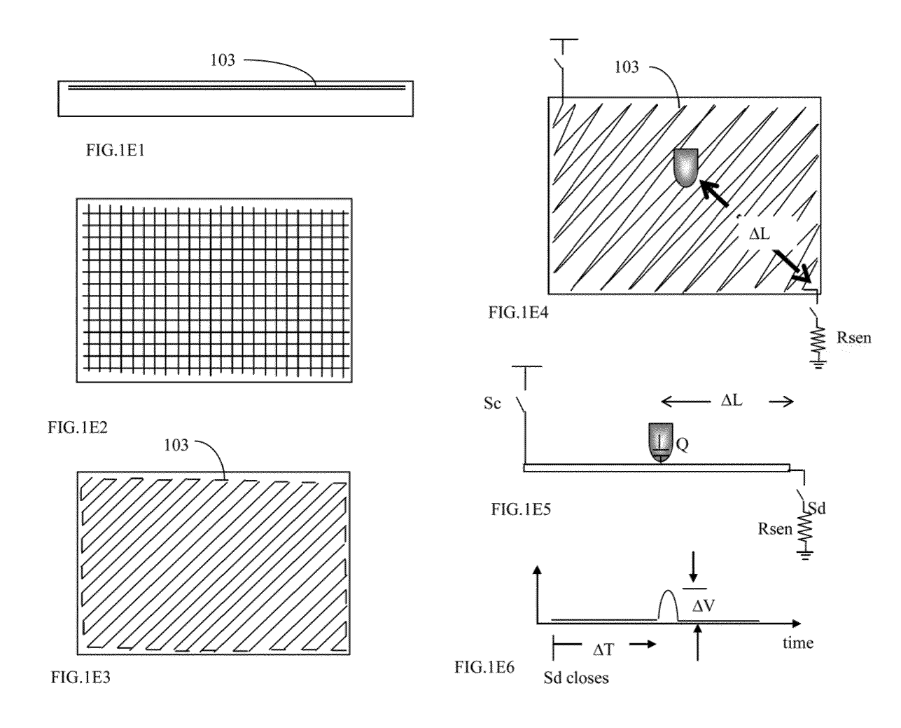

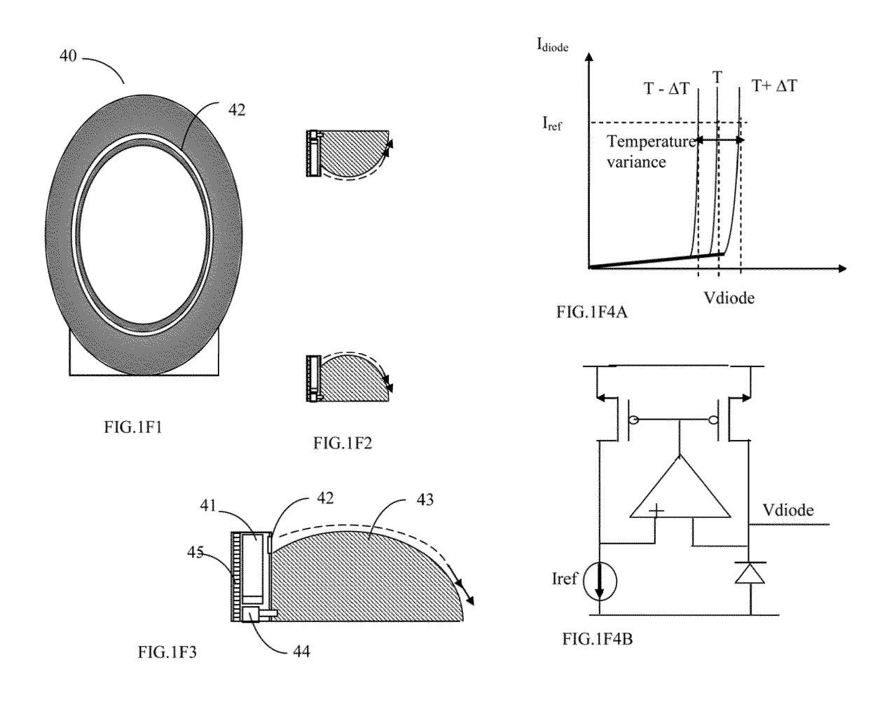

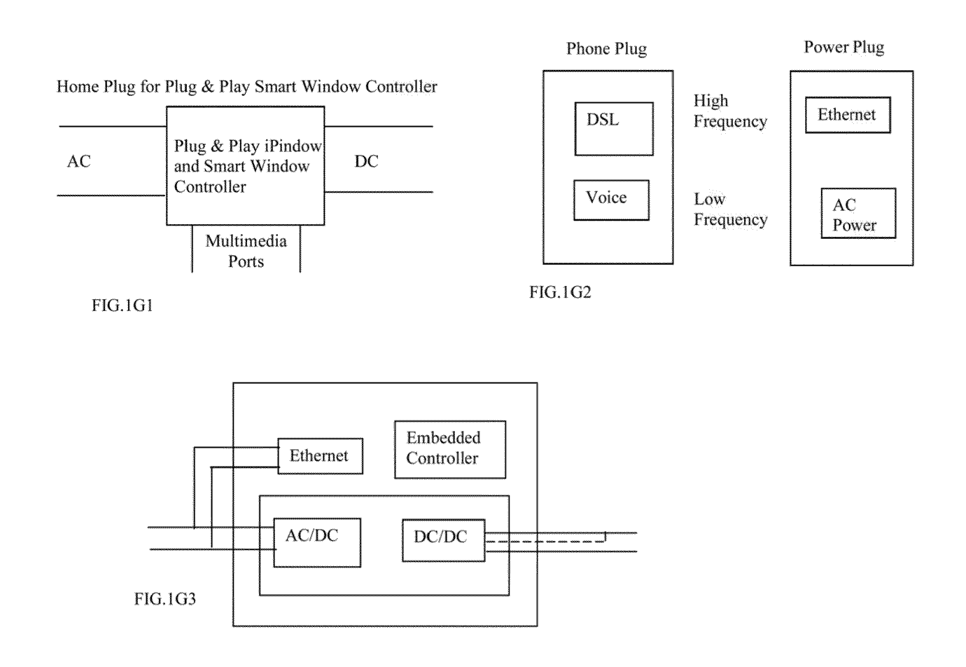

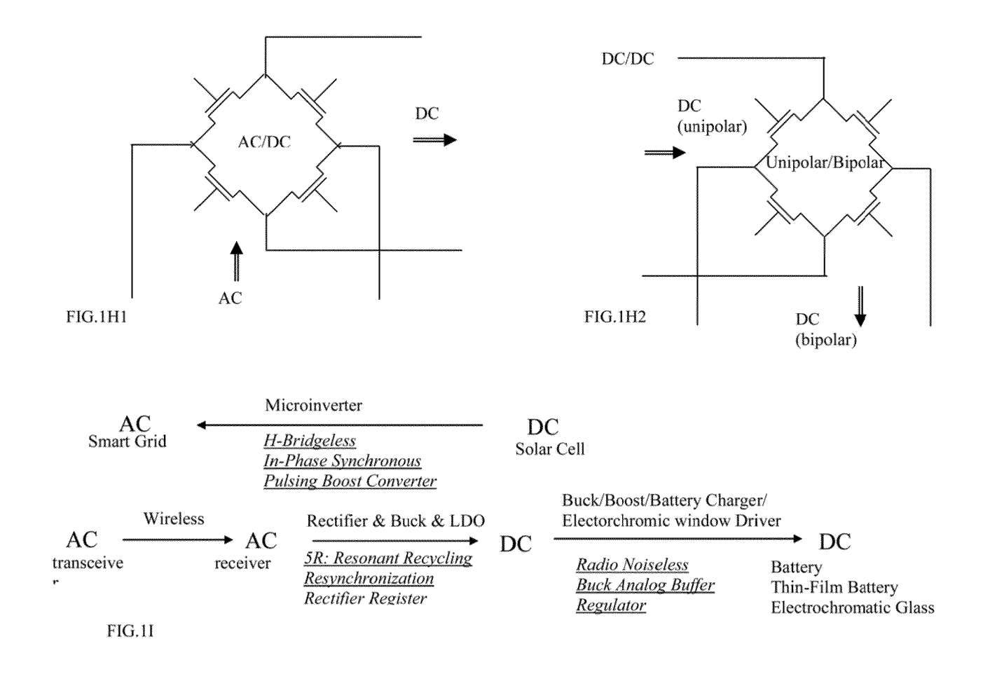

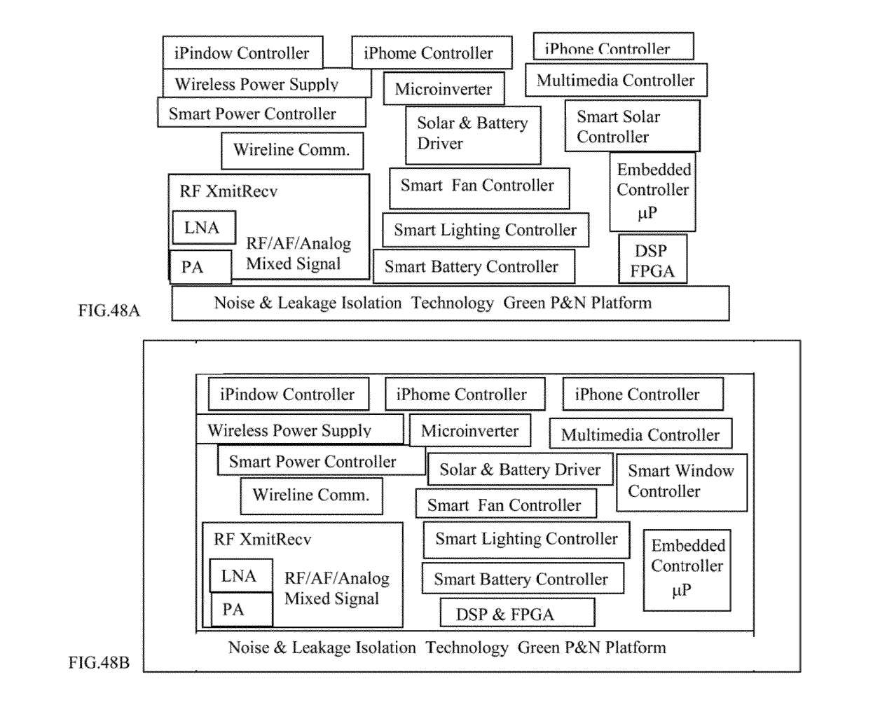

The Smart iPhome Driver and iPindow controller for Scalable iPindow of iPhome & Scalable Smart Window of Smart Home of Green House, etc are based on the 23Less Green Technology. The 23Less Green Technology for the Noiseless Field Programmable Integrated Circuit FSOC are Curtainless Window, Bladeless Turbo Fan, Brakeless Vehicle, Sawless LNA, Resistorless SMPS and Transceiver, Capless LDVR, Inductorless SMPS, Diodeless Random Number Generator. Xtaless Clock Generator, Clockless Switch Mode Power Supply, etc. As shown in FIG. 1A and FIG. 1B, the Wireless Window 5R System W5RS is constituted of Smart Multimedia Window. Smart Electrochromic Window and Smart Solar Window, etc. The Smart Solar Window harvests solar energy to be electric energy to provide power to the Smart Multimedia Window and Smart Electrochromic Window, etc. The electrical energy further provides to smart grid and mobile means. As shown in FIG. 1A, the green technology 123 has the window 123g comprising multimedia LCD panel, solar panel 10 and EC panel 20, etc. The Intelligent Graphical Unit IGU 123g has the multimedia LCD panel, solar panel 10 and/or EC panel 20, etc integrated to be one unit. The solar panel 10 and the Switch Mode Power Supply SMPS 11 provide the solar power energy to the Green Technology System 123 and the smart fan as shown by the dotted line. In the smart window, there are many smart controllers of the Scalable iPindow of iPhome & Scalable Smart Window such as Smart Home controller, smart lighting controller, smart solar controller, smart battery controller, smart power controller and smart fan controller, etc. As shown in FIG. 1C, FIG. 48A and FIG. 48B. Anlinx & Zilinx & Zilinx' Field-System-On-Chip FSOC will integrate all the smart controllers on the same platform to be one single chip.

The Smart Solar Window provides the electricity to the Smart Multimedia Window and Smart Electrochromic Window, etc to be “self-contained Intelligent Graphical Unit IGU”. All the smart controllers will be embedded in the frame of the Intelligent Graphical Unit IGU. The Intelligent Graphical Unit IGU further comprises the smart fan controller and the smart fan. In the smart fan, there are the multiple functional modules of the bladeless turbofan, air conditioner, the humidity/de-humidity and air-filter, etc. The bladeless turbine circulates the air for air conditioning and ventilation. In the winter, the ceiling portion warm air will be sucked in to the channel inside the Intelligent Graphical Unit IGU then be blown out at the bottom by the blades of turbofan.

FIG. 1B is the architecture of Scalable iPindow of iPhome & Scalable Smart Window of Smart Home. The Scalable iPindow of iPhome & Scalable Smart Window of Smart Home includes the multimedia iPindow and Telephone iPindow to be the core. The self-sustained iPindow is constituted of the core of iPindow. Solar Panel iPindow, Battery-type iPindow and Lighting iPindow, etc. The Scalable iPindow of iPhome & Scalable Smart Window of Smart Home further comprises the options of Ventilating iPindow. Turbofan iPindow, Humidity iPindow, Thin-Film Battery iPindow and other functions iPindow, etc.

The noise isolation is a platform serving as wrapper to integrate versatile combinations of application specific integrated circuit ASIC, field programmable gate array FPGA, conversion between analog and digital, digital signal processing DSP, microprocessor, RF/AF/Analog circuit and digital circuit to be field programmable integrated chip FSOC. FIG. 1C is the Field-System-On-Chip FSOC for the Scalable iPindow of iPhome & Scalable Smart Window of Smart Home. Furthermore, the Field-System-On-Chip FSOC has the versatile circuits of Ground-bounce-less I/O Buffer, Injectionless PLL, RF-Noiseless Battery Charger, Uneven-less Charging Bus, Stateless Dimmer Switch, RF Noiseless H-Bridge, Filmless Touch Screen. AC Noiseless Micro-inverter, iPindow, Multimedia iPindow, Thin-Film iPindow, Thin-Film Battery-Means iPindow, Ventilating iPindow. Solar Panel iPindow, Lighting iPindow. Safety Alarm iPindow, Shopping iPindow, MIGU: Multi-Insulating Glass Unit, Unified Solar Panel, Thin Film, Discharging Process with Boost, Hybrid Discharging for Solar and Thin Film Battery, Discharging with Reverse Buck, Triple-Wires Battery Charger, H-bridge-Analog Buffer Different Configurations, Low Leakage, Low Noise, Low Power, Low Voltage Window Driver Algorithm, Different Analog Buffer-H-Bridge forms, etc. These versatile circuits will be disclosed in the following description in details.

A Wireless Window 5R System W5RS further comprises micro-computers to control Smart Multimedia Window. The micro-computer further comprising touching sensor, video camera, etc to have both touch and touchless user interactive with said Multimedia Window. FIG. 1D is the multimedia iPindow/Smart Window controller to have the computer/communication/commander function for the multimedia iPindow/Smart Window. A multimedia iPindow/Smart Window controller integrated system comprising pipeline buffer ADC. The pipeline buffer ADC comprises high gain operational amplifier stage and dynamic switching output stage. There is Cap Sensor for the touch screen of LCD flat panel. The camera is for the touchless LCD panel application and Video phone, etc. The Touch screen pad is for the touch screen of the multimedia LCD panel of multimedia iPindow/Smart Window. FIG. 1E1 is the cross-section of the filmless LCD panel. The conducting layer 103 is embedded in the glass type media. FIG. 1E2 is the orthogonal two layers touch screen. FIG. 1E3 is the single layer touch screen. FIG. 1E4 shows the finger, etc touching on the screen having a single conducting layer. FIG. 1E5 shows the circuit of touch screen. FIG. 1E6 shows the waveform propagating on the conducting layer.

A green technology IGU integrated system comprises smart fans. The smart fan comprises bladeless turbofan. The bladeless turbofan circulates the humidity-controlled and temperature-controlled air for air conditioning and ventilation. As shown in FIG. 1F1, it is the bladeless turbofan. The blade of the turbofan is hidden inside the ring frame and cannot be reached from outside that it is named as the bladeless. FIG. 1F2 shows the cross-section of the bladeless turbofan. As shown in FIG. 1F3, the gear 44 of the motor drives the blade 41 of the turbofan. The air is sucked to flow through the humidify/de-humidify/air-filter 41 and flows out of the slot 42. As shown in FIG. 1F1 and FIG. 1F2, the expanded cone 43 makes the air pressure to drop to suck more air to flow through the center of the cone. The air multiplying factor is about 16. One volume of air flows through the blade, there are sixteen times air volume flows out the cone. As shown in FIG. 1A, the warm air at the ceiling is sucked into the side channels of the IGU and is blown out at the floor. It keeps the fresh air circulating in the room that a lot of energy is saved.

The Window 5R System W5RS comprises smart fans. The smart fan further comprises bladeless turbofan means. The bladeless turbofan circulates air for air conditioning. The turbofan needs the temperature sensor to detect the air temperature and the overheat of the motor, etc. As shown in FIG. 1F4A, the diode characteristic curve varies over temperature that we can use this diode characteristic curve to detect the temperature. As shown in FIG. 1F4B, the temperature sensor circuit can get the temperature as follows.

I_{ref}=Iₒe^{(Vdiode/VT)} where V_{T}=kT/q

ln(I_{ref}/Iₒ)=V_{diode}/(kT/q)=>T=V_{diode}/[k/q)ln(I_{ref}/Iₒ)]

As shown in FIG. 1G1, it is the Home Plug for Plug & Play Smart Battery Charger and/or Window Controller. There are AC port input, the DC port and the multimedia port. As shown in FIG. 1G2, the power plug is similar to the phone plug having the high frequency and low frequency port. As shown in FIG. 1G3, the Home Plug for Plug & Play Smart Battery Charger and/or Window Controller is constituted of the Ethernet, AC/DC converter, DC/DC converter, embedded controller, etc.

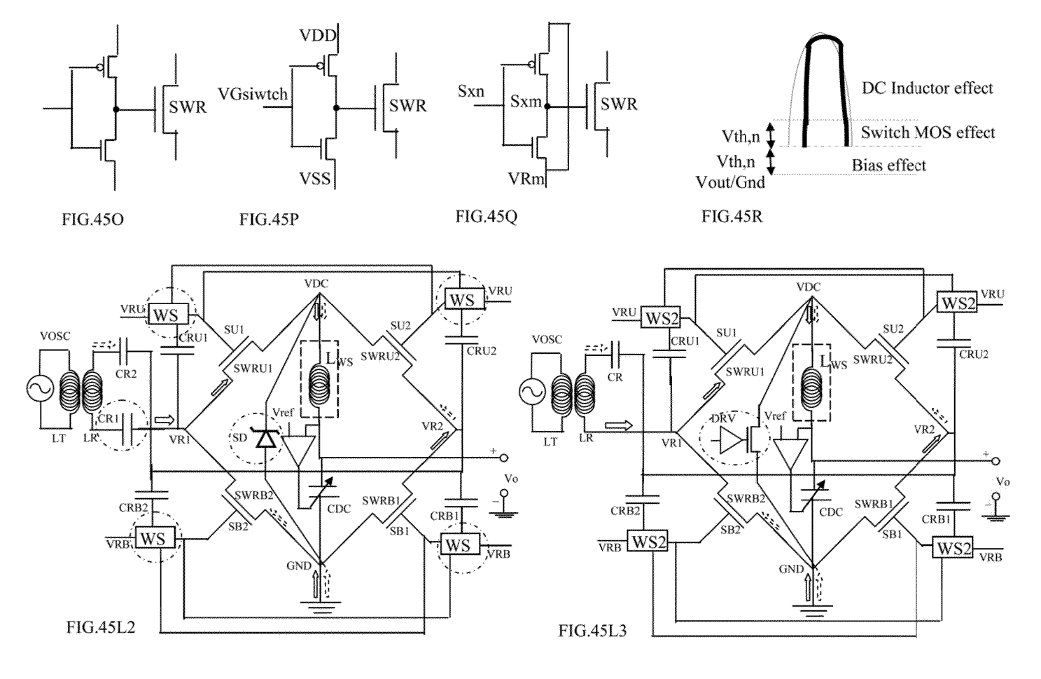

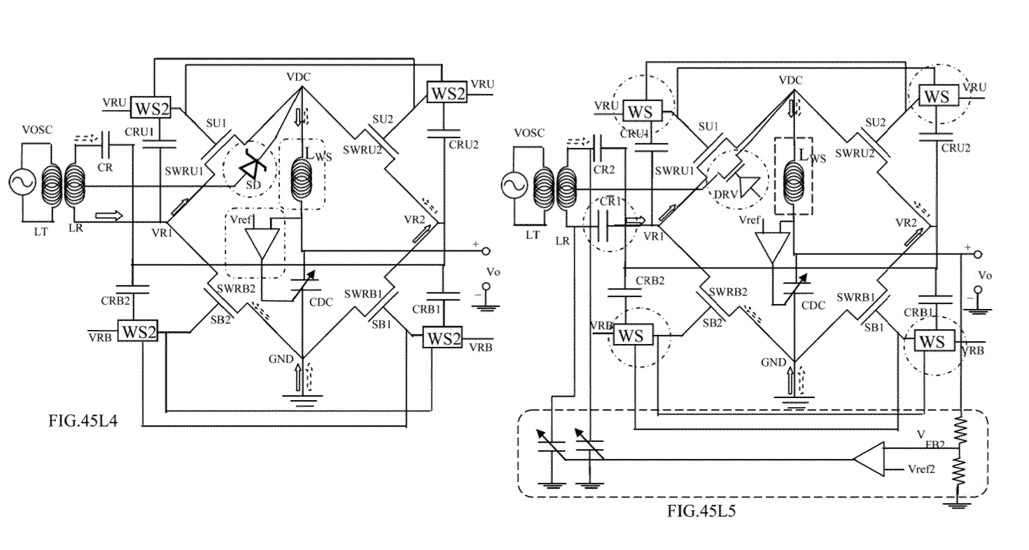

The Field-Programmable-System-On-Chip FPSOC needs to unify the different circuits to have the platform for the versatile different applications. For H-Bridge, the operation of Diode-Bridge is continuous and analog. However, the MOS-Bridge is Impulse/digital. To unify the circuit, as shown in FIG. 1H1, the H-Bridge makes the conversion between the AC and DC. The rectifier, inverter and micro-inverter use the AC/DC conversion. As shown in FIG. 1H2, the H-Bridge makes the conversion between the Unipolar-DC/Bipolar-DC. The Battery Charger and EC-Window Driver use the Unipolar-DC/Bipolar-DC conversion. Therefore, the H-Bridge is unified to be the two-way “Bipolar-AC/Unipolar-DC” for rectifier, inverter, micro-inverter, battery charger, EC-window driver, etc. As shown in FIG. 1H1. FIG. 45H1 and FIG. 45G1, for the H-Bridge, the AC/DC operation is “DIPFC: Digital/Impulse PFC Phase-Frequency Control”. With the wave-shaper of the “DIPFC: Digital/Impulse PFC Phase-Frequency Control”, the sinusoidal oscillation of LC resonator is converted to the digital switch signal.

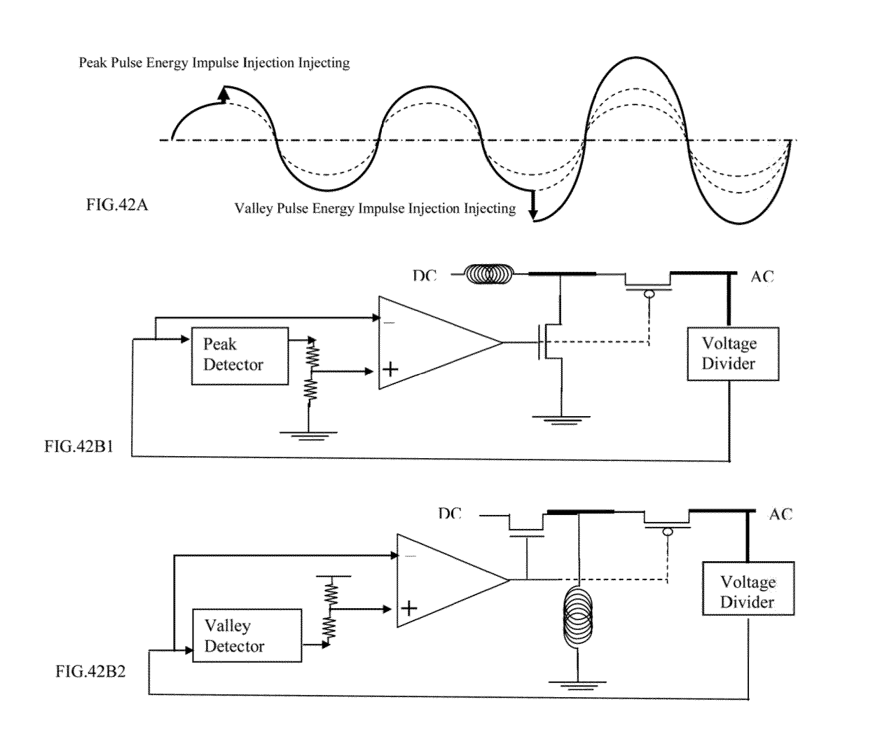

FIG. 1I shows the global map of the power conversions among different power supplies. The conventional way to convert the solar cell DC power to smart grid AC power conversion is to use micro-inverter. As shown in FIG. 1J2 and FIG. 42A, our innovation is to use the “H-Bridgeless In-Phase Synchronous Pulsing Boost Converter” to convert the solar cell DC power to smart grid AC power. The conventional way for the AC power converting to DC power is going through “three stages” power conversion of “rectifier, buck converter and LDO”. As shown in FIG. 1L1 and FIG. 45M, our innovation is “single stage” power conversion with “5R: Resonant Recycling Resynchronization Rectifier Register”. With the wave-shaper, the “resonant sinusoidal 90 degree IV out-of-phase” is converted to the “digital switch IV in-phase” recycling operation to have switch-power-loss-less rectifier operation.

As shown in FIG. 1J1, it shows the block diagrams of the energy injecting into and extracted from another power supply. As shown in FIG. 1J2, the energy is injected into another power supply with triggering impulse action. As shown in FIG. 1J3, the energy is extracted from another power supply. As shown in FIG. 1J4, the impulse/triggering impulse action is constituted of the Pre-Building-Up energy-inductor and the triggering MOS. The Instant-Impulse is the instantaneously turn off of the MOS switch to trigger the energy injection.

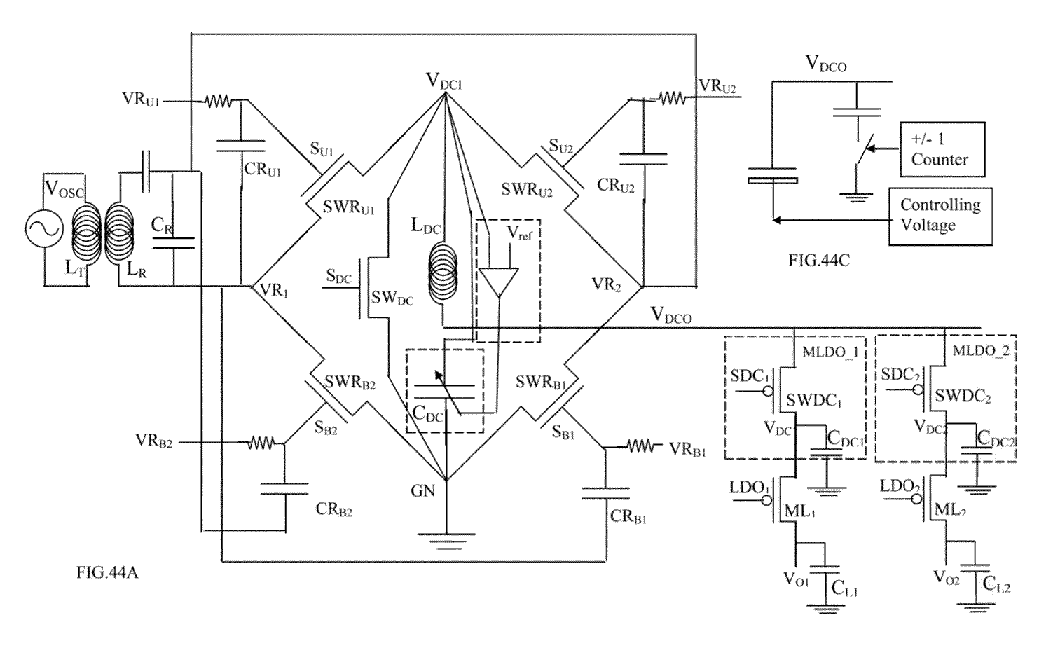

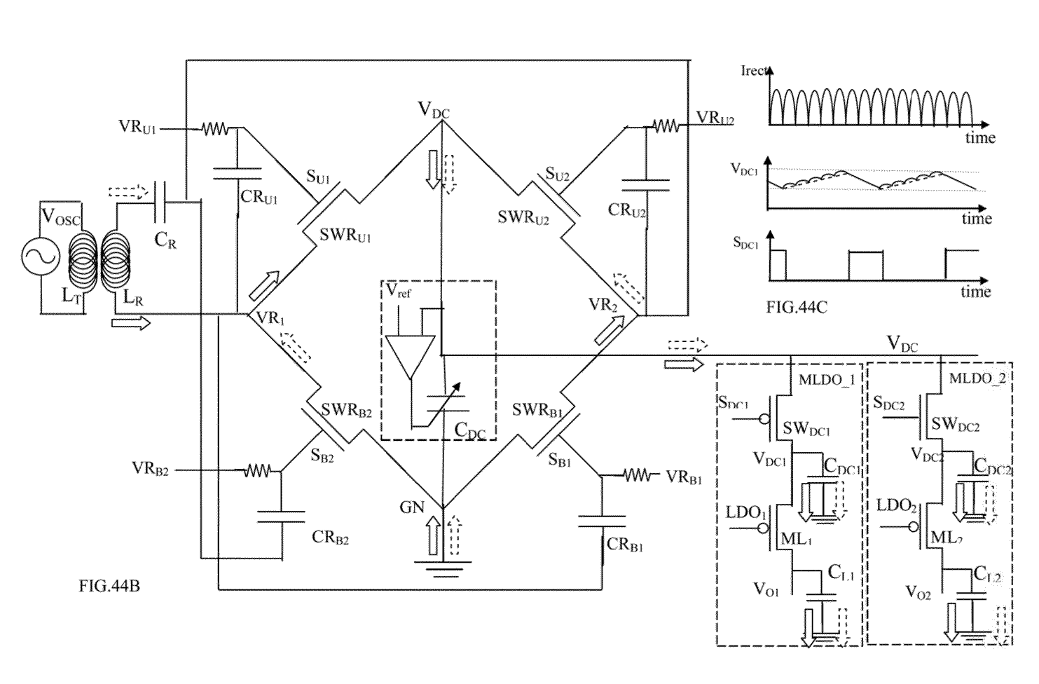

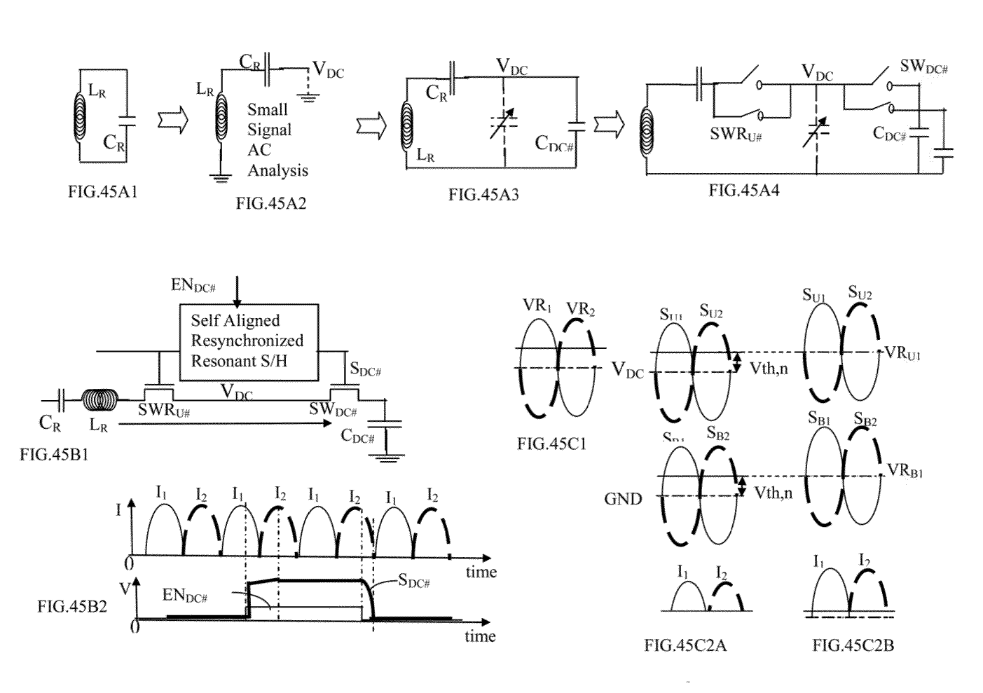

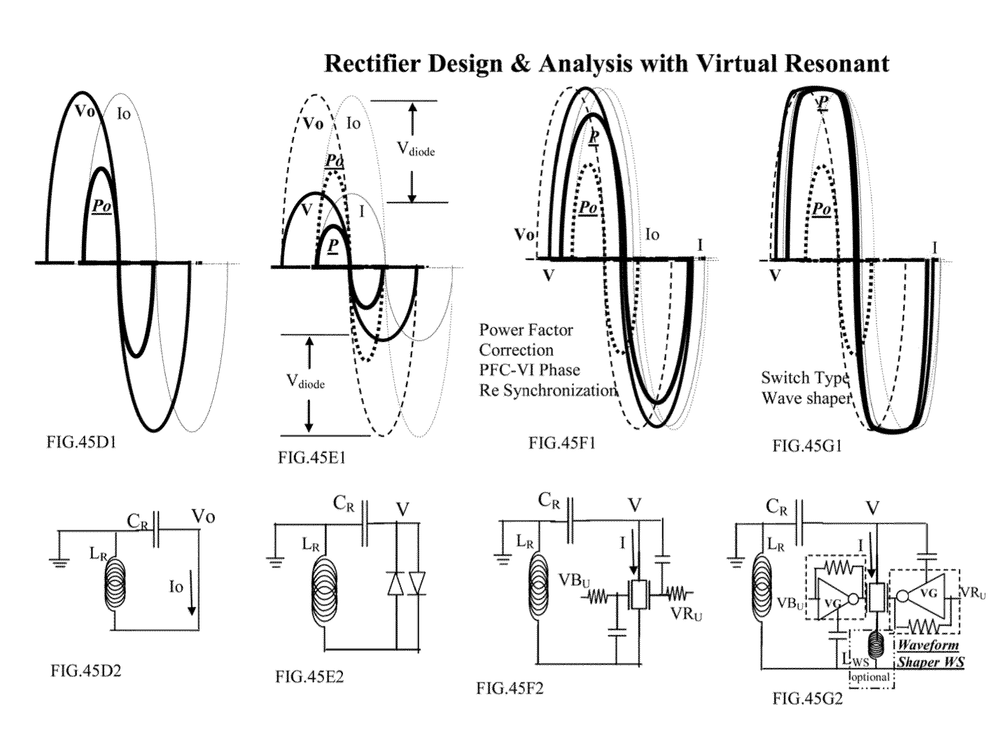

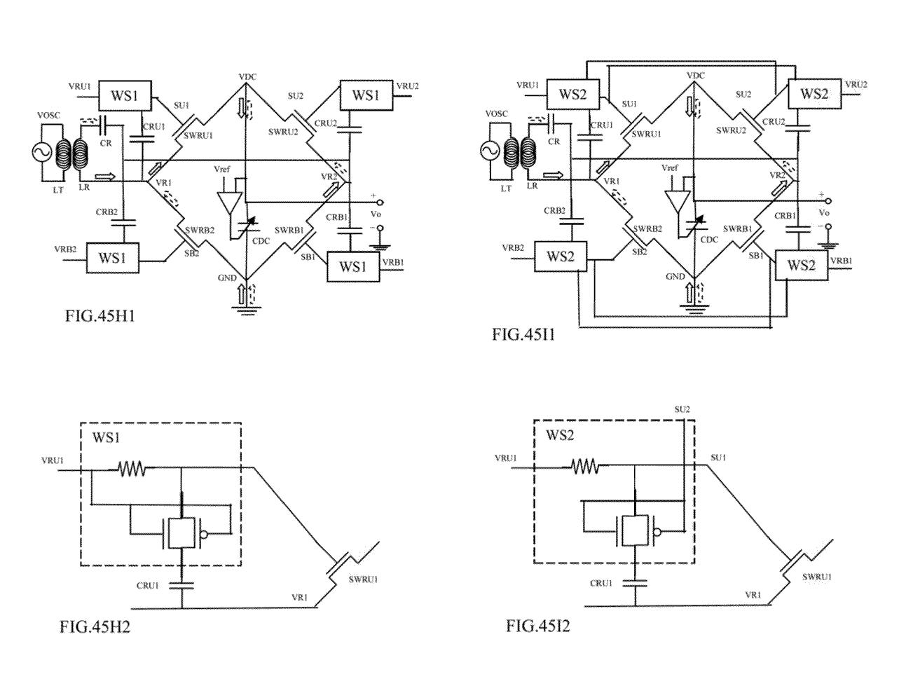

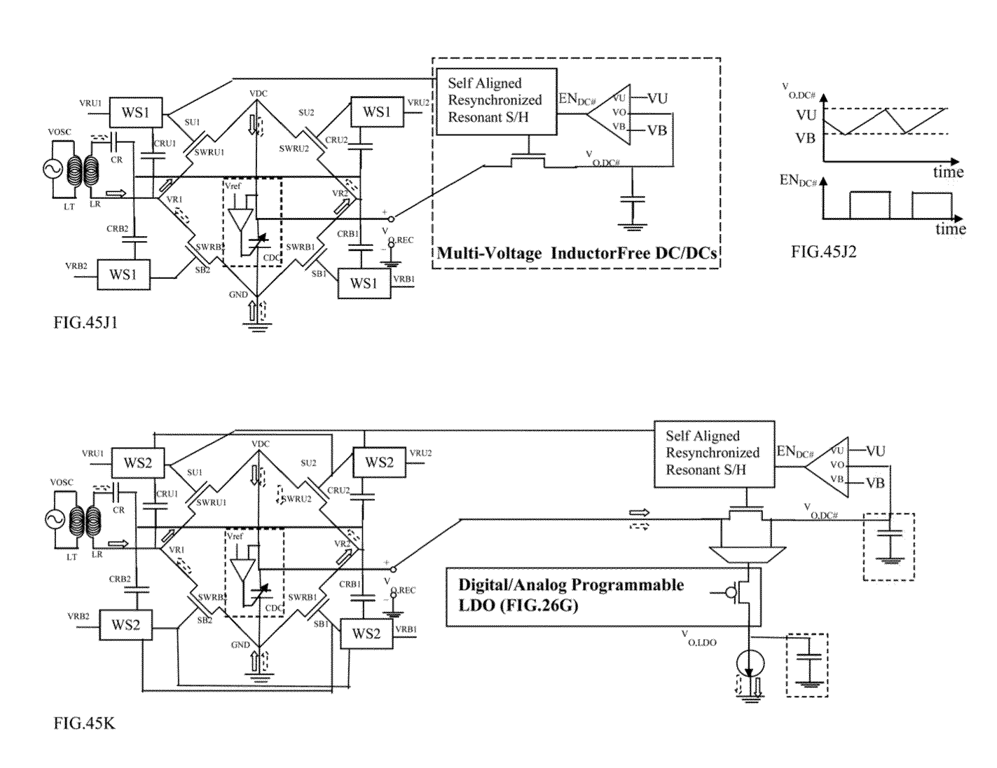

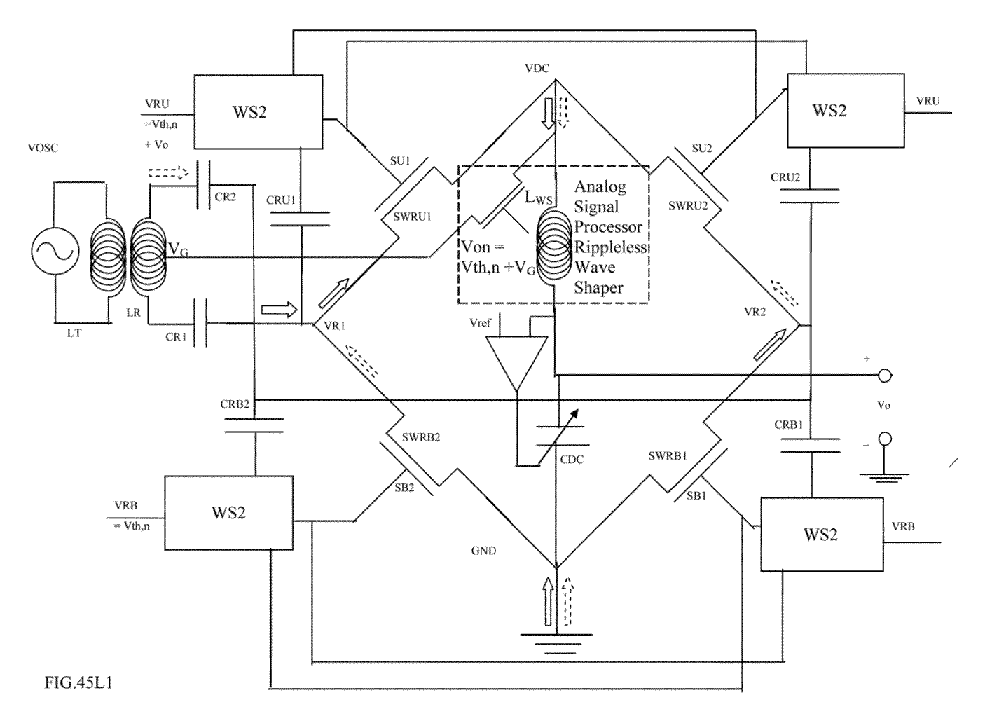

FIG. 1K shows the fundamental principle of the recycling resonant oscillator to save the switch loss. To reduce the on-resistance, the switch gate voltage must be in the digital switch mode signal. The key issue is to convert the analog sinusoidal wave form to be the digital switch form with the wave-shaping techniques. As shown in FIG. 1L1, the A5RS is constituted of the wireless transmitter 5RT and Wireless Receiver 5R as shown in FIG. 44A and FIG. 44B. Referring to FIG. 1L1, FIG. 45G1, FIG. 45G2 and FIG. 45M, the wave-shaper in 5R converts the analog sinusoidal wave form to be the digital switch form.

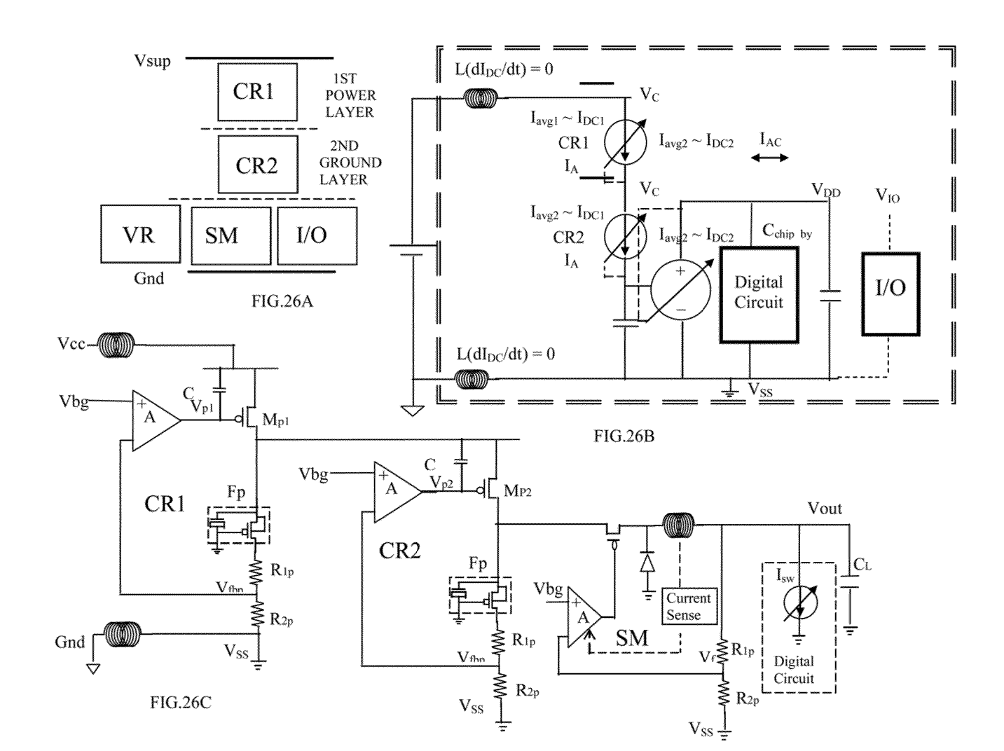

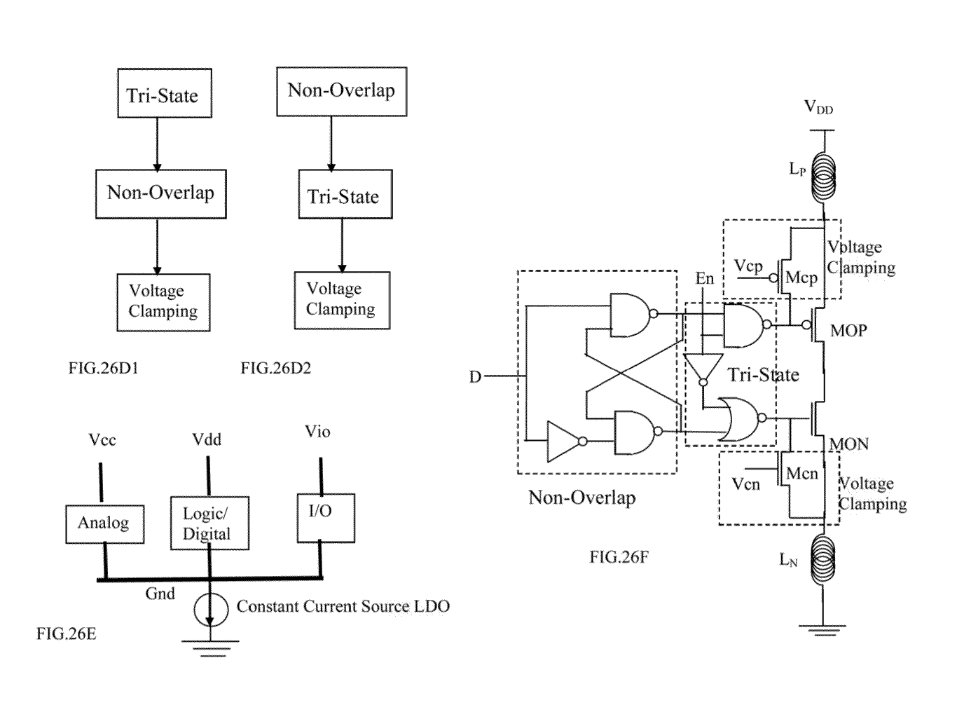

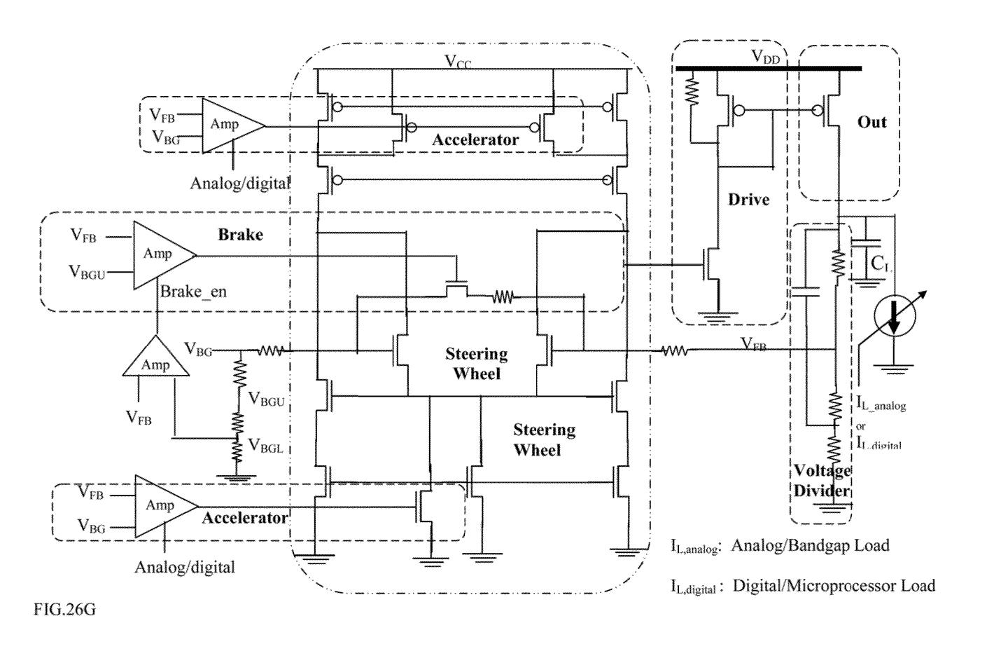

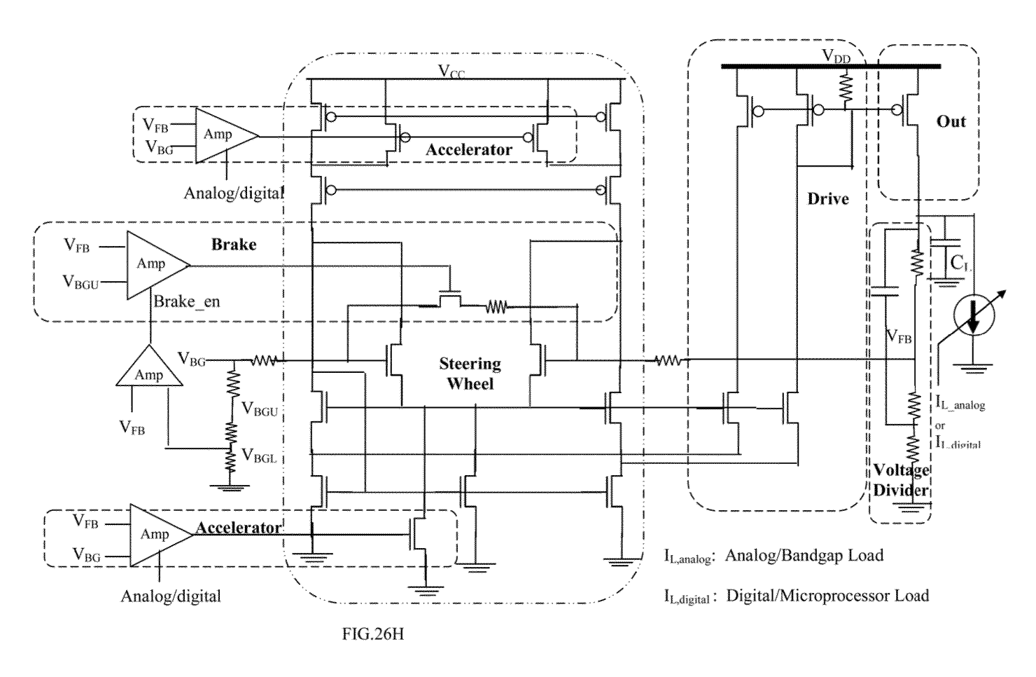

Referring to FIG. 1L1 and FIG. 26G, the Wireless Receiver 5R further has the programmable Analog/Digital LDOs be able to be programmed to be Analog LDO and Digital LDO. For example, the Analog LDO supplies the 1.8V analog power of constant current to the Bandgap and analog circuits, etc; the Digital LDO to supply the 1.2V digital power with pulsing current load to the microcomputer and digital circuit, etc. FIG. 1L4 shows the comparison between the analog LDO and digital LDO. A Wireless Window 5R System W5RS comprises a programmable LDO which further comprises programmable analog LDO/digital LDO mechanism, brake mechanism, accelerator mechanism and steering-wheel mechanism. Referring to FIG. 26G and FIG. 26H, the programmable analog LDO/digital LDO is programmed to be high-gain for analog LDO and high-bandwidth for digital LDO. The brake mechanism is able to reduce the difference of the differential input voltages of said steering-wheel mechanism to reduce the overshoot during the POS Power-On-Sequence. Due to the requirement of ripple reduction of the output voltage caused by digital loading of μP, the accelerator mechanism is orthogonal-conjugate with the steering-wheel mechanism of error amplifier to have the fast reaction to ripple.

There are the wire-line connection and/or the wireless connection for the dimmer/bi-state/multi-state smart window and light to integrate the light, ventilation, etc and smart window to be building management system. There are wireline and wireless connections and the switching powers in the Green Technology for the battery charger and smart window. The wireless is sensitive to noise. However, the switching power generates a lot of noise. To be consumer product, the cost must be low that the switching power, digital, analog and wireless, etc will integrate together to be a single Integrated Chip. To enable the Green Technology, we must have the Noise Isolation Technology NIT first.

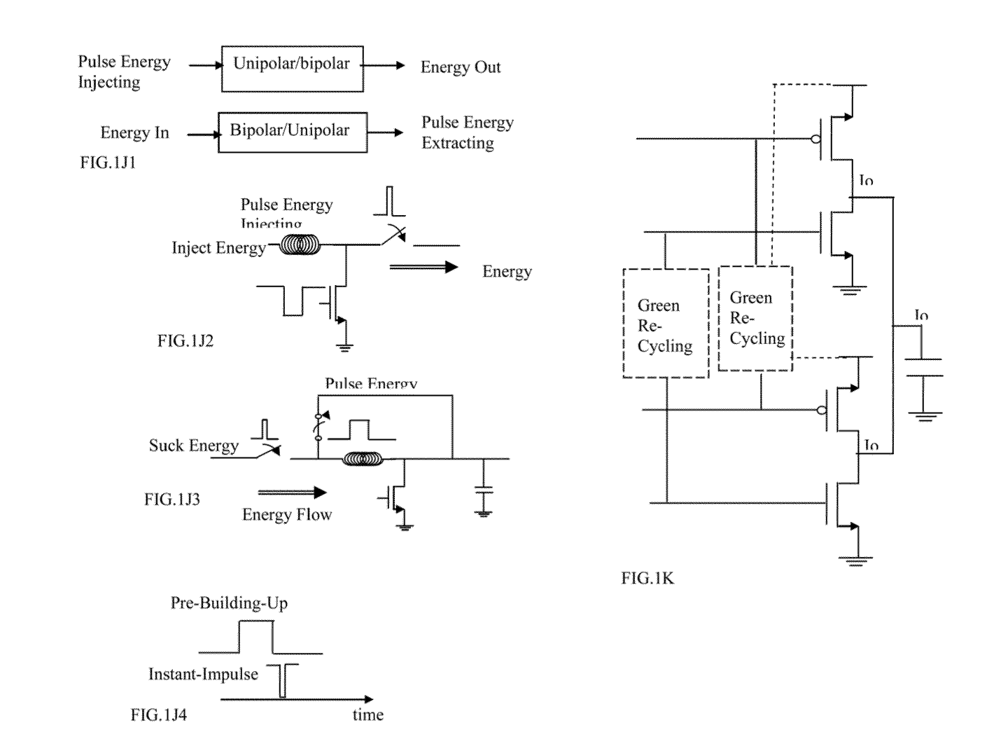

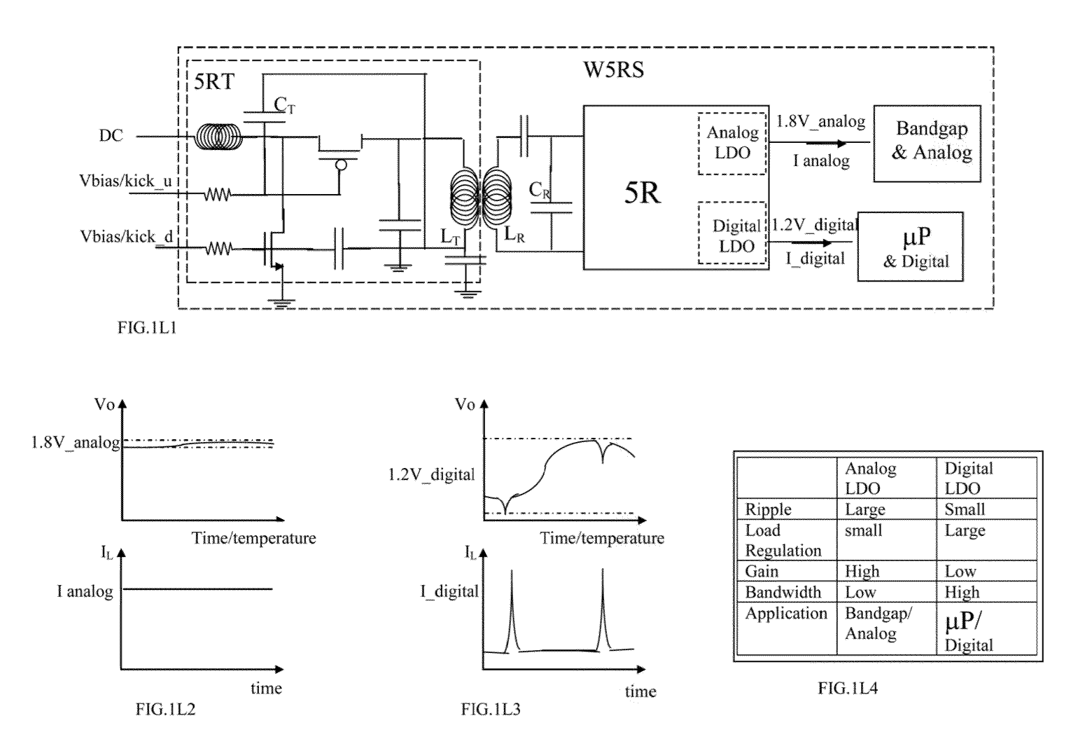

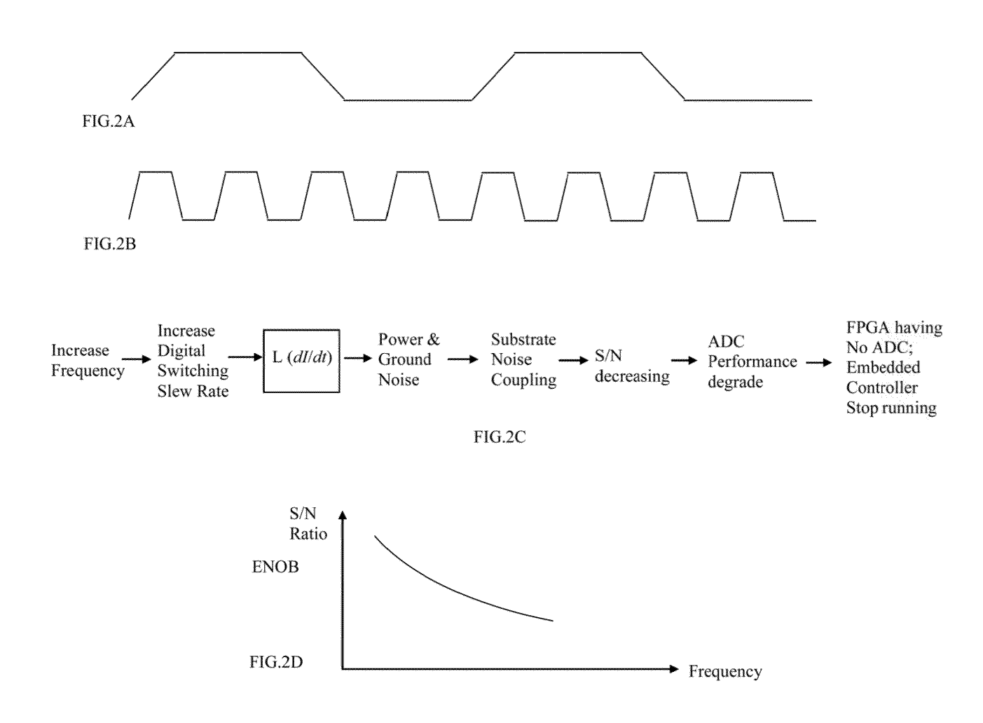

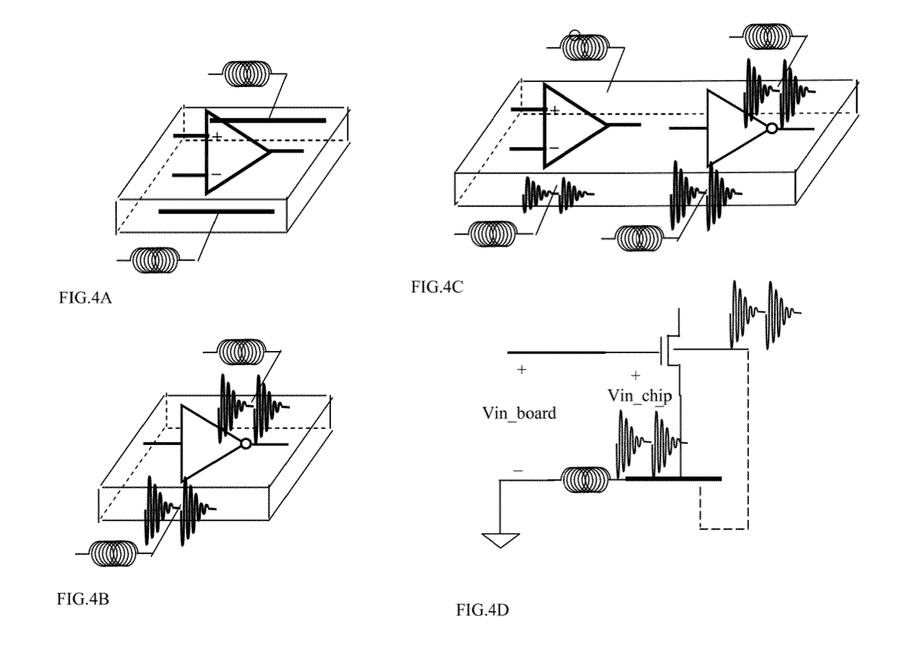

A green technology integration system has noise isolation. The noise isolation has a plural of current regulators to regulate current flowing through a plural of connections of pins and bonding wires, etc. The connections have parasitic inductors. The current regulator regulates current flowing through the parasitic inductors to reduce noise generated by the parasitic inductor. As shown in FIG. 2A. FIG. 2B and FIG. 2C, the generated noise and system degraded as the frequency increases. As shown in FIG. 2A, the switching frequency is low that the slopes of the rising edges and falling edges can be slow. As shown in FIG. 2B, the switching frequency is high that the slopes of the rising edges and falling edges are fast. As shown in FIG. 2C, as the frequency increase, the slew rate of the digital switching increases. The charging and discharging of the digital circuit has to finished in much smaller time that the switching noise of L (dI/dt) of the parasitic inductor increases. It induces the power and ground noises. The noise injected into the substrate becomes the coupling substrate noise. As shown in FIG. 4D and FIG. 2C, the substrate coupling noise injected into the circuit and system causes the degradation of the circuit and system performance. The signal to noise ratio S/N and SINAD decrease. The SINAD is the ratio of the wanted signal (the fundamental) to the sum of all distortion and noise. The Effective Number of Bits ENOB decreases where

ENOB=(SINAD−1.76)/6.02

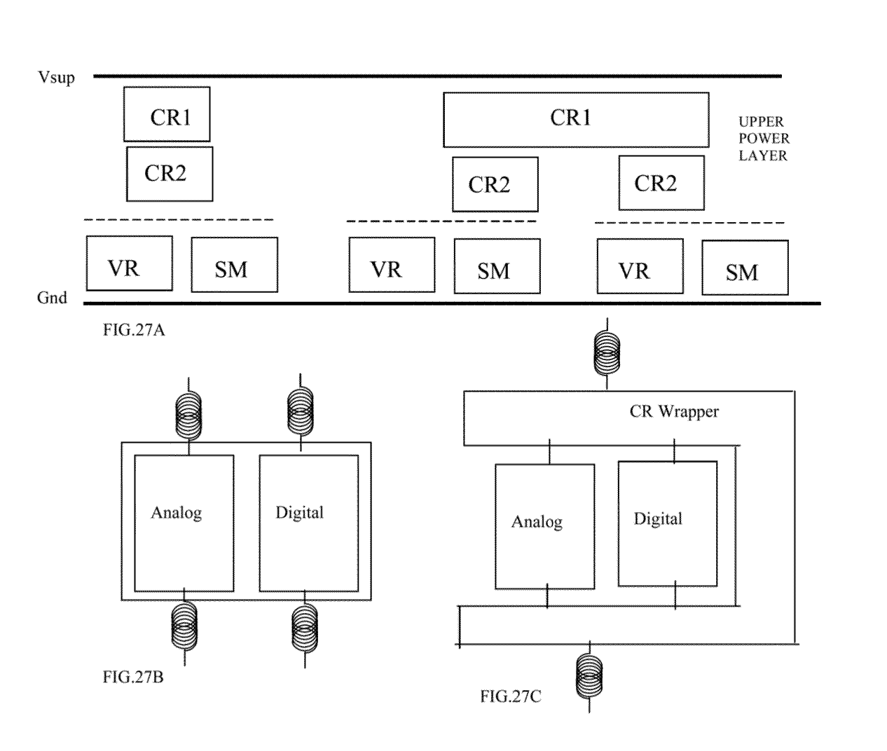

As shown in FIG. 27B and FIG. 2D, the ENOB decrement of the ADC on the FPGA is unpredictable and unacceptable that the ADC and DAC cannot be integrated on the FPGA.

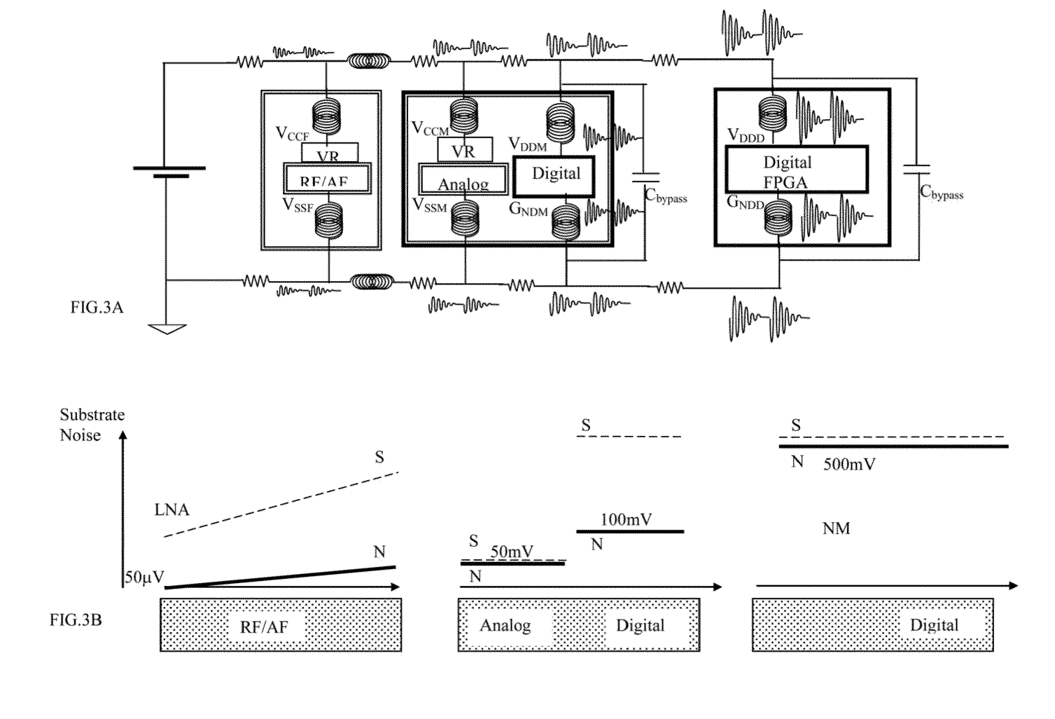

To solve the noise in system, the conventional system is partitioned as shown in FIG. 3A. The system is partitioned to be RF/AF chip, Mixed Signal Chip and Digital/FPGA chip. The parametric inductance of the package generates a lot oscillation in power and ground. To minimize the noise dumped on the board, there is the bypass capacitor C_{bypass}. As shown in FIG. 5A and FIG. 5B, this bypass capacitor C_{bypass} makes the on-chip oscillatory noises even worse. All the switching noise is dumped on the board. For the analog chip, there is the on-board inductor/choke to block the digital switching noise from the noise contamination of the analog and RF chip.

As shown in FIG. 3B, to keep the circuit performance requirement, the substrate noise for the RF/AF chip, Mixed Signal Chip and Digital/FPGA chip are bounded at separate levels. As long as these noise levels are matched at the boundaries, the signal can transmit across the chip boundaries without the loss of information.

The RF/AF signal and noise will be amplified along the chain. The noise level at the front end of LNA is very small. For the mixed signal, the substrate noise of the ADC signal has to be small. As the analog signal is converted to be the digital signal, the substrate noise can be raised to be the noise margin. However, the size of the mixed signal chip is bounded by the allowable substrate noise of the ADC. The large digital circuit has large substrate noise which is exceed the allowance of the substrate noise of the ADC. So, the mixed signal chip cannot have large digital circuit and cannot be integrated with the FPGA. Furthermore, for the FPGA, it is due to the uncertainty of the user programming digital circuit, a lot of fine tuned mixed signal techniques fails to work such as the different switching time of IO, etc. It makes the ADC not be able to be integrated with the FPGA.

As shown in FIG. 4A, it is the analog circuit in the AF/RF chip. There is no switching noise in the power and ground. As shown in FIG. 4B, it is the digital circuit in the digital/FPGA chip. There is switching noise in the power and ground. As shown in FIG. 4C, it is the mixed signal chip or large system integrated chip. There are switching noise and the switching noise injecting into the substrate to be the coupled substrate noise.

FIG. 4D shows how the ways the substrate noises coupling into the circuit to destroy the circuit performance such as S/N and ENOB, etc. First, the on-board signal Vin_board will be much different the on-chip Vin_chip.

Vin_board=Vin_chip+N_substrate

Vin_chip=Vin_board−N_substrate

It means the substrate noise N_substrate becomes the circuit input signal at the front gate. Second, the substrate noise N_substrate applies on the substrate of the input MOS. It is the back gate effect. Due to the dual substrate noise effect of the front gate and back gate, the RF circuit such as LNA Low Noise Amplifier cannot allow the digital switching circuit to be integrated into the RF/AF chip.

Regarding to the substrate noise, there are a lot of misunderstanding and mistakes in the system design. As shown in FIG. 5A, the digital circuit or FPGA generates the digital switching current. As the digital switching current flowing through the parametric inductor, the digital switch noise oscillations are generated. The digital switching noise is dumped on the board and it contaminates the board. It is assumed the board having the infinite large capacitance and to be the solid power ground.

However, as the board shrinks, the assumption of the board having the infinite large capacitance is no more valid. The traditional way to dump the noise on the board is no more allowed in the disciplinary of rigorous board design. To reduce the noise dumped on the board, as shown in FIG. 5B, there is the bypass capacitor C_{bypass} connecting between the power and ground. However, this bypass capacitor C_{bypass} makes the chip substrate noise even larger than the chip having no bypass capacitor C_{bypass}. It is due to the bypass capacitor C_{bypass} offering the storage of extra energy for substrate noise. Comparing FIG. 5B with FIG. 5A, it shows the substrate noise of chip having the bypass capacitor C_{bypass} will be much larger than the substrate noise of chip having no bypass capacitor C_{bypass}. To reduce the substrate noise, it had better not to add the bypass capacitor C_{bypass}. It is completely reverse the conventional thinking of the design practice.

Due to the fundamental wrong concepts about the substrate noise, it is no wonder the substrate noise problem becomes the mysterious and nobody can solve it. Actually, the substrate noise is the essential problem of the planarization of the chip system integration design. It is beginning with the Bell Lab in 1950 for the first planar device in system integration. For so many years, there is no fundamental theory to solve this substrate noise coupling problem in the planar device system integration. It is due to the industry and academic world having no grand master to formalize the fundamental problem and solve this fundamental problem. With the multi-disciplinary training, now the grand master Ming recognized the fundamental problem and solved this problem. The Noise Isolation Technology is introduced as follows.

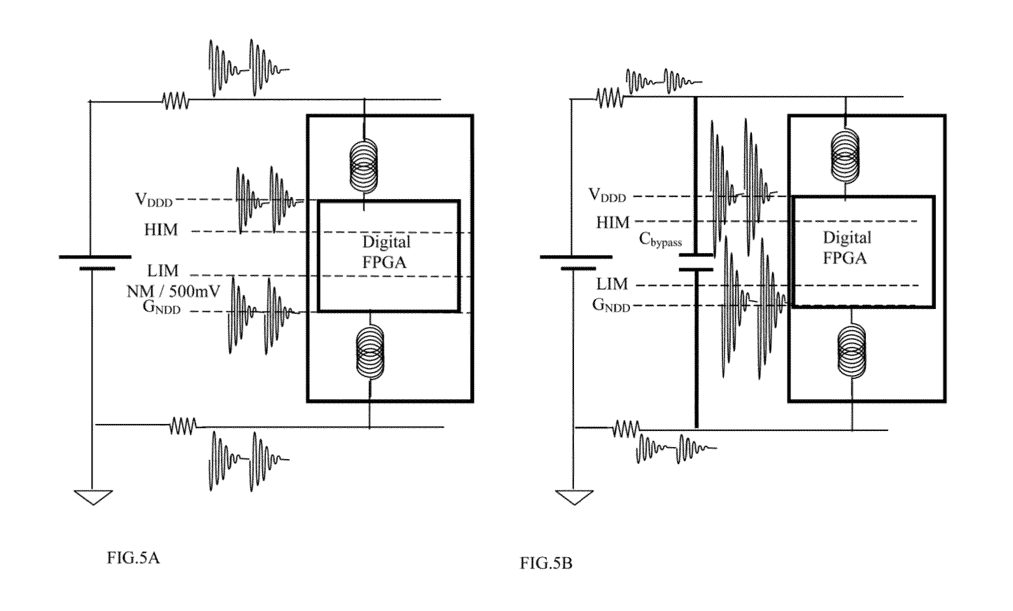

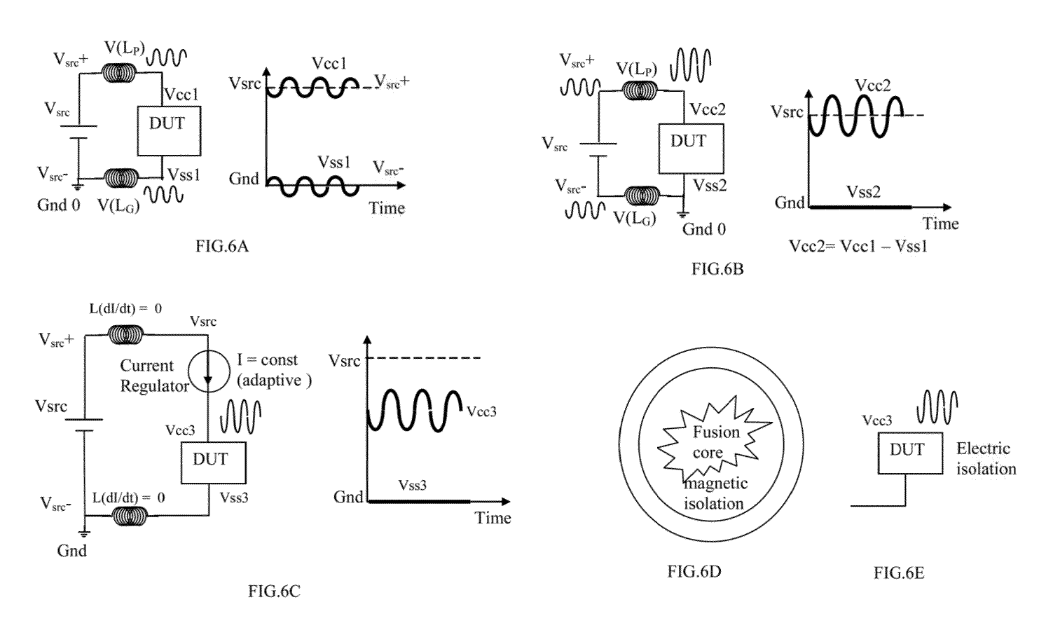

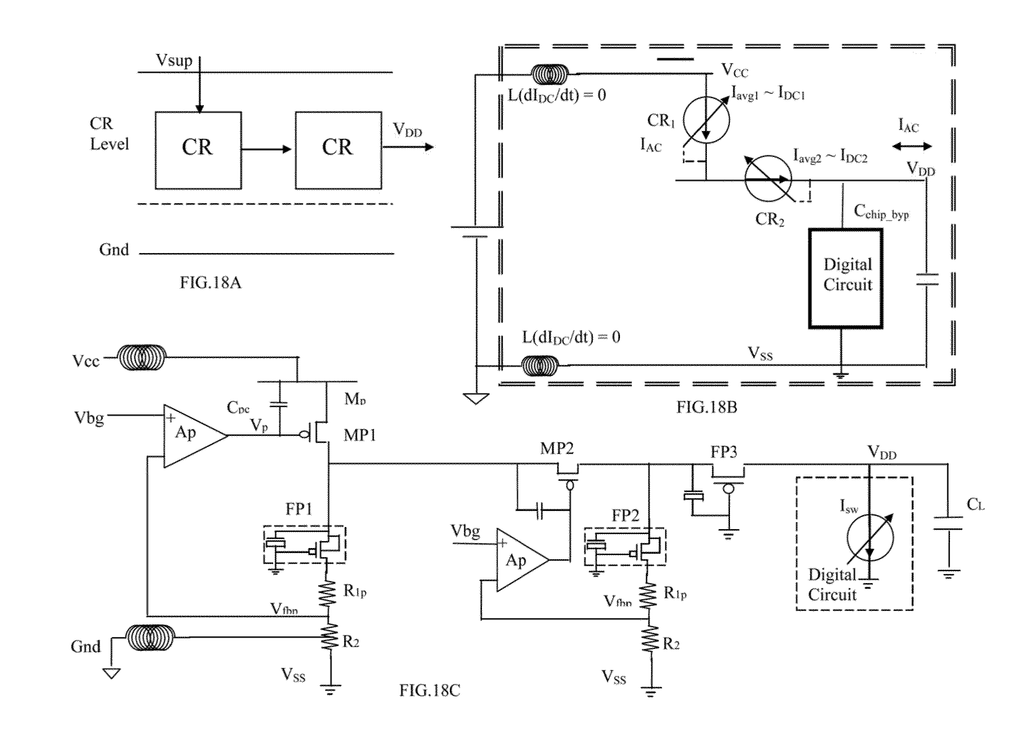

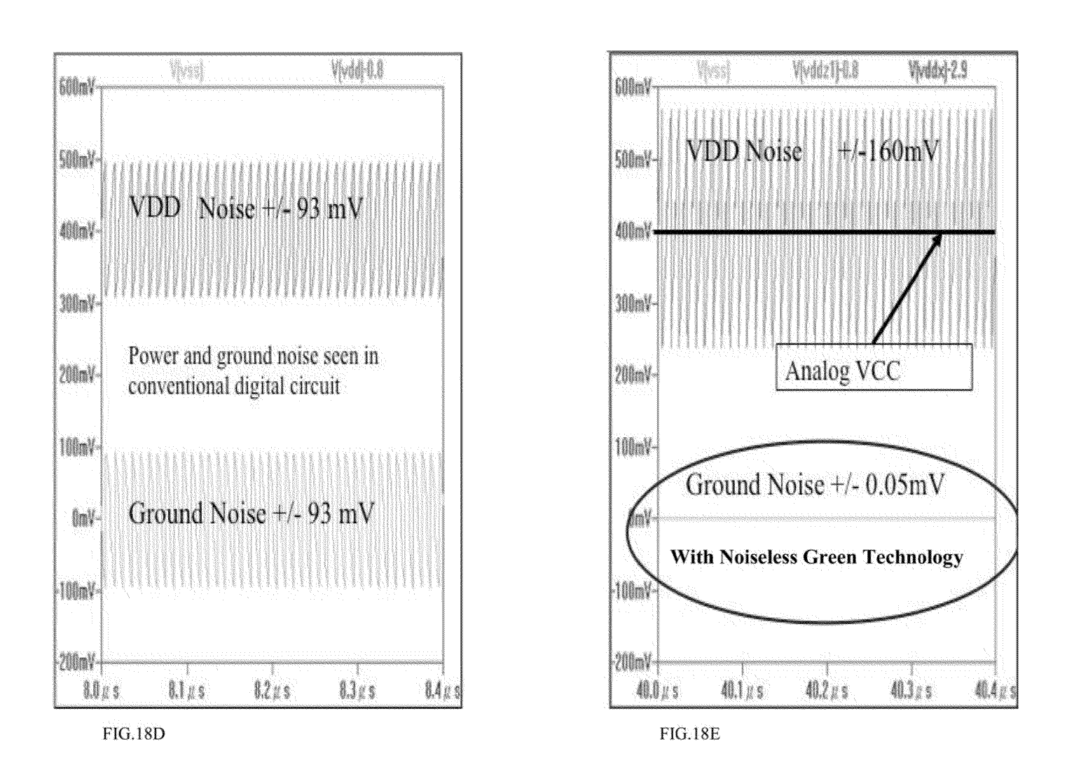

As shown in FIG. 6A and FIG. 18D, the Device Under Test DUT has the digital switch and the power and ground are oscillatory in the conjugate phases. The ground is on board to be at the bottom of the voltage source Vsrc. The Vsrc+ node voltage is Vsrc and the Vsrc− is 0V. The ground has the infinite capacitance and has the constant voltage, 0V. The power goes up and the ground goes down, and vice versa. As the P-device and N-device of the digital circuit are both on, there is the crowbar current. We might consider the power and ground are “shorted” by the P-device and N-device of the digital circuit. So, the power is pulled down and the ground is pulled up to be short together. At the same time, the parametric inductor tries to supply more current for the crowbar current. As the circuit having no more shorted path and there is no more crowbar current, however, the inductor current still flows in large amount. The continuous flows of the inductor will charge up the Vcc1 power node and discharge the Vss1 ground node. It causes the Vcc1 to go upward and the ground to go downward. The cycle of the power ground oscillation will be the doubling frequency of the switching frequency of the digital circuit. The oscillation of the power and ground are in conjugate 180° out of phase.

It is very hard for the industrial and academy to change the concept to accept the concept that the substrate noise can be zero with the proper design of circuit. To illustrate the zero substrate noise concept, two different zero substrate noise conditions are introduced for comparison. FIG. 6B is virtual mathematical game and FIG. 6C is the real world Noise Isolation Technology.

Now, as shown in FIG. 6B, in the spice simulation, we move the ground 0 node having the 0V to the on-chip ground node Vss2. Now, the Vss2 has the 0V. Vsrc− has the Vss1 voltage. The Vsrc+=Vss1+Vsrc that the Vss+ curve is in phase of Vss−. For the two cases of FIG. 6A and FIG. 6B, the voltage across the inductor should be the same.

$$\begin{matrix}V ( Vcc 2 ) = V ( Vsrc + ) + V ( {L}_{P} ) \\ = V ( {L}_{P} ) + Vsrc + V ( Vsrc - ) \\ = V ( {L}_{P} ) + V ( {L}_{G} ) + Vsrc\end{matrix}$$

$$V ( Vss 2 ) = 0$$

$${V}_{A} ( Vcc 2 ) = V ( {L}_{P} ) + V ( {L}_{G} )$$

$$with$$

$$V ( {L}_{P} ) = - V ( {L}_{G} ) != 0$$

$$Vss 2 = Gnd ( 0 v )$$

This is the mathematical and simulation trick. It shows the substrate noise can be zero and the power oscillation is double as the coordinate reference of ground node 0 is moved. It gives the implication that the substrate noise can be zero in the mathematical virtual world.

Now, with our innovative Current Regulator of Noise Isolation Technology, as shown in FIG. 6C and FIG. 18E, in the physical real world, the substrate noise is real zero.

V(Vss3)=0

V_{A}(Vcc3)=V_{A}(Vcc2)

with

V(L_{P})=V(L_{G})=0

Vsrc−=Gnd

The conventional noise technology is to try to reduce or get rid of the digital switch noise. Our approach is completely different. We are not to reduce or get rid of the digital switch noise. Our innovation is to confine the noise in the local power node VCC3 and isolate it from the substrate. Just as the heat isolation using the magnetic shield in the fusion reaction as shown in FIG. 6D, our noise isolation uses the electric shield in the planar chip as shown in FIG. 6E. Instead of the dump of the noise on the board, our innovation is to confine the noise in the digital power bus of each individual chip locally. The board is clean without noise.

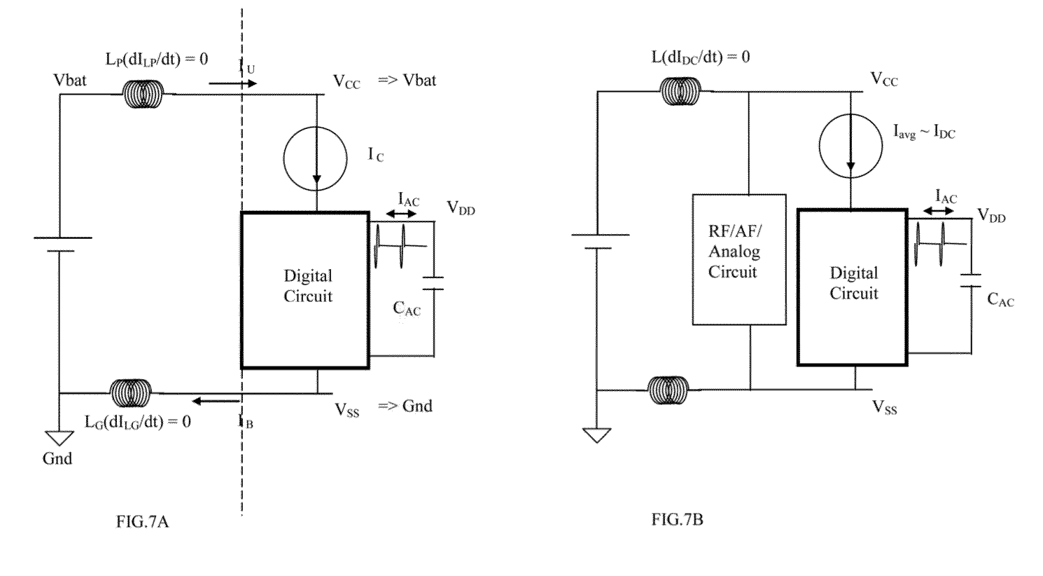

As shown in FIG. 7A, ideally, the current regulator regulates the current supply to be a constant current source IC. As the digital circuit is switched, all the time varying current I_{AC} flows through the capacitor C_{AC}. I_{LP} and I_{LG} are the current flowing through the parametric inductors.

I_{LP}=I_{U}=I_{C}=const

L_{P}(dI_{LP}/dt)=0

Furthermore, according to Kirchhoff's Current Law, the section cut is shown as the dotted line, we have I_{U}=I_{B}.

I_{LG}=I_{B}=I_{U}=const

L_{P}(dI_{LG}/dt)=0

As shown in FIG. 5A, the inductor is the noise amplifier of the noisy instantaneous current with the L(dI/dt) mechanism. As shown in FIG. 7A, the noise isolation technique has the instantaneous current I_{AC} to be confined locally with the local bypass storage capacitor C_{AC}. The I_{AC} doesn't go through the inductor L_{G}. The green technology integration system has the noise isolation further comprising capacitor C_{AC} at the output to absorb variance of current loading to keep variance of current flowing through the current regulator I_{C} to be minimum.

As shown in FIG. 7A, with the short circuit L_{G}(dI_{LG}/dt)=0 of the parametric inductors, the substrate Vss is clamped to be the zero voltage by the ground 0, Grid. All the noise is confined and isolated at the node VDD and the ground and substrate is at 0V and is shorted and clamped by the ground 0 with the inductor L_{G}.

Since the VCC and VSS are quite, as shown in FIG. 7B, the RF/AF radio frequency, analog front and analog circuit can be connected to the quite power and ground VCC and VSS. The substrate is connected to the VSS that there is no substrate noise coupling problem. In other words, the RF/AF radio frequency, analog front and analog circuit can be integrated with the digital and FPGA to be single chip.

The green technology integration system means has noise isolation means. The noise isolation means has the current regulator means to regulate the current flowing a plural of connection of bonding wire. The bonding wire connection has the parasitic inductor. The current regulator regulates the current flowing through the parasitic inductor of bonding wire to reduce the switching noise generated by the parasitic inductor.

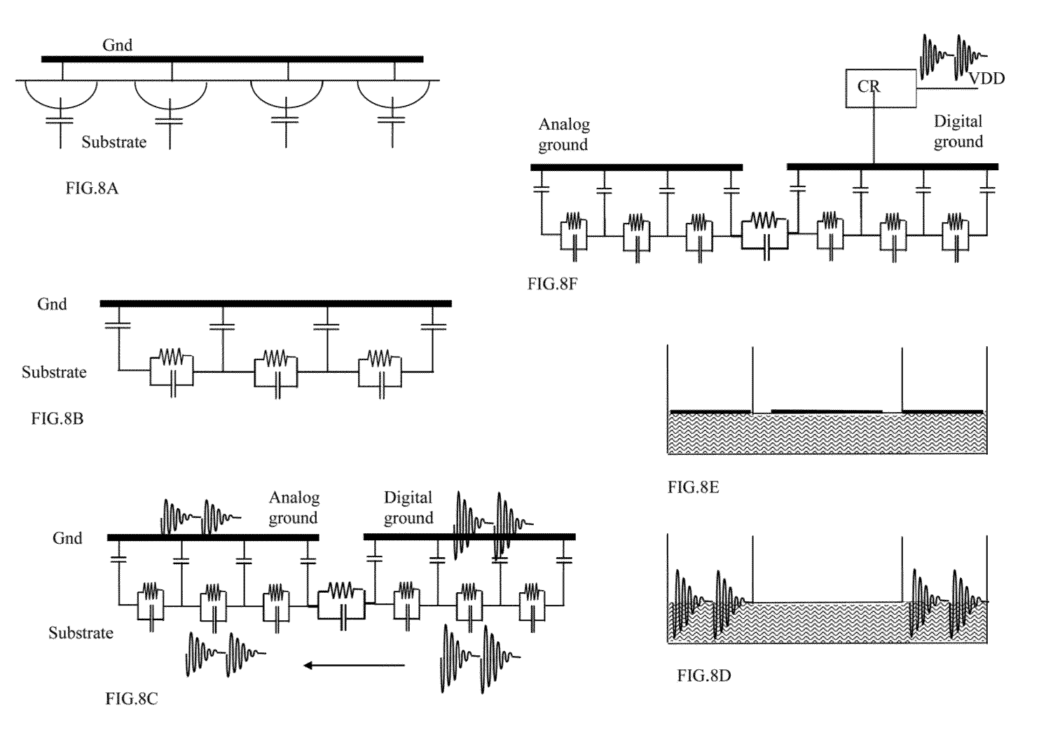

As shown in FIG. 8A is the on-chip metal ground line Gnd connected to the substrate through the high density doping wells, etc. There are the parametric capacitors. As shown in FIG. 8B, it is the equivalent circuit of the substrate connection. The substrate has the resistance 3000 W per square, the metal has the resistance about 0.001 W per square. So, the ground metal shorts all the substrate circuit together to be a lump node. So, there is no need to do the whole chip 3D simulation to verify the noise isolation technique. The low resistance metal has shorten all the substrate circuit together and the substrate circuit effect has been marked off.

Comparing the conventional noise isolation techniques as shown in FIG. 8C, the digital noise injects into the substrate. This substrate noise injects further into the substrate under the analog circuit, the substrate noise contaminates the analog ground. So, the conventional separate power and ground doesn't solve the coupling substrate problem. As shown in the FIG. 8D, it is the hydraulic model of the electron sea in the substrate. The substrate noise in the digital substrate will disturb the substrate of analog circuit. In other words, it must have all the substrate connected together to be a calm sea as shown in FIG. 8E. The separation of power and ground cannot eliminate the substrate noise to meet the high S/N or ENOB requirements that the analog RF/AF ASIC chip has to separate from the large digital or FPGA circuit. To have the quite ground for the digital substrate in the FIG. 8E, as shown in FIG. 8F, the current regulator CR confines all the digital noise at the power node V_{DD} and the ground is kept isolated from the noise with the digital circuit to be the electrical isolation layer.

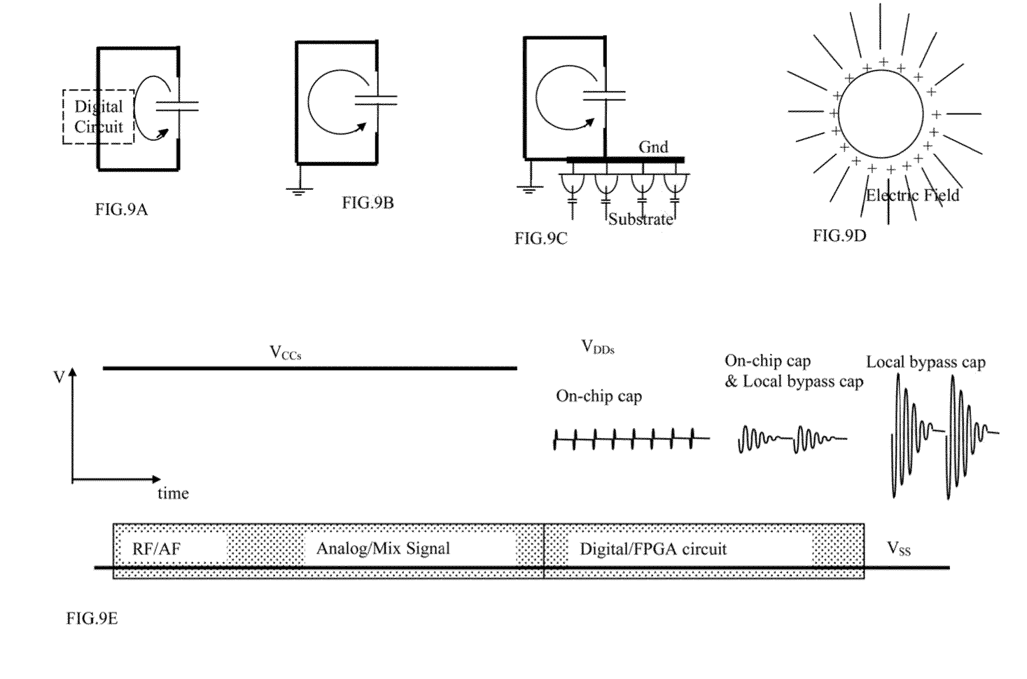

With the innovative CR in FIG. 8F, the power, ground and noise are shown in FIG. 9E. The ground voltage and the substrate voltage are clamped by the ground 0V with the L_{G} inductor. There is no substrate noise. All the digital switching noise is confined at the V_{DD} node. Depending on the size of digital/FPGA circuit, the C_{AC} might be the versatile combinations of the on-chip capacitor and on-board capacitor. For very large digital/FPGA circuit, the crowbar current is too large that the on-board capacitor is needed. However, the on-chip capacitor can reduce the instantaneous rising of the inductor current a lot that the peak voltage oscillation is reduced a lot.

In the Noise Isolation Technology NIT, there is a question whether the oscillation of the current between the digital circuit and the capacitor will inject into the substrate to generate the noise. To answer this question, as shown in FIG. 9A, there is one capacitor with the positive terminal being connected to the negative terminal of this capacitor. There is no ground and/or substrate. The closed loop current will not inject to ground and/or substrate. As shown in FIG. 9B, the ground is added to the circuit however the loop current will be still the same. So, as shown in FIG. 9C, the loop current will not inject into the ground and/or substrate. In other words, just as the electric field inside the closed metal cavity as shown in FIG. 9D, the ground and substrate are shielded from the inject current FIG. 9C. FIG. 9D is the static electric field case; FIG. 9C is the dynamic current case. There is no switching noise outside the current loop and it is names as the Tangs' Law.

A green technology integration system comprises application specific integrated circuit ASIC and field programmable gate array FPGA. The green technology integration system integrates the ASIC and FPGA on a platform made of the noise isolation means to be the field programmable integrated chip FSOC. FIG. 9E is the application of the Tangs Law to the platform of the system integration. All the Radio Front, Analog Front RF/AF, analog/mixed signal and Digital/FPGA circuit are integrated on the same chip to share the same substrate. With the Tangs' Law, the power V_{CCS} of the RF/AF, analog circuit is constant over time. The switching noise is confined on the multiple V_{DDS} digital power buses. For the switching current spikes, the switching noise is small. With the on-chip capacitor, the oscillation voltage is much smaller than the on-board capacitor.

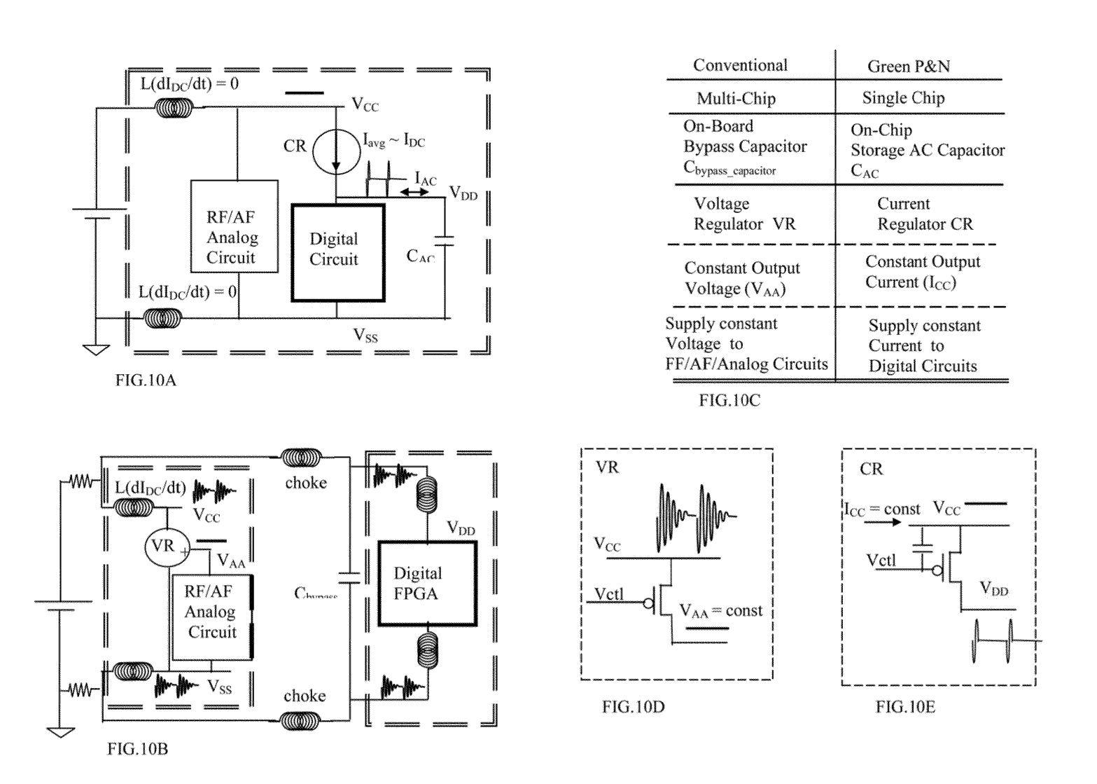

FIG. 10 is to illustrate the difference and make the comparison between the innovative current regulator and conventional voltage regulator. FIG. 10A is the current regulator to eliminate the internal on-chip substrate noise generated by the on-chip digital switching noise. FIG. 10B is the voltage regulator to eliminate the external on-board power noise injected into the analog circuit.

The digital switch has the periodic curve that we can take advantage to get rid of the digital switch noise. As shown in FIG. 10A, the digital circuit consumes the switching current I_{switch}=I_{AC}+I_{DC}. The I_{DC} is the slow varying low frequency average current which can be treated to be constant in the timing window. The current regulator CR only provides the constant average current I_{DC}. In the short time window, I_{DC} can be approximated to be constant, I_{DC}=constant. For I_{DC}=constant, L(dI_{DC}/dt)=0. The substrate has V(Vss)=V(0) to be the ground node voltage and have no digital switch noise. The capacitor C_{AC} will smooth the voltage V_{DD}. The amplitude variance of V_{DD} is the inverse proportional function of the capacitor C_{AC}. To make the variance of V_{DD} smaller, we need the larger C_{AC}. However, there is the limit of the on-chip capacitor. Then the off-chip capacitor can be used with the combination of the on-chip capacitor. The on-chip capacitor reduces the peak voltage and the off-chip capacitor reduces the large variance of the V_{DD} amplitude.

As shown in FIG. 10A, for the current regulator, the current switching occurs at node V_{DD}. The protected node V_{CC} voltage is a constant voltage. On the contrary, as shown in FIG. 10B, the node V_{CC} has the on-board injecting noise. This on-board injecting noise is coming from the digital switching noise of the neighboring digital or FPGA chips. The digital or FPGA chip dumps the digital switching noise on the board. Even having the bypass capacitor and/or choke, there are still have the digital switching noise injecting into the RF/AF analog chip. Under the V_{CC} injecting noise, the voltage regulator is trying to have the on-chip analog supply voltage V_{AA} to be constant. Comparing FIG. 10A with FIG. 10B, the noise injecting node and the protected node are exactly reverse. It shows the essential difference between the current regulator CR and voltage regulator VR. The current regulator CR has the completely different functional features from the voltage regulator.

As shown in FIG. 10C, the comparison table summarizes the difference between the conventional approach and the Green Technology. In the conventional approach, the system is partitioned to be multi-chip of the RF/AF analog chip, mixed signal chip, digital and FPGA chip. The Green Technology uses the single chip system approach. It saves power and has higher performance. The conventional multi-chip system uses the on-board bypass capacitor. The on-board bypass capacitor will generate much more on-chip digital switching noise. The conventional system dumps the noise on the board. The Green Technology confines the noise on the local chip. The conventional uses the voltage regulator to isolate the analog circuit from the on-board power and ground noise. The Green Technology uses the current regulator to isolate the digital switch circuit to keep the switching noise from the contamination of the on-board power and ground. The conventional system uses the voltage regulator VR to generate the internal constant chip voltage V_{AA} for the analog circuit. The Green Technology uses the current regulator to generate the constant current for the digital switching circuit.

Comparing the voltage regulator VR in FIG. 10D and the current regulator CR in FIG. 10E, the voltage regulator VR is to filter the voltage oscillation in Vcc to generate the constant voltage at V_{AA} node; the current regulator CR is to filter the current spikes in the V_{DD} to generate the constant current in node Vcc. The current regulator CR has the conjugate and opposite functions of the voltage regulator VR.

From the power source view, we compare and make the analysis for the characteristics of the current regulator. As shown in FIG. 11A, it is the characteristic curve and symbol of the voltage source of the voltage regulator VR. The output voltage is constant over all the current load. As shown in FIG. 11B, it is the characteristic curve and symbol of the current source. The output current is constant over all the voltage load. As shown in FIG. 11C, it is the characteristic curve and symbol of the current regulator. Both the output current and voltage are the specified constants. So, the current regulator is neither the voltage source nor the current source. The current regulator is the new kind of power source. Furthermore, for the dynamic loading, the output current load varies but the output voltage is constant. This is the adaptive smart current regulator. However, the current regulator is different from the voltage regulator. The voltage regulator has to be high speed and broad spectrum circuit to keep the out voltage to be constant. The current regulator can be low speed and narrow spectrum circuit to keep the output current to be constant.

As shown in FIG. 12A, it is the digital switching curve with the slow wandering. The slow wandering comes from oscillation having the large on-board capacitance, etc. The spectrum of the digital switching curve is shown in the FIG. 12B. The high frequency band is the digital switch. The low frequency is the wandering baseline coming from the large on-board capacitance, etc. FIG. 12C2. FIG. 12C3 and FIG. 12C4 are the waveform, symbol, spectrum of the input and output signals of the current regulator CR. FIG. 12D2, FIG. 12D3 and FIG. 12D4 are the waveform, symbol, spectrum of the input and output signals of the current regulator VR.

In FIG. 12C1 and FIG. 12C2, the power noise PNi input is at VDD and the output is the constant or very slow varying current ICC. The control signal Vct1 makes the slow varying to keep the current ICC to be constant. As shown in FIG. 12C3, the power noise PNi input has both high frequency digital switching noise and the low frequency wandering baseline. As shown in FIG. 12C4, the control signal Vct1 only has the low frequency control for the low frequency wandering baseline.

On the contrary, in FIG. 12D11 and FIG. 12D2, the power noise PNi input is at V_{CC} and the output is the constant voltage V_{AA}. The control signal Vct1 needs to be the fast varying to keep the voltage V_{AA} to be constant. As shown in FIG. 12D3, the power noise PNi input has both high frequency digital switching noise and the low frequency wandering baseline. As shown in FIG. 12D4, the control signal Vct1 only has both high frequency control for the digital switching and the low frequency control for the low frequency wandering baseline.

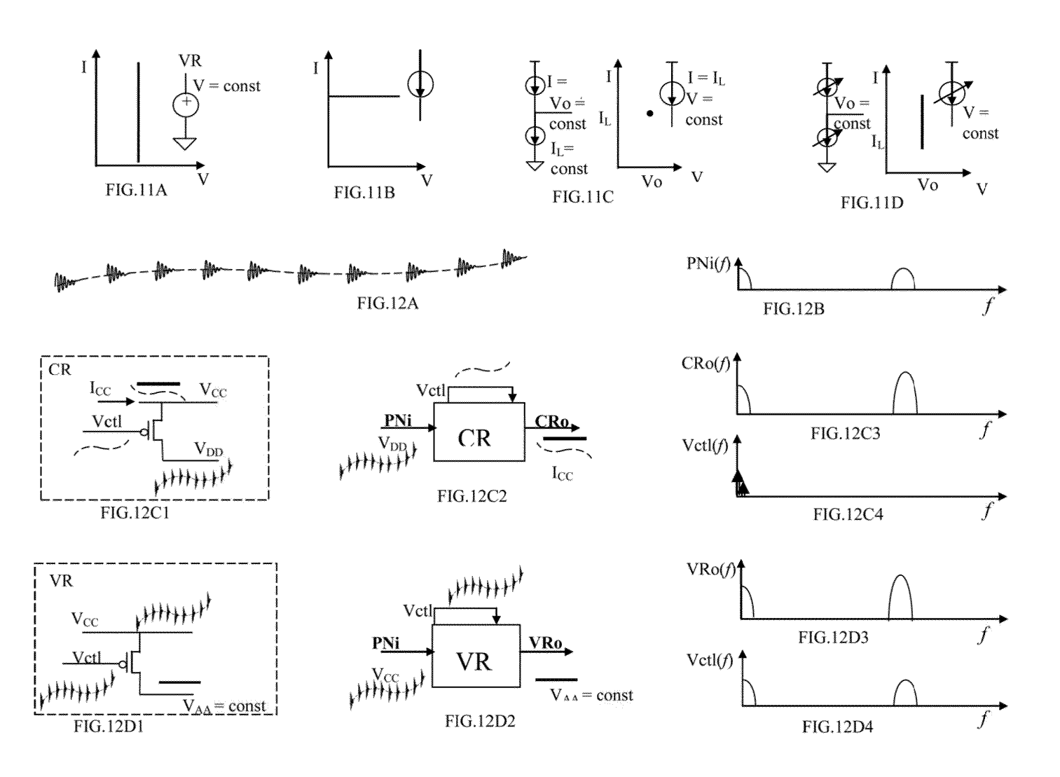

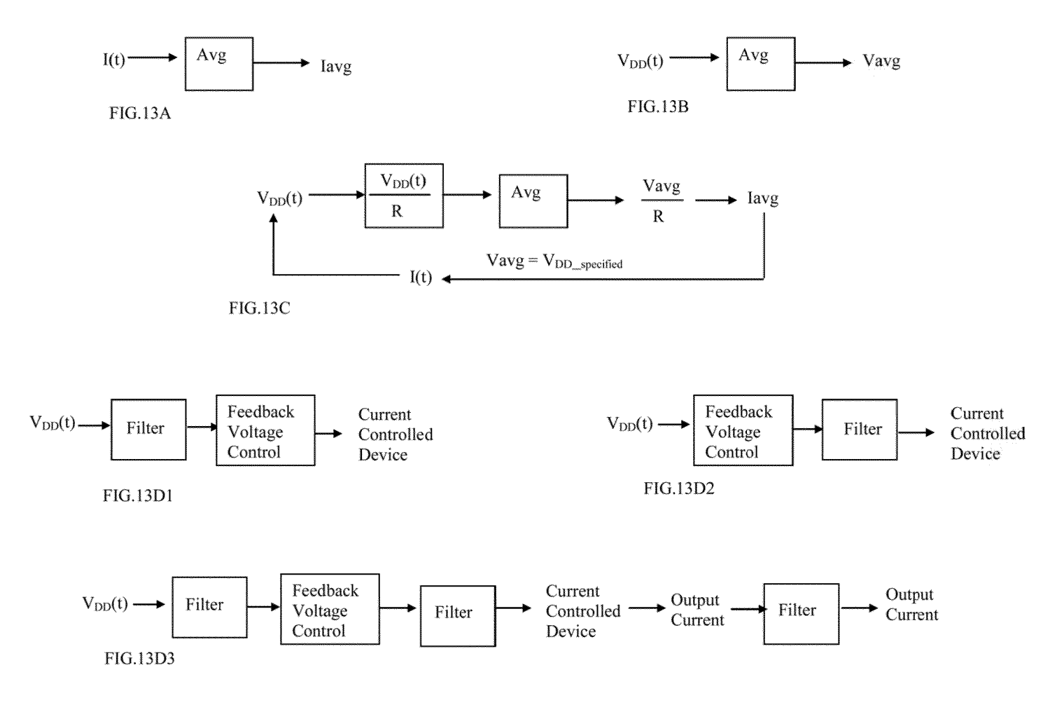

To generate the low frequency control signal for the current regulator, we need to extract the baseline wandering information from the input PNi digital switching power noise signal. As shown in FIG. 13, there are versatile different ways to extract the baseline wandering information from the input PNi digital switching power noise signal.

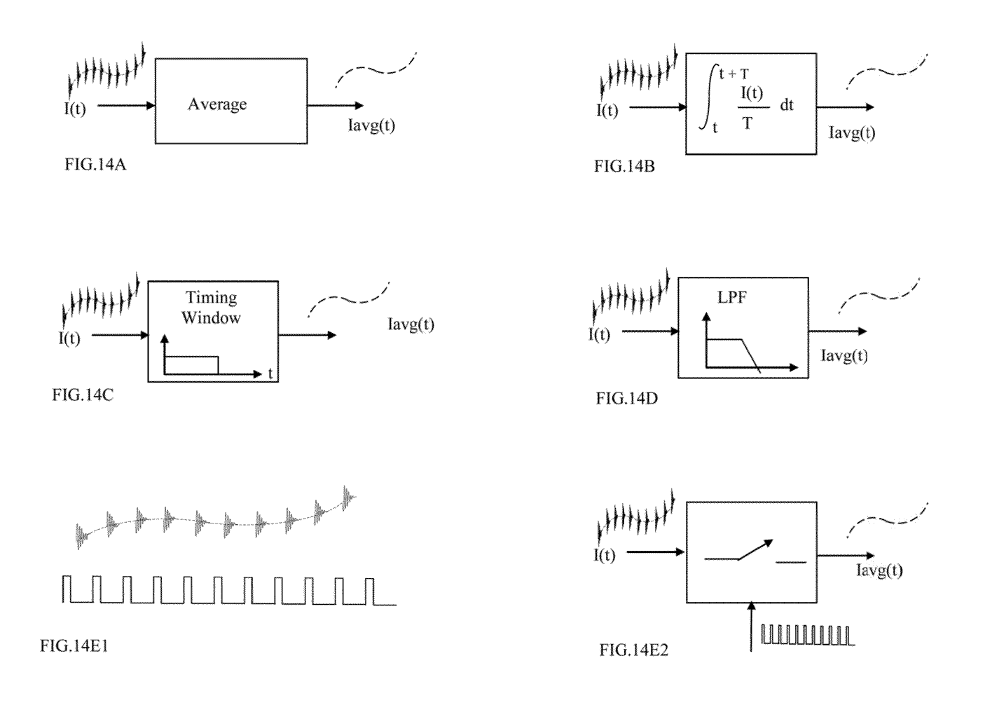

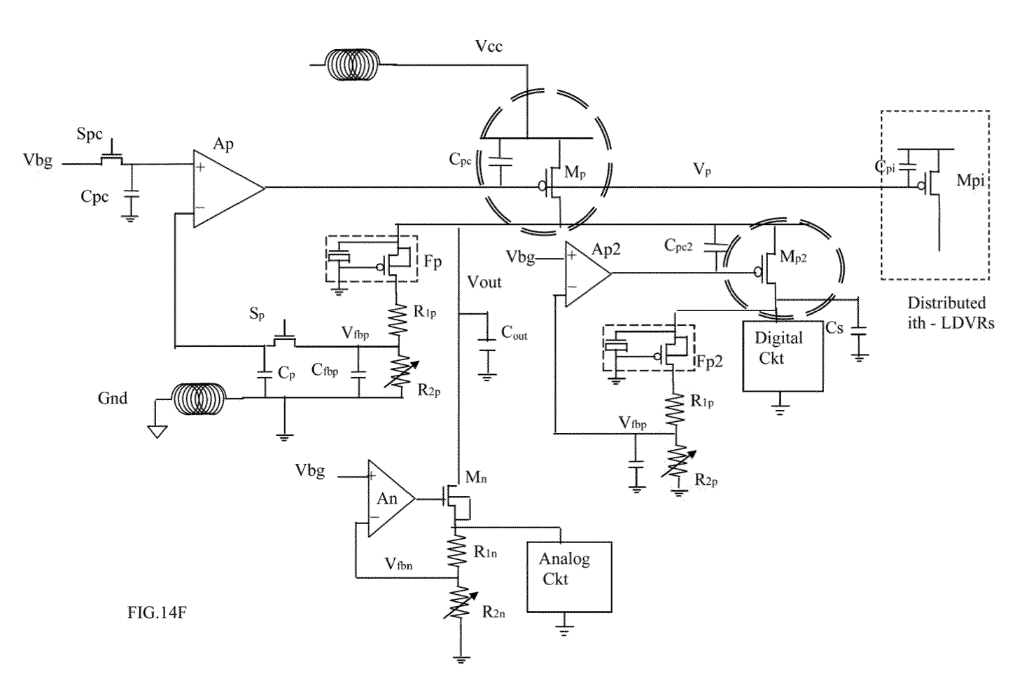

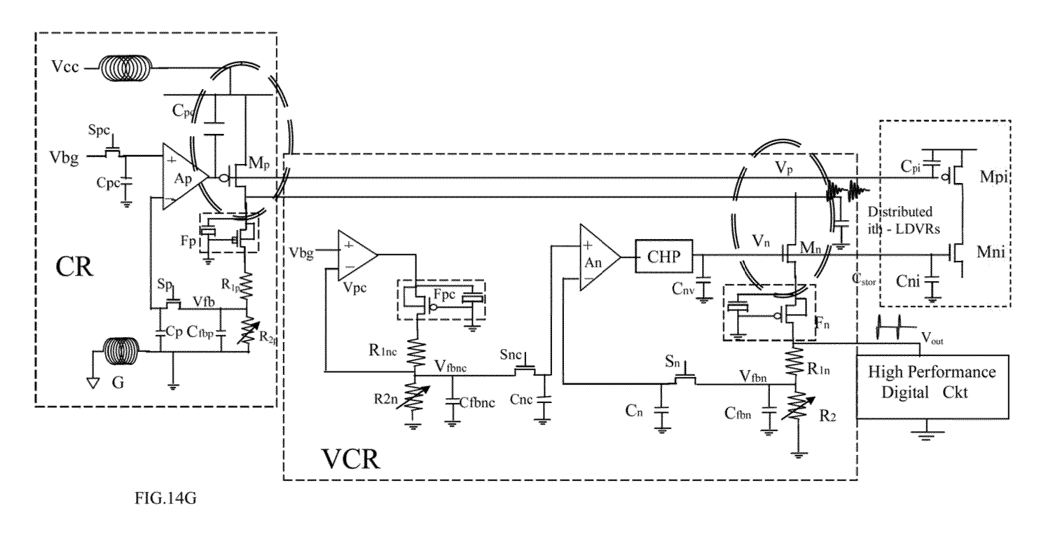

FIG. 13A is the basic block diagram of average circuit to extract the average value I_{avg} from current I(t). FIG. 13B is the basic block diagram of average circuit to extract the average value V_{avg} from current V(t). FIG. 13C is the block diagram which generates the average current from the voltage instead of the current directly. The fundamental principle of the current regulator is to minimize the variance of current flowing through the parasitic inductor of the bonding wire and pin, etc. The current flowing through the parasitic inductor is only the average of the current. The feedback control circuit provides the low frequency current to current loading and keeps the voltage to be the specified voltage level. The abrupt change and variance of switching current is absorbed by the storage capacitor. There are many different implementations of the above principles. As shown in FIG. 13D1 and the F_{P} in FIG. 14F, the switching noise is filtered out first, then the low frequency signal is compared with the reference voltage to generate the control signal. This pre-filter is the preferred implementation. Of course, as shown in FIG. 13D2, there is possible to have the alternative post-filter implementation to feedback the voltage first then filter the switch noise. However, in the practical implementation, as shown in FIG. 13D3 and FIG. 18C, both the pre-filter of FP and post-filter made of the Cpc and the output impedance of amplifier AP are adopted. Furthermore, as shown in FIG. 18C, the cascade current regulators and the cascade filter FP3 are adopted. The green technology integration system has the current regulator further comprises the filter and feedback and comparing circuits. The filter filters out the high frequency variance of output current loading to get low frequency variance of output current loading. The feedback and comparing circuits feedback the information of variance of output current loading. The current devices are controlled based on the information of the low frequency variance of output loading current.

FIG. 14 illustrates the versatile techniques to generate the dynamic average current. FIG. 14A is to use the average circuit to generate Iavg(t) from I(t). The current regulator comprises filter and feedback and comparator. The filter filters out high frequency variance of loading to get low frequency variance of loading. The feedback and comparator feedback information of variance of loading. A plural of current device is controlled based on information of said low frequency variance of loading. FIG. 14B is the timing integration block to generate the Iavg(t) from I(t). FIG. 14C is the timing window to generate the Iavg(t) from I(t). FIG. 14D is to use the low pass filter to generate the Iavg(t) from I(t). FIG. 14E1 shows the waveform of the power buses and clock. At the clock edge, the simultaneous switches of the digital circuit generate the switch noises instantly. The switch noises then die away to be the average value. As shown in FIG. 14E2, the sampling circuit samples the average value at the average value period to get the average value Iavg(t). According to the principle illustrated in the FIG. 13C, FIG. 14F shows the current regulator design which integrates of the above techniques to have the practical application. The filter Fp is to serve as the filter as shown in FIG. 14D to generate the average voltage for the average current. The voltage divider R1p, R2 and Cfbp are the feedback circuit and filter. The sampler Sp is to sample the average value at the average period to have the much cleaner average value. The sampling gate Spc and capacitor is to compensate for the sampling noise generated by the switch gate Sp. The output capacitor Cpc and the output resistance of the amplifier Ap are constituted of another filter. So, there are four filters are in cascade to get the high quality average current. Finally, the average bias voltage for the average current applying on the P device Mp to generate the constant “current source” which has the “constant” current value Iavg(t) to be the “average” value of the current load I(t). It is noted that the circuit is dynamical that the Iavg(t) is also dynamic. The “constant” means over a short time period of time window. The time window shifts and the “constant” value also varies and shift slowly at very low frequency. For a short period time, the average value can be treated as a constant. For the constant current, L(dIavg/dt)=0, the voltage across the inductor is zero, i.e., the switching noise generated by the inductor is zero.

As shown in FIG. 14F and FIG. 18C, the green technology integration system has the current regulator comprising P type current devices and N type current devices. The P type current device M_{P} and N type current device M_{N} are connected in cascade with drains. The capacitor C_{OUT} is connected to the drains of devices. As shown in FIG. 14G, the Hybrid current regulator HCR is made of the P type current regulator PCR and N type current regulator NCR. FIG. 14G is the cascade of the voltage regulators of the current regulator and it is the hybrid voltage regulator of P-type current regulator PCR and N-type current regulator NCR. The current regulator CR has the constant current flowing through the P-type current regulator and the N-type current regulator is to minimize the switching noise as seen by the high performance circuit to have the fast circuit speed and less noise. The noise is isolated in the capacitor between the P-type current regulator and the N-type current regulator that both the inductor and circuit do not see the violent switching noise. The hybrid current regulator is much better than the two P-type cascaded current regulators as shown in FIG. 18. The two P-type cascaded current regulator has the NIF to be 1800; however, the hybrid current regulator has the NIF much larger than 1800.

FIG. 15A is the basic system and architecture of the Noise Isolation Technology. The noise isolation comprises capacitor at current output to absorb variance of current loading to keep variance of current flowing through current regulator to be minimum. FIG. 15B is the circuit implementation of the Noise Isolation Technology. FIG. 15A illustrates the fundamental principles of the Noise Isolation Technology. In FIG. 15A, the current regulator CR is the constant value DC current I_{DC} of the current average I_{avg}. First, assumes the RF/AF/Analog circuit does not exist that only the current flows through the current regulator CR. Applying the Kirchhoff's current law at the cross-section as shown in FIG. 15A, the current I_{LC} flows through the inductor of the power supply is equal to the current I_{LC} flows through the inductor of the ground. I_{LV}=I_{DC}=I_{LG}=constant. So the voltage across inductors LV(dI_{DC}/dt)=0 and LG(dI_{DC}/dt)=0. In other words, there is no switching noise generated by the inductor L_{V} and L_{G}. The on-chip ground or substrate voltage Vss is the same voltage as the on-board ground.

The same argument can be applied to the circuit having the RF/AF/Analog circuit. As shown in FIG. 15A, the current flowing through the RF/AF/Analog circuit is constant. Both the current regulator and the RF/AF/Analog circuit are constants that the current flows through inductor LV and LG are constant. The on-chip ground or substrate voltage Vss is the same voltage as the on-board ground.

FIG. 15B is the circuit for the current regulator. The current regulator is very similar to the voltage regulator. However, the function of the circuit is much different from the voltage regulator. The voltage regulator is to keep the “output voltage” to be constant. However, the current regulator is to keep the “input current” to be constant. The difference between the current regulator and voltage regulator is the current regulator having the addition of the low pass filters such as Fp and Cpc to the voltage regulator. The voltage regulator has to be fast response for the high frequency switch noise. The current regulator is only to trace and follow the low frequency average current.

To increase the switching noise rejection capability, the current regulator can be cascaded to get the high ratio of the switch noise rejection. The Noise Isolation Factor of the switch noise rejection is defined as

NIF=Switching Noise in Isolated Power Bus Switching Noise in Substrate

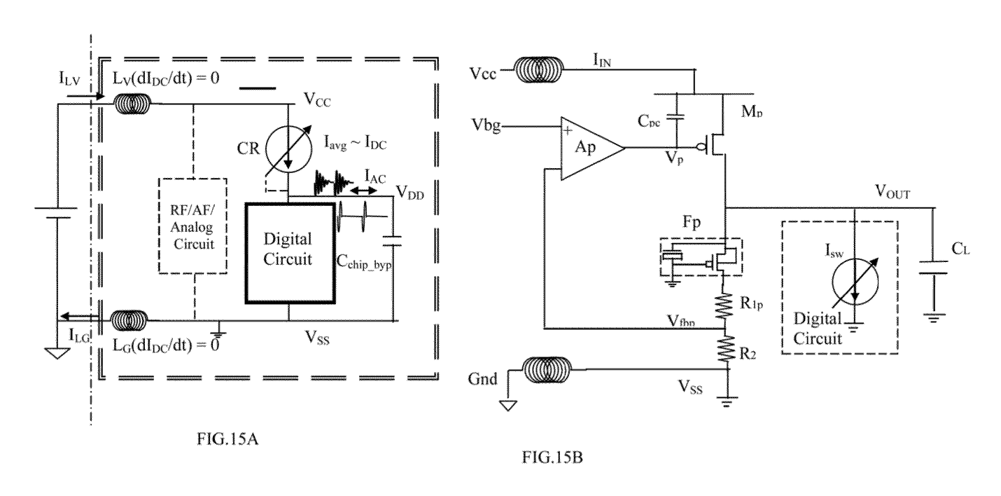

As shown in FIG. 16A, for the cascade current regulator, the total SNRR

NIF=NIF₁×NIF₂

where the NIF₁ is the NIF of the first stage current regulator and the NIF₂ is the NIF of the second stage current regulator. Usually one stage current regulator has the SNRR to be 50. For the two stage current regulator, the SNRR is bout 2500. It is equivalent to 13 Bits improvement for ADC. FIG. 16B is the circuit for the 2-stage cascade current regulator.

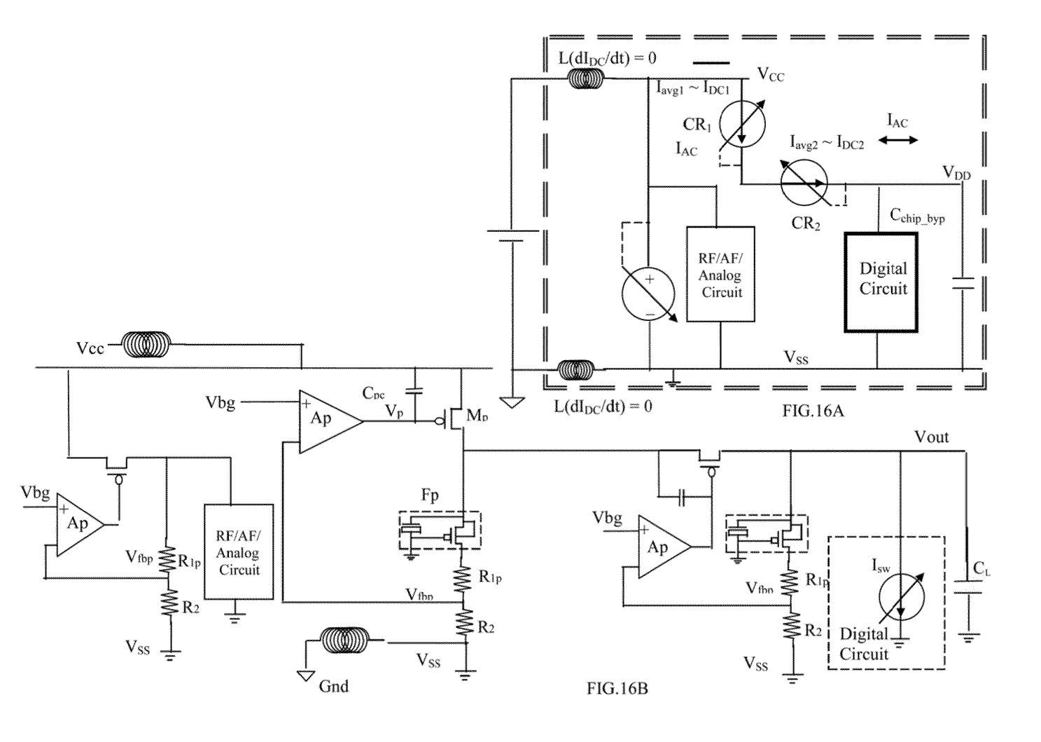

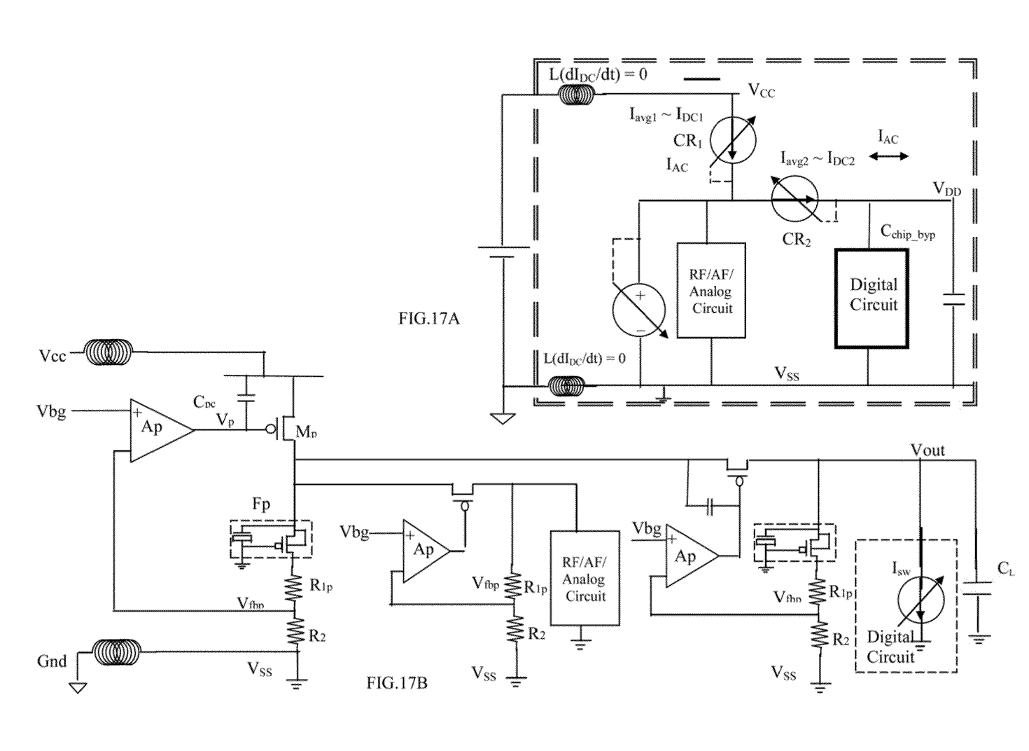

As shown in FIG. 17A, for the cascade current regulator architecture, there is another possibility for the RF/AF/Analog Circuit. The RF/AF/Analog Circuit can be located between the two current regulators. FIG. 17B is the circuit implementation of the FIG. 17A.

Referring to FIG. 18C, the green technology integration system has the noise isolation means is constituted of a plural of cascading controlled current devices MP1, MP2 to regulate the current flowing through the parasitic inductor to reduce noise generated by the parasitic inductor. Furthermore, with the basic patterns, we can have the versatile combinations of the different patterns for the noise isolation technology. The noise isolation means further comprising a plural of filters FP1, FP2 to filter the high-frequency noise to control a plural of cascading controlled current devices. FIG. 18 is the basic pattern of the cascade of the current generators. FIG. 18A is the block diagram for the cascade current generators. FIG. 18B is the system and architecture of the cascade current generators. FIG. 18C is the circuit of the cascade current generators. As shown in FIG. 18D, it is the SPICE simulation to show the switching noise of digital circuit as shown in FIG. 6A. As shown in FIG. 18D, it is the SPICE simulation with the Noise Isolation Technology Circuit in FIG. 18C to show the switching noise of digital circuit as shown in FIG. 6C. The Noise Isolation Factor NIF is 1800. Referring to FIG. 18C, the noise isolation means comprises a plural of cascading controlled current devices MP1, MP2 and filters FP3 to regulate current flowing through the parasitic inductor means to reduce noise generated by the parasitic inductor means.

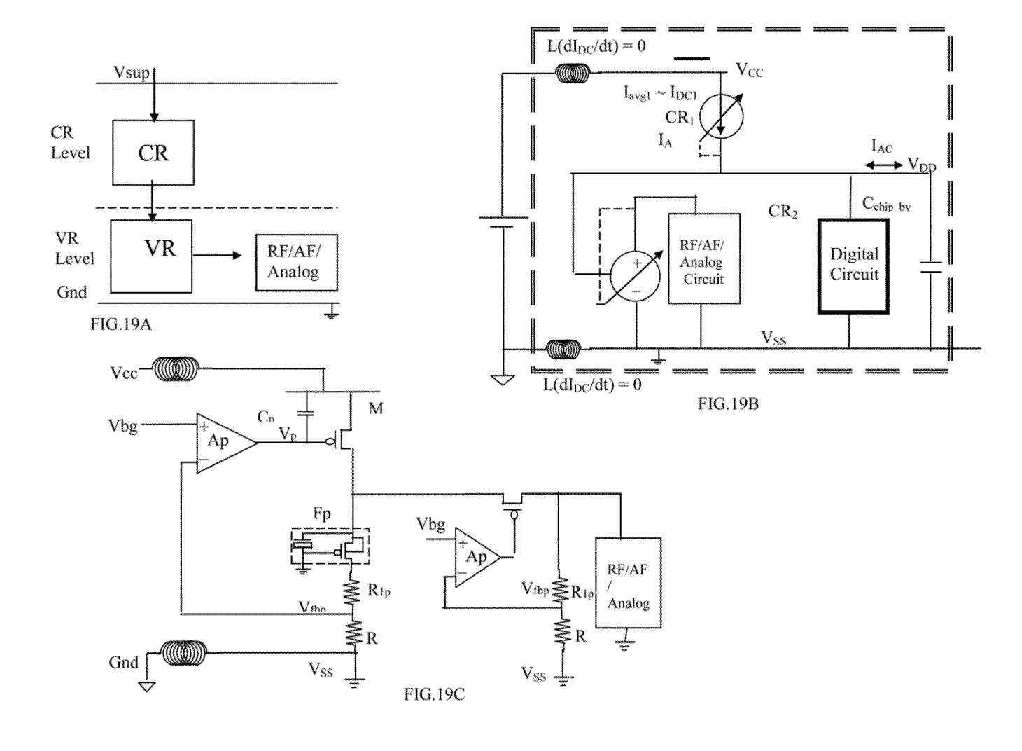

FIG. 19 is the cascade of the current regulator and the voltage regulator. FIG. 19A is the block diagram of the current regulator and the voltage regulator. FIG. 19B is the system and architecture of the cascade current generator and voltage regulator. FIG. 19C is the circuit of the cascade current generator and voltage regulator.

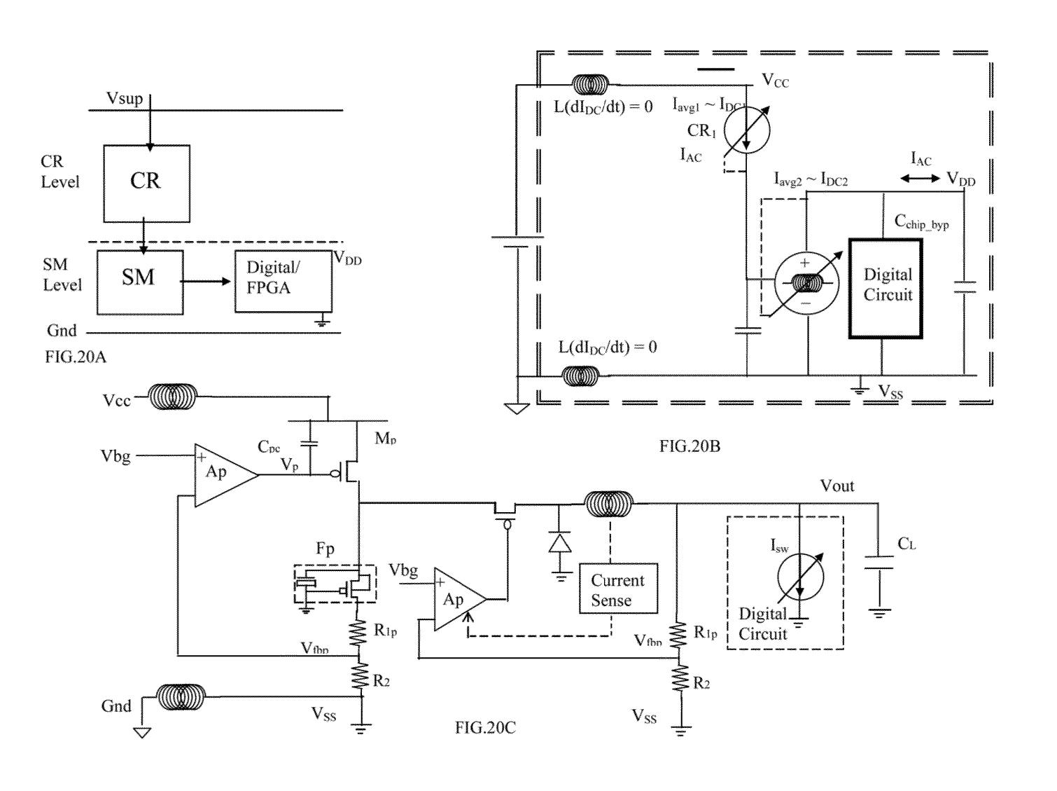

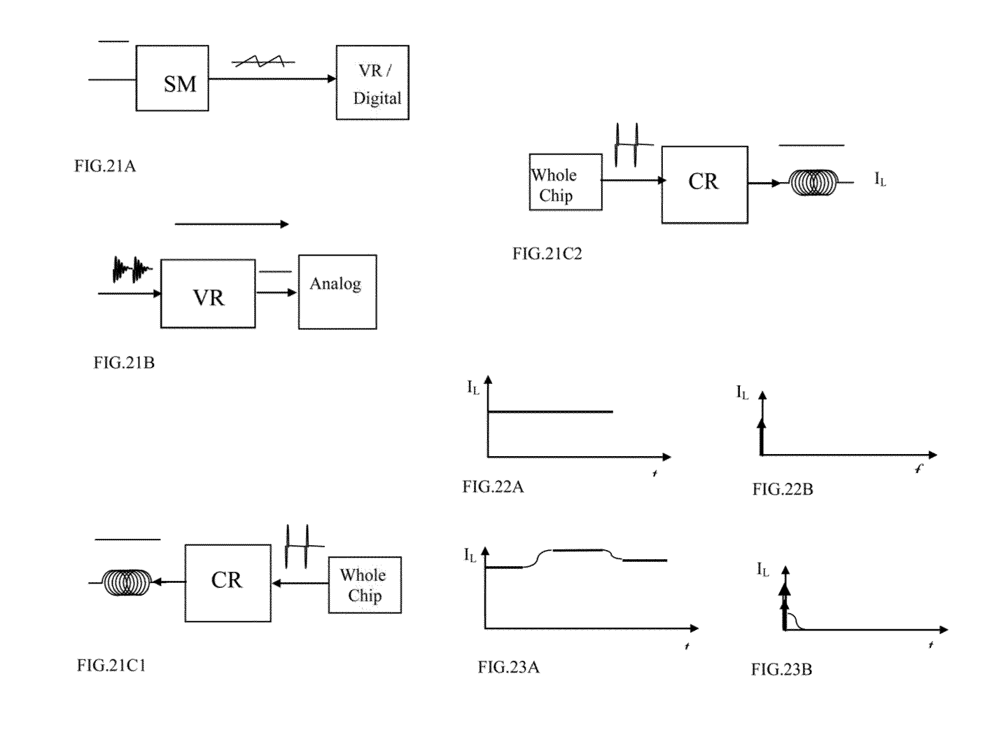

FIG. 20 is the cascade of the current regulator and the Switch Mode power supply. FIG. 20A is the block diagram of the current regulator and the Switch Mode power supply. FIG. 20B is the system and architecture example of the cascade current generator and Switch Mode power supply. FIG. 20C is the circuit example of the cascade current generator and Switch Mode power supply of buck converter. It is noted that FIG. 20B and FIG. 20C are shown only one example of the Switch Mode power supply. The switch mode power supply can be boost converter, buck converter, etc.

FIG. 21 is to make the comparisons among the three different power management unit. Switch Mode SM, Voltage Regulator VR and Current Regulator CR. In FIG. 21A, the Switch Mode power supply changes the power from one voltage level to another voltage level. The output voltage has the ripple voltage. The output voltage is fed into the voltage regulator VR or directly to be the low voltage digital circuit, etc. In FIG. 21B, the voltage regulator VR is to filter the input power noise to have the output voltage to be the clean constant voltage for the analog circuit. FIG. 21C1 is the block diagram of the current regulator which is analogy to the voltage regulator VR. However, the signal flow is in the backward direction. So, the forward direction signal flow diagram is as shown in FIG. 21C2. FIG. 22A is the current regulator for the constant average current output loading I_{L}. FIG. 22B is the frequency spectrum for the constant output inductor current I_{L} of the current regulator. FIG. 23A is the current regulator for the slow varying average current output loading I_{L}. FIG. 23B is the frequency spectrum for the slow varying output inductor current I_{L} of the current regulator.

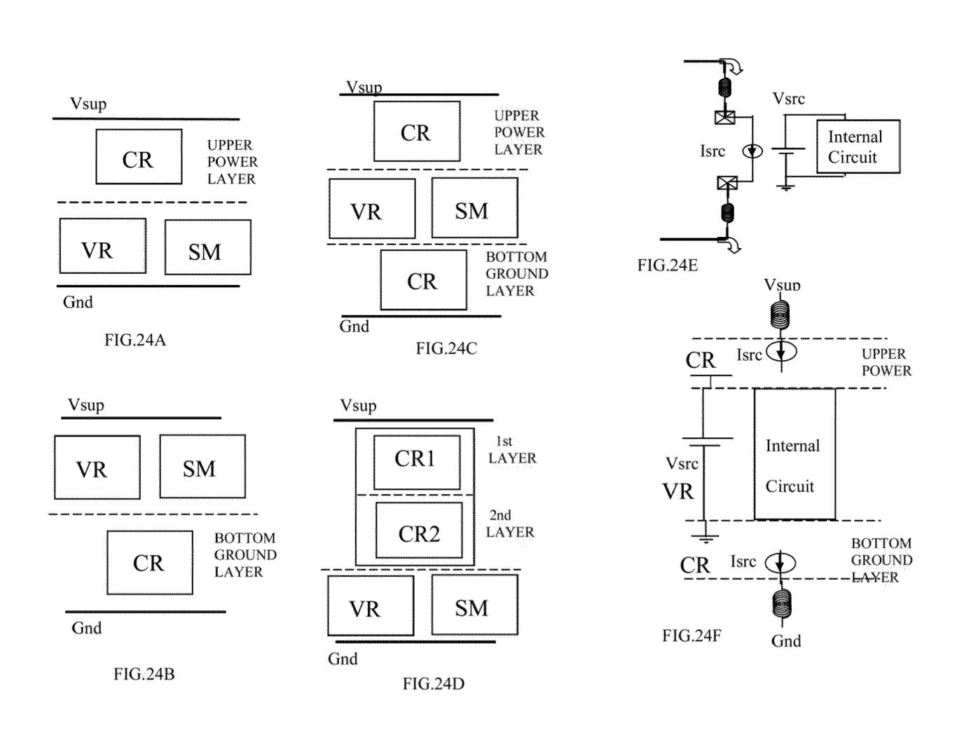

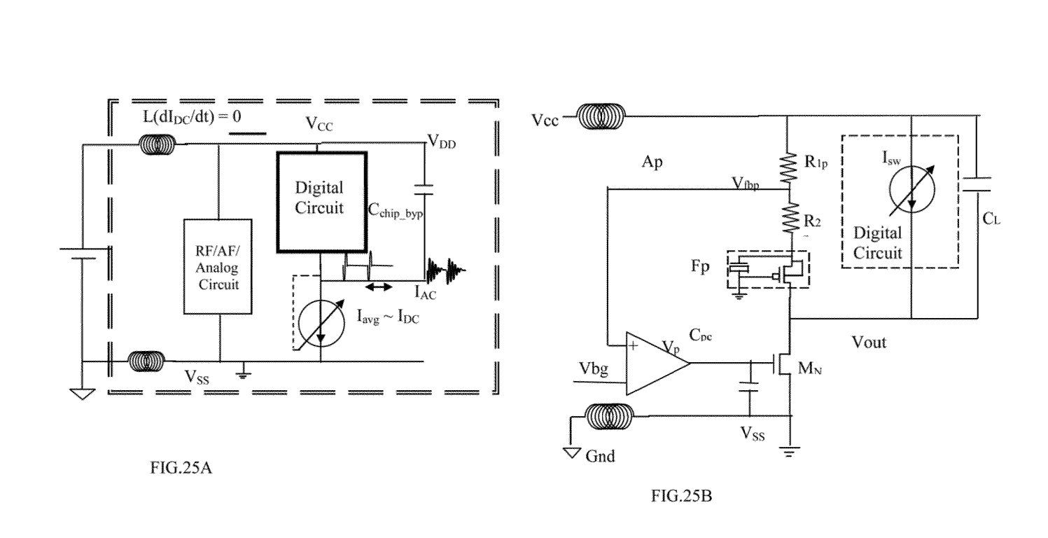

With the manipulation of the block diagrams, we can make novel innovations of the Noise Isolation Technology in the system and architecture level. FIG. 24A is the basic system and architecture of the noise isolation technology. The current regulator is at the upper power layer and the voltage regulator and the switch mode power supply are at the low layer. FIG. 24B is the conjugate architecture of FIG. 24A. The current regulator is at the lower ground layer and the voltage regulator and the switch mode power supply are at the upper layer. The system and architecture is shown as FIG. 25A and the circuit implementation is shown as FIG. 25B.

To have the higher Noise Isolation Factor NIF, as shown in FIG. 24C, the current regulators are in both upper layer and ground layer. The Noise Isolation Factor is

NIF=NIF_{P}×NIF_{G}

where the NIF_{P} is the NIF of the current regulator at upper power layer and the NIF_{G} is the NIF of the current regulator at upper power layer.

Similarly, we can have the different ways to cascade the current regulator. As shown in FIG. 24D, all the current regulators are in the upper power layer. It can be interpreted that the current regulator CR is the hierarchical current regulator having the current regulator CR₁ to be cascaded with the current regulator CR₂. The cascade current regulators are as shown in FIG. 18. FIG. 18A is the system and block diagram of the cascade current regulator. FIG. 18B is the architecture of the cascade current regulator. FIG. 18C is the circuit of the cascade current regulator.

Applying the hierarchical principles to the versatile combination of the current regulator, voltage regulator and switch mode power supply, there are many different novel power and ground plan. With the versatile novel combination, as shown in FIG. 24E, it is the equivalent circuit for the ideal power supply. The board provide the constant/average current source to the chip and the chip generate the constant/voltage source to the circuit. As shown in FIG. 24F, it is the architecture of the ideal power supply which is corresponding to the ideal circuit as shown in FIG. 24E. It is equivalent to the system and block diagram as shown in FIG. 24C.

The current regulator comprises a plural of P type current devices and N type current devices. The P type current device and N type current device are connected in cascade with draining node being connected together. The capacitor is connected to draining nodes.

A green technology noise isolation integration system comprises a plural of cascading controlled current device with addition of a plural of cascading filter to regulate current flowing through parasitic inductor to reduce noise generated by parasitic inductor. FIG. 25A is the conjugate Noise Isolation Technology as shown in FIG. 15A. The P device is changed to be the N device M_{N} and the power bus Vcc is changed to be the Ground Bus Vss. FIG. 26A is the alternative design of the FIG. 24C to have the cascade current regulator effect to increase the Noise Isolation Factor NIF. Even FIG. 25A has slightly better NIF, since the cascade effect is the same and the FIG. 26A can have the multiple distributed power structure as shown in FIG. 27A, the FIG. 26 E is the Preferred implementation. As shown in FIG. 26C, the green technology integrated system noise isolation comprises a plural of cascading controlled current device and filter to regulate current flowing through the parasitic inductor to reduce noise generated by the parasitic inductor.

Wireless Window 5R System W5RS comprises substrate noiseless P&G plan having all the ground nets being connected together going through one LDO typed constant current source. In FIG. 26E, all the ground nets are connected together. As shown in FIG. 26E, the Noise Management has all the ground nets connected to one constant current switch before connecting to the bonding wire & Pad=>zero-noise substrate. Furthermore, as shown in FIG. 26D2 and FIG. 26F, the output buffer has non-overlap, tri-state and voltage clamping mechanism made of MCP and MCN. A Wireless Window 5R System W5RS further comprises ground-bounce-less output buffer. The ground-bounce-less output buffer further comprises non-overlapping mechanism, tri-state mechanism and clamping mechanism. The clamping mechanism detects the undershoot of the ground-bounce-less output buffer and turns off said N type output device. The clamping mechanism detecting overshoot of the ground-bounce-less output buffer and turns off the P type output device.

FIG. 26G is the programmable LDO which can be programmed to be analog LDO and digital LDO. Furthermore, programmable LDO is the “Auto-LDO” which is constituted of the steering-wheel, brake and accelerator. The combinatory operations of brake mechanism and accelerator mechanism of the “Auto-LDO” can have the smooth and fast transition without overshoot in the startup and POS Power-On-Sequence. A Wireless Window 5R System W5RS further comprising a overshootless LDO having brake module to deliver overshootless DC output power at an output voltage during the startup process. The overshootless LDO has one error amplifier having steering wheel function module and voltage divider. The voltage divider means dividing said output voltage to generate a feedback voltage V_{FB}. The error amplifier has a reference voltage V_{BG} and said feedback voltage V_{FB} been connected as inputs. A switch MOS connects the reference voltage V_{BG} input terminal of said error amplifier with feedback voltage V_{FB} input terminal of the error amplifier as the feedback voltage V_{FB} is less than the reference voltage V_{BG}.

As shown in FIG. 26G. Wireless Window 5R System W5RS also comprises a rippleless LDO to deliver rippleless DC output power at an output voltage. The rippleless LDO has one error amplifier and voltage divider. The voltage divider divides the output voltage to generate a feedback voltage V_{FB}. The error amplifier has a reference voltage V_{BG} and the feedback voltage V_{FB} been connected as inputs.

There are two orthogonal conjugated Accelerator function modules to be the biasing current injecting means to modulate the biasing current in the error amplifier. As the feedback voltage V_{FB} is not equal to reference voltage V_{BG}, to increase the bandwidth of the error amplifier to speedup the error amplifier in correct direction in orthogonal conjugated common-mode accelerator mode, the two orthogonal conjugated Accelerator modules will push-pull the common mode voltage of the error amplifier to compensate the error voltage generated by V_{FB} and V_{BG}. FIG. 26H is the alternative design of the Programmable A&D LDO having Analog &Digital, Brake/Accelerating/Wheeling programmable LDO with trans-impedance cascade Amplifier. The Programmable A&D LDO having the trans-impedance cascade Amplifier can reduce the ripples of digital circuit to be rippleless LDO.

FIG. 27 shows how the Noise Isolation Technology is applied to the conventional chip to serve as IP with the wrapper structure. FIG. 27A is the general Noise Isolation Technology architecture. FIG. 27B is the general mixed-signal type chip which integrates all the RF/AF/Analog with Digital/FPGA. FIG. 27C is the wrapper structure of the IP of the current regulator to wrap around the conventional mixed-signal type chip.

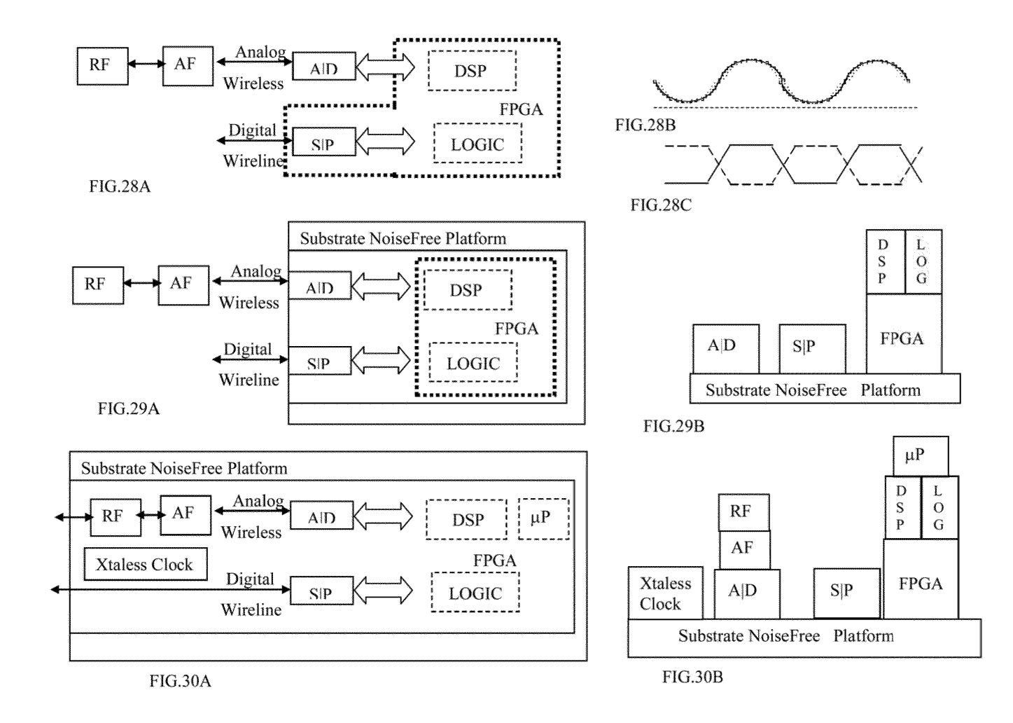

FIG. 28 shows the details of the general mixed-signal type chip. It illustrates the state of art of semiconductor industry. A|D represents analog to digital conversion AD and/or digital to analog conversion D/A. S|P represents serial to parallel conversion S/P and/or parallel to serial conversion P/S. The FPGA has merged the logic, Digital Signal Processor DSP, the Serial/Parallel and Parallel/Serial two-way Conversions S|P together. The Radio Front RF, Analog Front AF, the Analog to Digital Conversion (ADC) and Digital to Analog Conversion (DAC) AD are excluded due to the substrate noise. As shown in FIG. 28B, it is the A|D overlapping waveform of the analog input and digital output. As shown in FIG. 28C, it is the logic signal of the S|P in the analog wave form. The A|D signal steps are much smaller than the S|P logic signal. The small A|D signal steps make the A|D is much more susceptible to the substrate noise. The FPGA has a lot digital circuit and injects a lot of switching noise into the substrate. Even worse, the higher frequency is, the higher slew rate is, the larger switching noise is, the lower the circuit performance is. The substrate switching noise forbids the signal path integration of the high speed and high performance A|D. So, today the FPGA only can integrate the logic path integration of S|P and low speed and low performance ADC. Even worse, the embedded controller needs to shut down all the digital circuit during the ADC operation.

For the signal path, after A|D, it is the DSP. For the logic path, after S|P, it is the combinatory logic. As shown in FIG. 28A, today FPGA only can integrate DSP, S|P and Logic circuit. As shown in FIG. 29A, with our novel Noise Isolation Technology, the A|D of ADC and DAC can be integrated into FPGA. FIG. 29B shows the Noise Isolation Technology is the platform to integrate the A|D, S|P. FPGA, DSP and Logic all together.

A green technology integration system comprises the field programmable gate array FPGA, the ADC and DAC conversion between analog and digital. The green technology integration system integrates the FPGA, the ADC and DAC conversion between analog and digital on the platform made of noise isolation technology to be field programmable integrated chip FSOC.

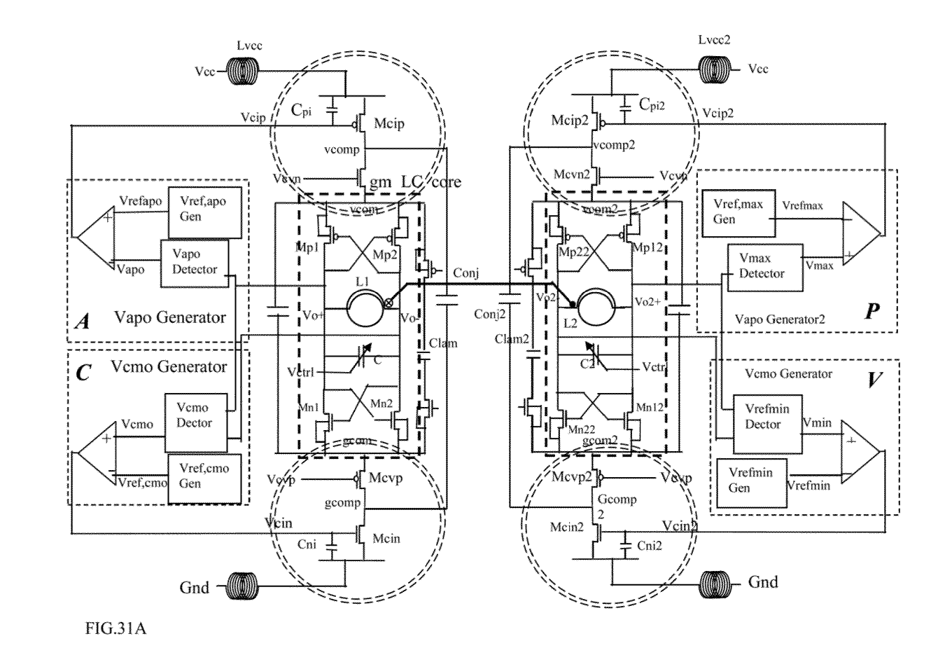

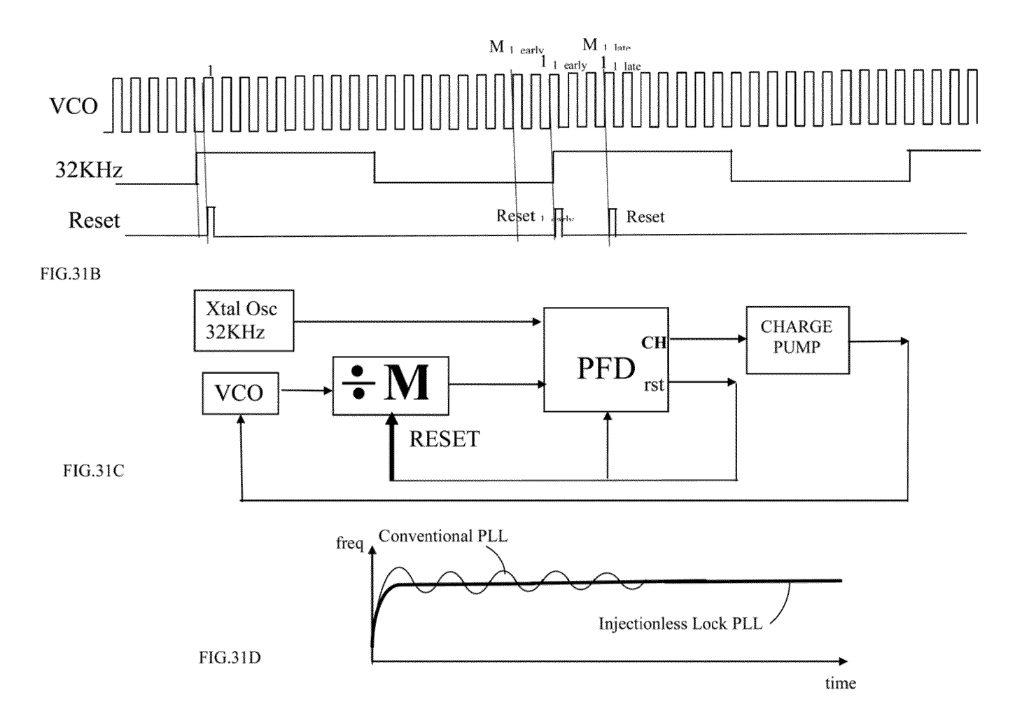

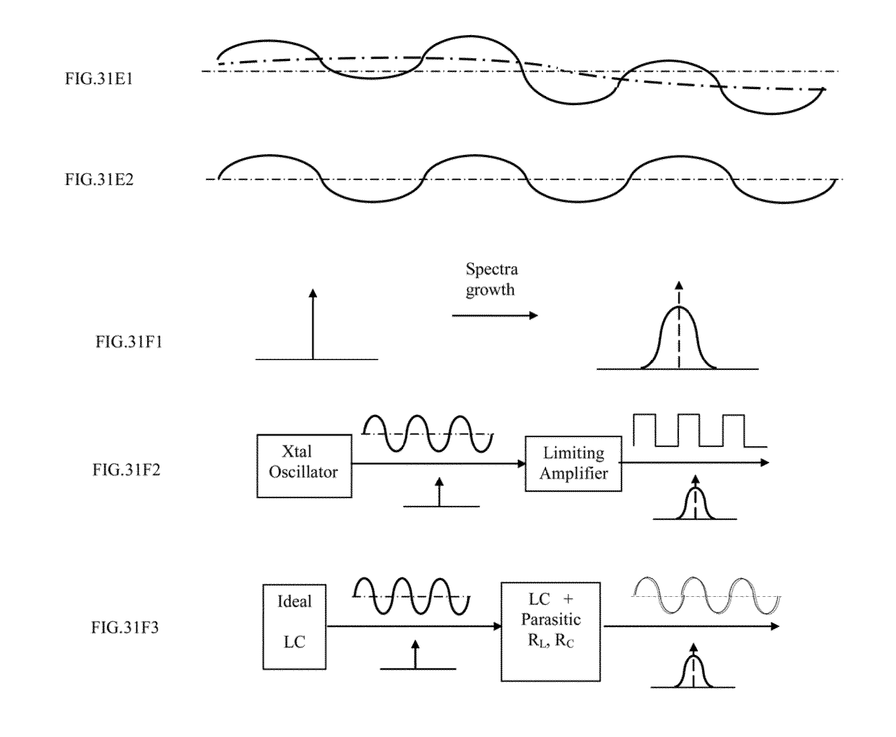

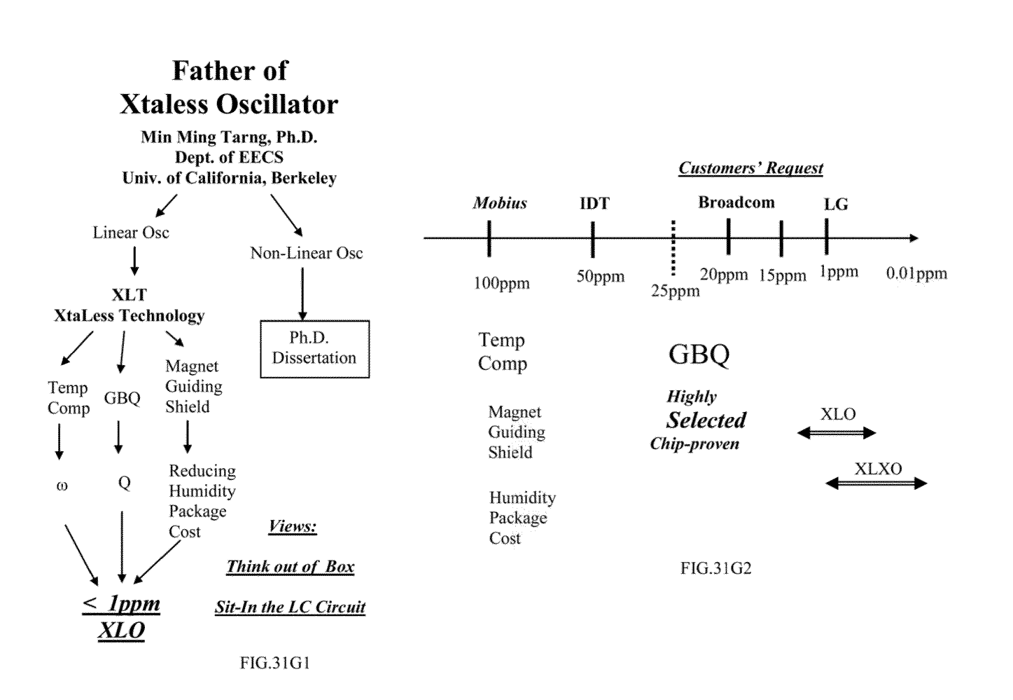

Furthermore, as shown in FIG. 30A, with our noise isolation technology, the RF and AF are all integrated into one single chip, FSOC. FIG. 30B shows the Noise Isolation Technology is the platform for the integration of the FSOC. Both the ADC and the LC resonator of the Xtaless Clock are very sensitive to the substrate noise.

The green technology integration system comprises the digital signal processing DSP and the application specific integrated circuit ASIC. The ASIC can be the combinatory integration of the radio front RF, analog front AF, analog, mixed signal, etc. The green technology integration system integrates the ASIC with DSP on the platform made of the noise isolation technology to be field programmable integrated chip FSOC. This DSP can be the portion of FPGA that the ASIC is integrated with FPGA. The green technology integration system also comprises microprocessor and the application specific integrated circuit ASIC. The green technology integration system integrates the ASIC and microprocessor on the platform made of the noise isolation technology to be the field programmable integrated chip FSOC. This microprocessor can be the portion of FPGA that the ASIC is integrated with FPGA too.

As shown in FIG. 27C, FIG. 30A and FIG. 30B, the green technology integration system has the noise isolation to be the platform serving as wrapper to integrate the versatile combinations of application specific integrated circuit ASIC means, field programmable gate array FPGA means, conversion means between analog and digital, digital signal processing DSP, microprocessor means, RF/AF/Analog circuit and digital circuit to be field programmable integrated chip FSOC.

As shown in FIG. 31A, it is the combination of the FIG. 14G and FIG. 25B. As shown in FIG. 14G and FIG. 31A, the Xtaless oscillator adopts the embedded Hybrid Current Regulator Noise Isolation technology. The P-device and N-device marked with the dotted circle are corresponding to the P-type current regulator PCR and the N-type current regulator NCR. As shown in FIG. 15A, the LC resonator of the Xtaless Clock is located in the RF/AF/Analog Circuit region that adopts the embedded Hybrid current generator Noise Isolation Technology as shown in FIG. 31A. Furthermore, as shown in FIG. 24C, the LC resonator of the Xtaless Clock uses the cascade Hybrid current generator at both the power and ground layer to have the highest quality noise isolation.

As shown in FIG. 31A, the P-device of the hybrid current regulator is controlled by the amplitude control or maximum voltage control; the N-device of the hybrid current regulator is controlled by the common mode control or the minimum voltage control.

The modulation has the innovation of modulation from the amplitude modulation AM to frequency modulation FM. Similarly, the oscillator has the innovation of control from frequency control FC to amplitude control AC.
Modulation innovation: AM=>FM
Oscillator innovation: FC=>AC

Furthermore, we make the unified approach to generalize the passive circuit to be the active circuit as follows.
passive circuit: Q=E(L,C)/R_{dissipative}
   Damping Curve RC decaying envelop [symbol] Q
active circuit: Q=E(L,C)/[R_{dissipative}+(−R)]½I²
   Virtual Damping RC decaying envelop [symbol] Q

Constant Amplitude Control will boost-up the Q as follows.
(−R)>R_{dissipative}: amplitude/voltage envelop exponential grow
(−R)<R_{dissipative}: amplitude/voltage envelop exponential decay
(−R)=R_{dissipative}: amplitude/voltage envelop=const
   −R: gain of circuit
Q=E(L,C)/{[(R_{dissipative}+(−R)]½I2}=E(L,C)/0=∞

Constant Common Mode Control boost-up the Q
gain=f(operating point)=f(V_{baseline})

As the baseline wandering, the gain changes as R(t)!=constant
R_{dissipative}−R(t) !=0
Q=E(L,C)/{[R_{dissipative}+(−R)]½I2}!=E(L,C)/0!∞

We need to have both Constant Amplitude Control and Constant Common Mode Control at the same time to guarantee to have R(t)=constant=R_{dissipative} and Q=∞
Constant Amplitude Control and Constant Common Mode Control
   =>R_{dissipative}=C(−R)
   =>Q=∞

LC oscillator has the gain to oscillate. It also finds the active circuit has larger Q than the passive circuit. However, is not necessary to have the perfect matching of −R(t)=R_{dissipative} all the time.

Due to the relation of

R_{dissipative}+(−R)<R_{dissipative}

so the active circuit has larger Q than the passive circuit. However, Q!=∞. To have the perfect matching of −R(t)=R_{dissipative} all the time to have Q=∞ all the time. As shown in FIG. 31E1 and FIG. 31E2, we especially mention the Constant Amplitude Control and Constant Common Mode Control to be the gain-boost Q. As shown in FIG. 31G2, the customer. Broadcom, requests the clock to have <20 ppm. The object is to replace the high-end Xtal Oscillator, the complete set of ultra-high-Q Xtaless LCO technologies.

Xtaless Clock is to replace Xtal Oscillator. As shown in FIG. 31G1, the Xtaless Technology actually came from UC Berkeley and developed by Dr. Min Ming Tarng in 1980. It is the business of Die. All the following ten ways must be used altogether. It cannot miss anyone of them.

1. Gain-Boost Q LC (400 ppm=>26 ppm)

2. Magnetic Shield/Guiding high-Q inductor=>humidity; Performance

3. Amplitude controlled frequency: varactor-less LCO

4. Active-Device varactorless-compensation

5. Temperature Compensation LC Oscillator R_{L}(T)=R_{C}(T) ω(T)=ωo (400 ppm=>60 ppm)

6. Noiseless Substrate

7. Active Filter to eliminate the double frequency power supply noise

8. On-Chip Heater to speed-up and reducing-cost of test & calibration

9. Plastic Packageable—No need for ceramic

10. Complete-Set Compensation Bandgap VBG & IBG (<0.02%-50° C.˜140° C.)

All the final f curves show the bandgap variation characteristics.

IDT vs. XLT: IDT promises fifty ppm(50 ppm) before 2011;

XLT (XtaLess Technology) fifteen ppm (15 ppm) in 2011.

As shown in FIG. 31E1 and FIG. 31E2, LCO itself is switching noise generator, baseline wandering

<10 MHz frequency noise=>noise on varactor effect

>100 MHz amplitude noise=>noise on Gain effect

As shown FIG. 31F1, FIG. 31F2 and FIG. 31F3, they show Spectra Re-Growth. The Spectra Re-Growth is NOT always causes jitter. So, we need to separate the Waveform-Shaping Spectra Re-Growth and Jitter Noise Spectra Re-Growth.

As shown in FIG. 31F2,
Sinusoidal=>Amplitude growth=>Limiting Effect=>Spectra Growth=>No Jitter effect

RFIC design cares more about Waveform-Shaping Spectra Re-Growth. However. Clock cares more about Jitter Noise Spectra Re-Growth. So, it is wrong to use the PLL for RF Spectra Re-Growth to be the clock Jitter Noise Spectra Re-Growth.

modified spectra: Waveform Shaping Effect
(Total Spectra−Single Shot Waveform Spectra)=Noise Spectra
   (Accumulated Spectra−Single Shot Spectra)=Net Jitter-correlated Spectra=>Jitter

As shown in FIG. 31F1, under current Injection of the Active Device, the Sinusoidal Oscillatory Wave is not the idealized sinusoidal wave. There is the spectra-growth. However, for the periodic wave, it will not cause the Jitter.

Idealized Sinusoidal Waveform

As shown in FIG. 31F2 and FIG. 31F3, for the extreme case, both the xtal type output waveform have the same jitter, however, the spectra is completely different. It implies the failure of the current spectra approach and the successful of our Jitter approach with the modified spectra.

As shown in FIG. 31G1, it is the global innovation history of the Xtaless Clock Chip. As shown in FIG. 31G2, it is the route map for the Xtaless Clock Chip.

The theoretical Minimum ppm for the State of Art is as follows. For “0.1% RC-IQ oscillator @10 MHz”, we have

10 MHz×0.1%/1 GHz=0.1%*10e6/10e9=0.001*0.001=1 ppm

So far, our target is 15 ppm>>1 ppm.

As shown in FIG. 31B, FIG. 31C and FIG. 31D, the Wireless Window 5R System W5RS further comprises the Injectionless Locked PLL. The Injectionless Locked PLL further comprises a clock-divider to divide clock and a phase frequency detector PFD generates reset signal. The reset signal resets the clock divider after the reset signal generated by the phase frequency detector PFD.

The high-speed and high-performance ADC converter adopts the pipeline architecture. The MDAC has the analog circuit which consumes a lot of power and determines the speed of the conversion. The key issue is to increase the conversion speed at the high resolution and reduce the power consumption. These are two conflict goals. The solution is the dynamic switching type analog circuit.

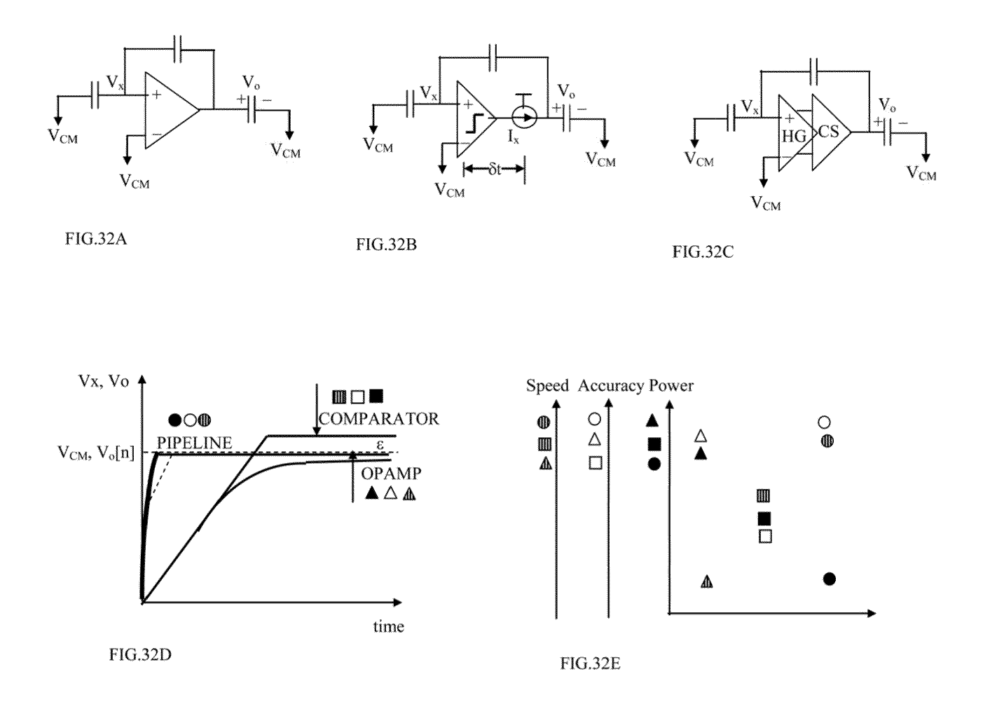

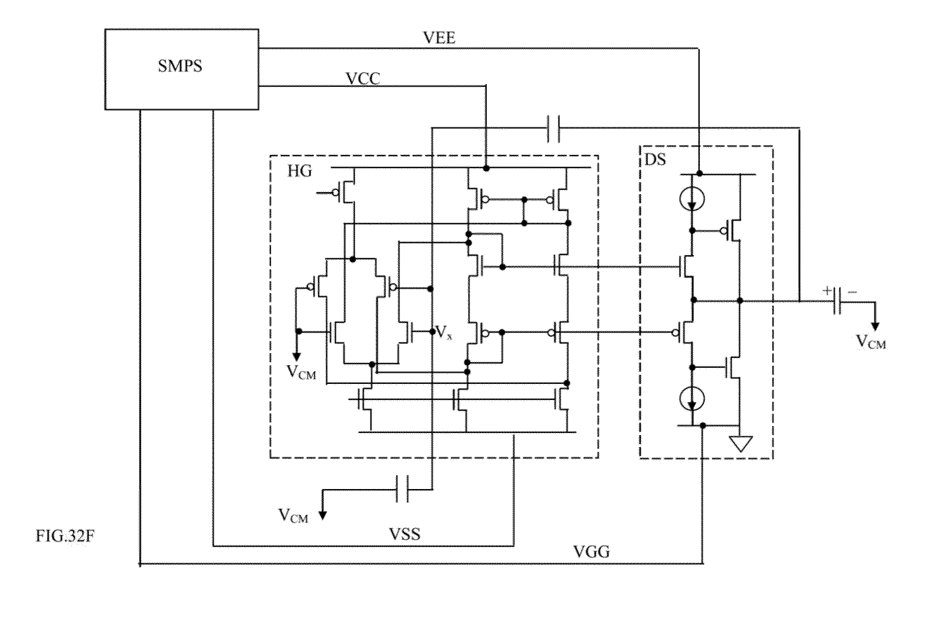

As shown in FIG. 32A, it is the conventional OPAMP in the Multiplying DAC, MDAC. There are A type OPAMP and AB type OPAMP. At the steady state, they both consume DC current. The biasing current serves as both the switching current and biasing current. They treat the OPAMP as a whole circuit. As shown in FIG. 32B, at beginning, the Vx is the slew rate to approach V_{CM}. Finally, it is the RC delay of C/gₘ for Vx to approach V_{CM} where gₘ is the gain of the small signal. As shown in FIG. 32B, it is the comparator in the MDAC. There is a constant current source which is corresponding to the slew rate of the OPAMP in the conventional MDAC. It is just to eliminate the RC delay of C/gₘ with the constant current source which is the duplicate of the biasing current. However, it is at the cost of losing the accuracy. There is the comparator switching delay which causes the inaccuracy of the Vx. Even with the delay compensation techniques for the deviation ε, this inaccuracy is still uncertain. It is impossible to have the accuracy. Vx=V_{CM}.

The FPGA having the Low power pipeline ADC with pipeline buffer will enable the merge the industrial ASIC with FPGA to be the green technology FSOC. As shown in FIG. 32C and FIG. 32F, the pipeline OPAMP adopts the dynamic switch technique in both High Gain HG OPAMP stage and Clamping Switch CS output stage. Referring to FIG. 32F, the green technology integration system comprises the pipeline buffer ADC. The pipeline buffer ADC is constituted of the high gain operational amplifier stage and dynamic switching output stage. The Dynamic Clamping Switch DS OUTPUT has the digital switching effect to drain a large amount current. So, the slew rate of the pipeline OPAMP is dynamic and is not limited by the biasing current. As shown in FIG. 32D, the dynamic switch of the pipeline OPAMP has the much higher slew rate due to the dynamic switch of the DS output stage. At the small signal stage, due to the clamping mechanism having much higher gain, the settling time is much faster and having the highest accuracy. FIG. 32E is the MDAC comparison result of the pipeline OPAMP, the comparator and the conventional OPAMP. The MDAC made of the pipeline OPAMP has the highest speed, highest accuracy and the least power.

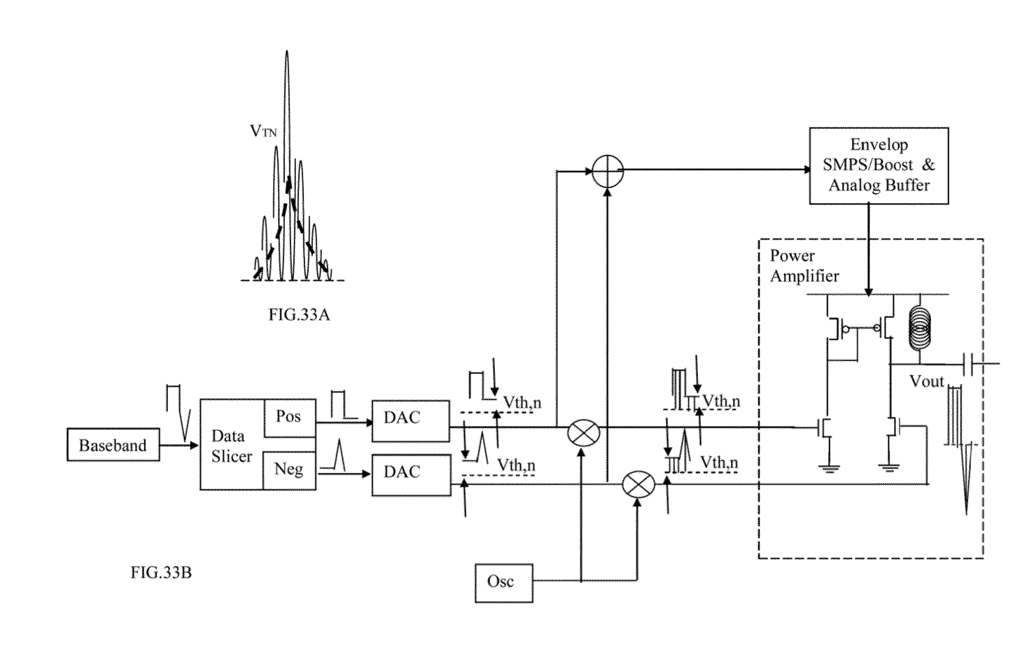

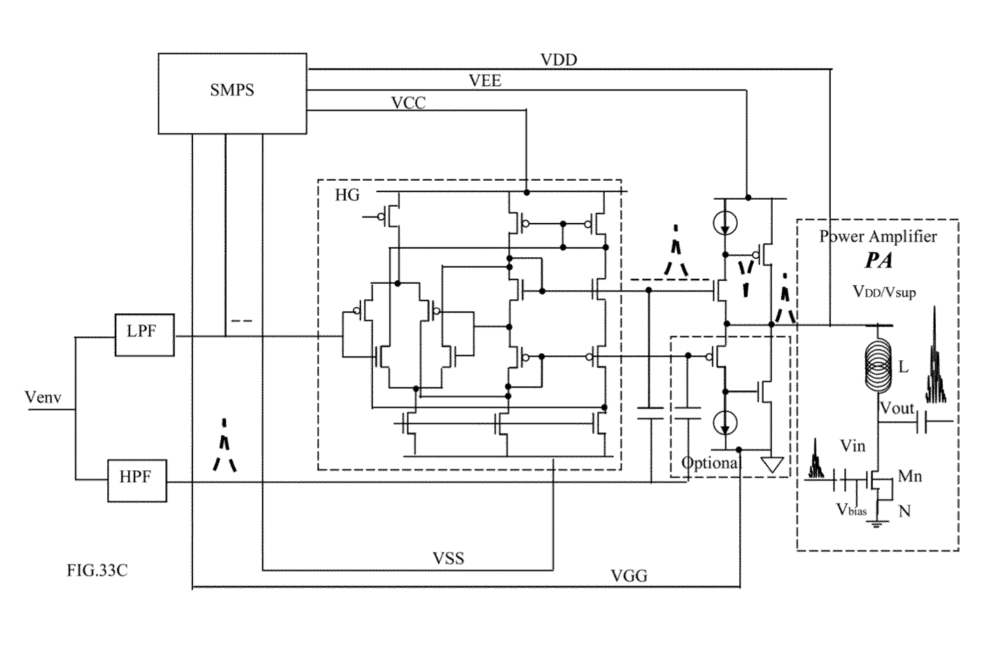

As shown in FIG. 1A, there is the need for the wireless connection for the green technology system made of the Intelligent Graphic Unit IGU of the Green Window. The most power consumption for the high Peak-Average-Ratio PAR wireless signal in FIG. 33A is the power amplifier. We need to use the dynamic power supply to reduce the power consumption of the power amplifier. A green technology integrated system comprising RF Power Amplifier dynamic power supply. The RF Power Amplifier dynamic power supply has boost converter and Low Drop Voltage Regulator LDVR type analog buffer power supply to be AC coupled with high PAE ratio signal to supply power dynamically. Referring to FIG. 33C, the green technology integration system comprises the RF Power Amplifier dynamic power supply. The RF Power Amplifier dynamic power supply has the Low Drop Voltage Regulator LDVR type analog buffer power supply to be AC coupled with the high PAE ratio signal to supply power dynamically.

Window 5R System W5RS means further comprises a high-power-efficiency conjugated power amplifier. The conjugated power amplifier takes analog signals of positive sliced data and negative sliced data to operate at amplifier B mode and/or amplifier C mode. As shown in FIG. 33B, the baseband generates the data to be transmitted by the power amplifier. The data slicer slices the transmitted data to be the positive and negative data streams. The DACs converts the positive and negative data streams to be the analog signal with the voltage level shift of Vth,n. The oscillator generates the high frequency carrier signals to carry the baseband analog signals to be the RF signal having the zero signal level to be Vth,n. Then the positive and negative modulated RF signals are fed into the dual conjugated power amplifier which was operated between the modes of amplifier B and amplifier C with the fidelity of class A. Class-A is exceptionally linear, and forms the basis of many more complex circuits. Class B has a maximum theoretical efficiency of π/4, (i.e. 78.5%). This is because the amplifying element is switched off altogether half of the time, and so cannot dissipate power. Class B can be used in RF power amplifier where the distortion levels are less important. Class-C amplifiers conduct less than 50% of the input signal and the distortion at the output is high, but high efficiencies (up to 90%) are possible. Therefore, as shown in FIG. 33B and FIG. 33C, the W5RS Window 5R system has the dual conjugated power amplifier with the envelop tracing power supply to have the most power-efficient and the most fidelity signal to meet the WiFi specification and customer requirements. The Window 5R System W5RS comprises a high-power-efficiency conjugated power amplifier system. The conjugated power amplifier takes analog signals of positive sliced data and negative sliced data to operate at amplifier B mode and amplifier C mode. The data stream coming from baseband is sliced to be said positive sliced data and said negative sliced data. Two separate DACs converting the positive sliced data and the negative sliced data to be two separate analog signals of positive sliced data and negative sliced data.

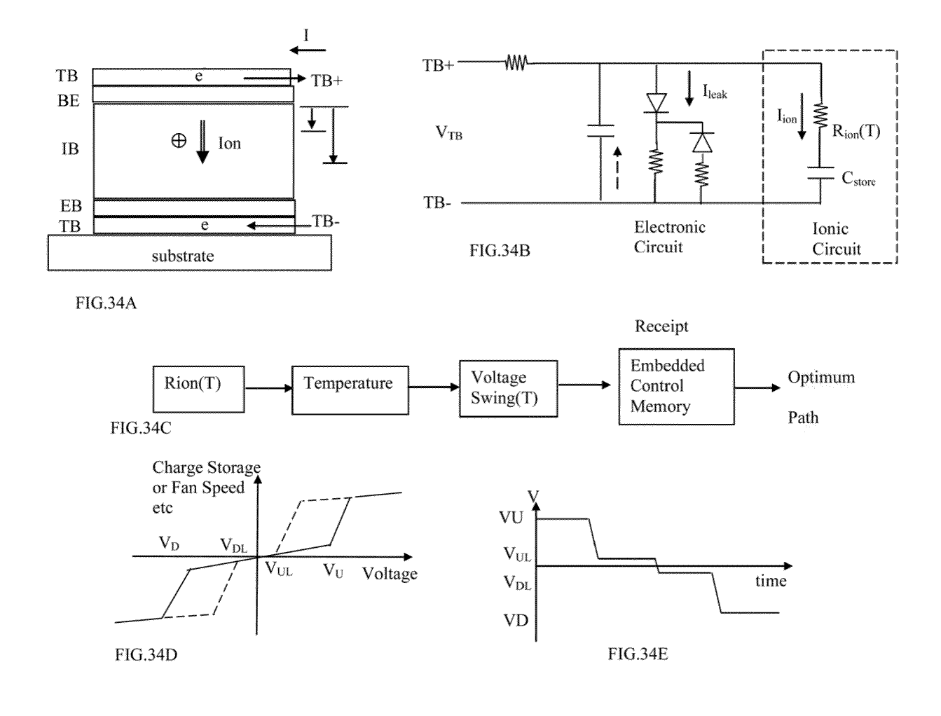

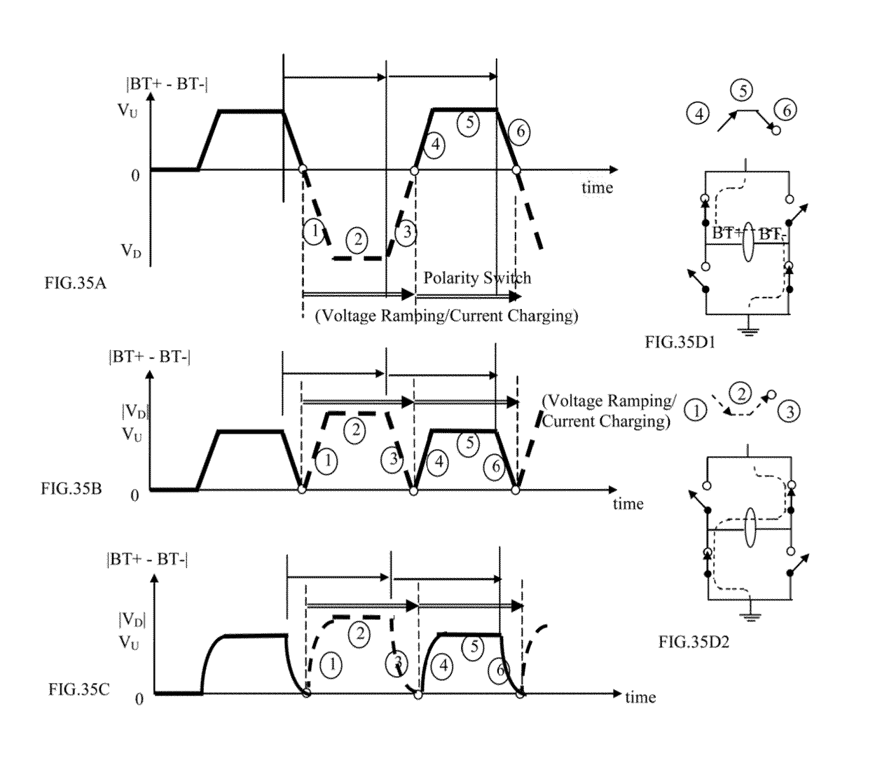

A green technology integrated system comprises Intelligent Graphic Unit IGU. The Intelligent Graphic Unit IGU further comprises thin-film battery and/or electrochromic window and solar window/panel. The solar window/panel provides electricity to the thin-film battery and/or electrochromic window to be self-contained IGU. FIG. 34A is the cross section of the thin film battery and/or Electro-Chromic Window (EC Window). The thin film battery/EC window is made of five layers, Transparent Conductor (TC), Electro/chromic Electrode (EC). Ion Conductor (IC), Counter Electrode (CE) and Transparent Conductor (TC). As shown in FIG. 34A, similar to the MOS and Bipolar devices, there are the hot-ion Iᵢₒₙ and break-down/reliability voltage problems for the EC window. The current-limited voltage ramping is the adaptive increment of voltage difference according to constant current/field. As shown in FIG. 34B, the const current/field is the difference of the applying voltage and the built in potential of Cstore. There are two kinds of window controller. The first green technology integration system comprises the Current-Limited Voltage Ramping circuit to switch an Battery and/or Electrochromic Window being made of said layer means. The second green technology integration system comprises Voltage-Limited Current Charging circuit to switch battery and/or Electrochromic Window means being made of layer. The voltage limit and current limit are the function of temperature. The ion resistance Rᵢₒₙ is function of the temperature. As shown in FIG. 34C, we can get the temperature of the EC window from the value of Rᵢₒₙ(T) with the relations as follows.

Vw=I(t)R(T)+ΣI(t)/C

Vw1=I1(t)R(T)+ΣI(t)/C

Vw2=I2(t)R(T)+ΣI(t)/C

Vw2−Vw1=[I2(t)−I1(t)]R(T)

R(T)=(Vw2−Vw1)/[I2(t)−I1(t)]

I=Niν=NiE=Ni(Vw−ΣI(t)/C)/dᵢₒₙ

I(t)=(Vw−ΣI(t)/C)/R(T)

R(T)=dᵢₒₙ/Ni

The battery and/or EC window have the bi-stability as shown in FIG. 34D that the battery and/or EC window can operate as shown in FIG. 34E to reduce the leakage current to save the power with the optical hysteresis.

FIG. 35A shows the switching operation of the battery and/or EC window. The voltage difference across the battery and/or EC window W+−W−. The voltage of the bleach might be different from the voltage of the color. There is polarity. To protect the battery and/or EC window, there are the voltage limit and the current limit. To avoid the current limit, in the switching from bleaching to the coloring and vice versa, there is the voltage ramping of the switch. To implement the current limited voltage ramping switch, as shown in FIG. 35B, with the H-Bridge switching as shown in FIG. 35D1 and FIG. 35D2, we can convert the polar switching to be the unipolar switch as shown in FIG. 35B. It is noted that the window switching time is different from the polarity switching time. As shown in FIG. 35A, the EC window switching time is the start of bleaching or coloring. The voltage starts to ramp up or down. The polarity switch is the time the ramping voltage across the zero voltage, W+=W−.

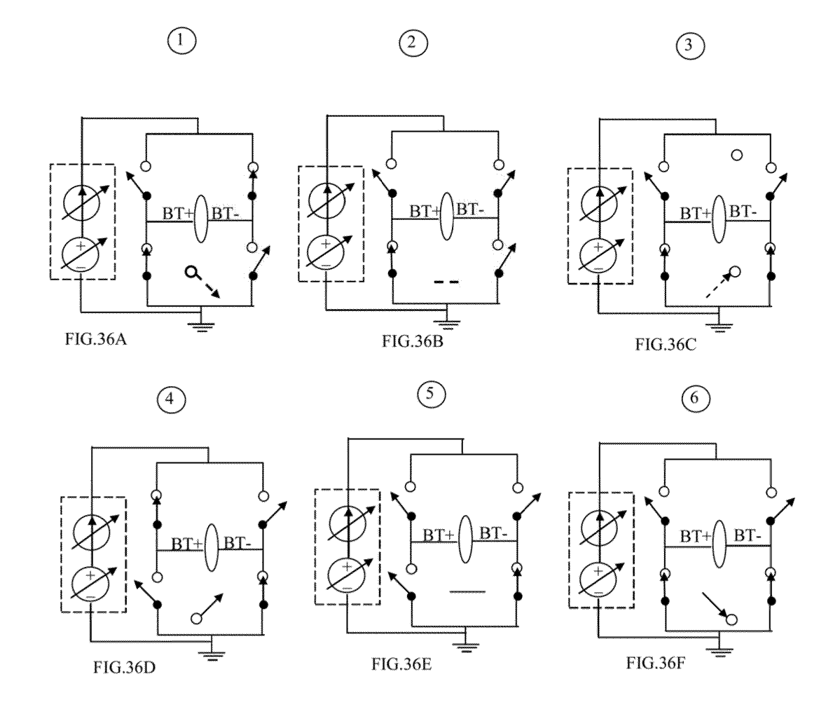

The thin film Battery/EC window has two limits, current limit and voltage limit. Due to the hot-ion effect, the speed limit of the ion is limited to a maximum ion speed. The hot-ion speed limit can be observed with the current-limit. The thin film battery/EC window can be thought as the battery. The voltage limit is the electrical field causing the reliability of the thin film battery/EC-window battery. As shown in FIG. 36, during the operations of the thin film battery/EC window, the voltage source or the current source are varying to keep both the voltage-limit and current limit. According to the switching operation in FIG. 35, the fundamental thin film battery/EC-window switching operation are classified to be six phases. Phase 1 is the start or continue switching of coloring phase. Phase 2 is the hold of the color. Phase 3 is the start of discharge/bleach. Phase 4 is the start or continue switching of discharging/bleaching phase. Phase 5 is the hold of the discharge/bleach. Phase 6 is the start of charging/coloring All the operations of the thin film battery/EC-window H-bridge switch are followed this fundamental switching principles. To protect the thin film battery/EC window, the power is current-limited and voltage-limited source.

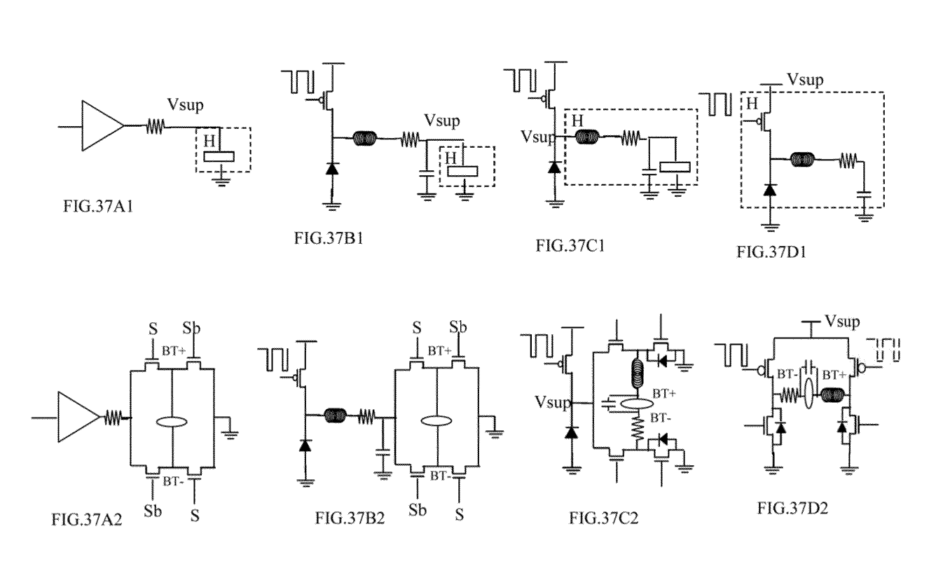

Furthermore, the H-Bridge Switch structure can be applied to have the different components. As shown in FIG. 37A1, it is the thin film battery/EC window driven by the analog buffer. It is the fundamental voltage ramping mode. From the electric model of the thin film battery/EC window, the thin film battery/EC window can be treated as the capacitor with the dissipative current source. Applying the H-Bridge structure to the capacitor of the thin film battery/EC window, the circuit of the H-Bridge with the analog buffer is shown as FIG. 37A2. The resistor is served as the current sensing. With the feedback of the current sensing, the circuit in FIG. 37A2, can be served as the current-limited voltage ramping.

The H-Bridge structure applying to the Switch Mode Power Supply has much more versatile novel structures. As shown in FIG. 37B1, it is the basic Buck converter. Applying the H-Bridge to the thin film battery/EC window, the current-limit window controller is as shown in FIG. 37B2. As shown in the FIG. 37C1, the H-Bridge structure is applied to the inductor, current-sensing resistor, capacitor and the battery/EC window. The corresponding current-limited window controller is shown as FIG. 37C2. Applying the H-Bridge operator to the whole buck converter as show in FIG. 37D1, the corresponding window controller is as shown in FIG. 37D2. The MOS devices in the H-Bridge serve as not only the switches but also the switching gate of the buck converter, too.

There are different thin film battery/EC window controller algorithms of (1) voltage-ramping, (2) current-limited, (3) current-limited voltage-ramping and (4) voltage-ramping current-limited, etc. We can apply the different H-Bridge window controller architectures in FIG. 37 to the different thin film battery/EC window controller algorithms.

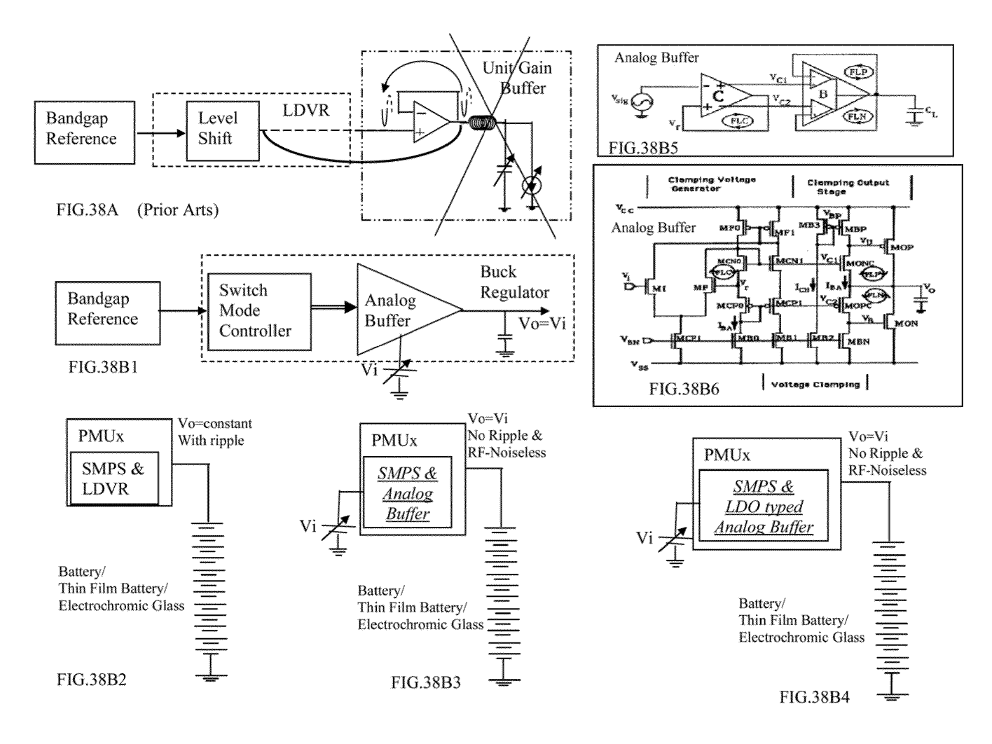

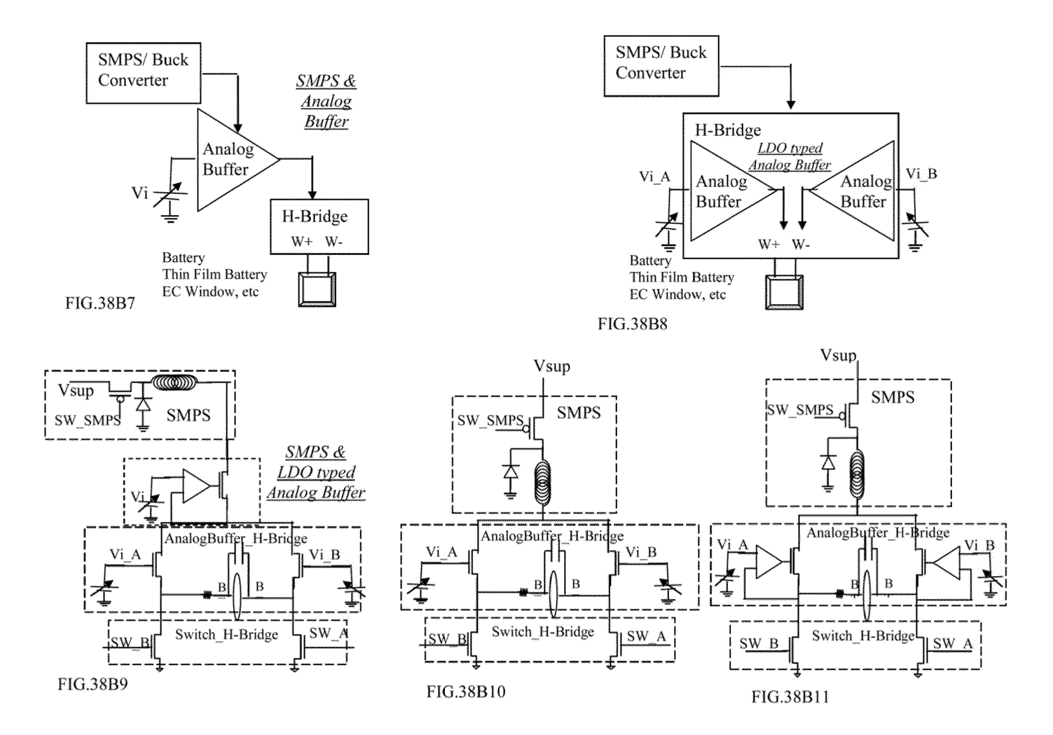

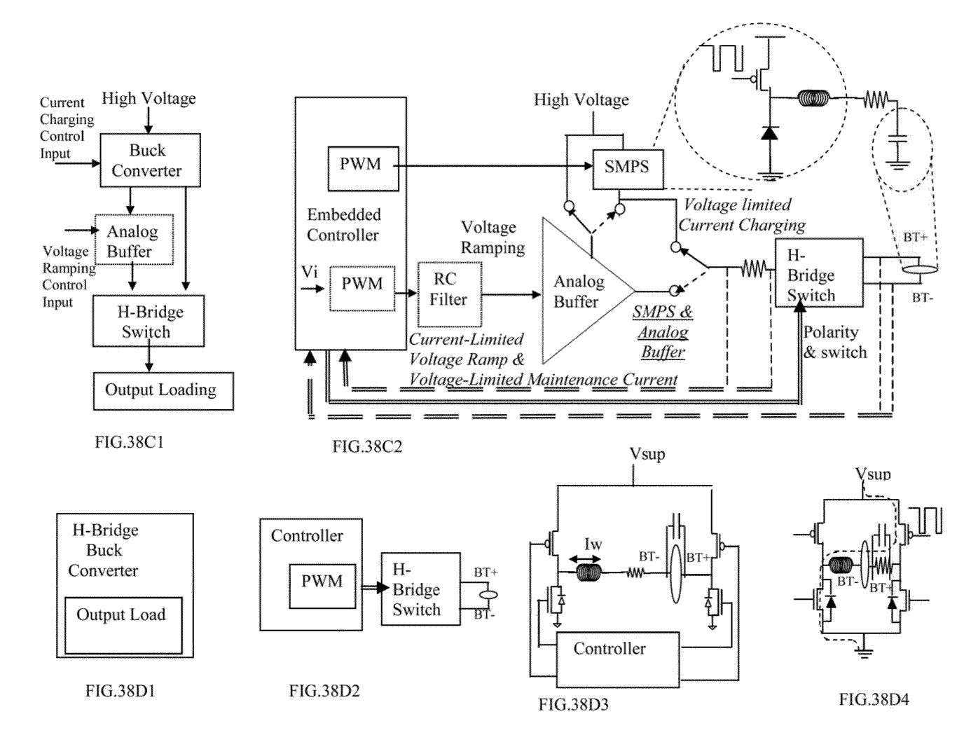

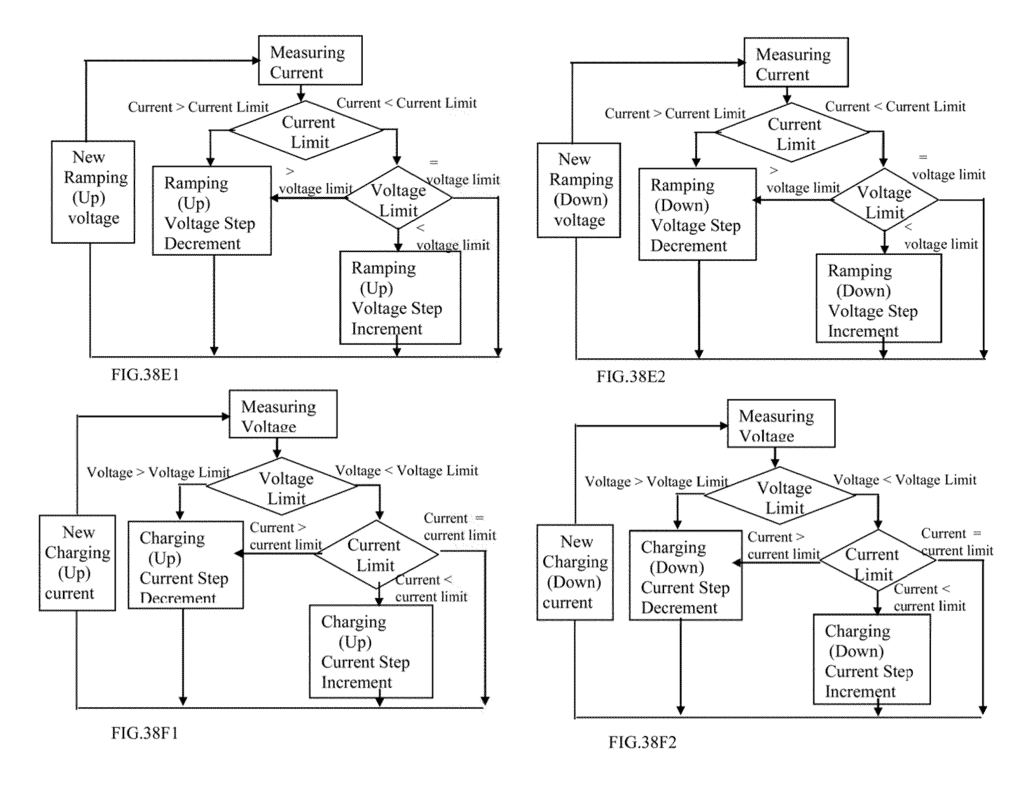

FIG. 38C1 and FIG. 38C2 show the design platform having the different practical implementations of the thin film battery/EC window controller. The buck converter is to convert the high voltage power supply to the low voltage power having the large current. There are many different ways to implement the thin film battery/EC controller. The green technology integrated Current-Limited Voltage Ramping mode having a analog buffer to drive a H-bridge switch structure to drive battery, thin-film battery and Electrochromic Window. The Voltage-Limited Current Charging mode further comprises a buck converter to drive a H-bridge switch structure to drive a battery and/or Electrochromic Window. The Voltage-Limited Current Charging mode also can comprise H-bridge switching Buck Converter to drive battery, thin-film battery and Electrochromic Window. As shown in FIG. 38C1, the control input signals can be either current charging signal or the voltage ramping signal. However, for the networking consideration, there is the need for the embedded controller. The embedded has the Pulse Width Modulation PWM signals. In the practical design, the thin film battery/EC window controller is designed around the embedded controller.

As shown in FIG. 38E1 and FIG. 38E2, the green technology integrated system comprises Current-Limited Voltage Ramping circuit and algorithms to charge a battery or switch battery/Electrochromic Window being made of thin-film layers. As shown in FIG. 38F1 and FIG. 38F2, the green technology integrated system comprises Voltage-Limited Current Charging circuit and algorithm to charge a battery or switch battery and/or Electrochromic Window means being made of thin-film layers.

As shown in FIG. 35B, there are the charging process and the discharging process. As the voltage increases from 0 to the voltage limit is the charging process. As the voltage decreases from the voltage limit to 0 is the discharging process. The voltage limit for the tint/coloring is different from the voltage limit of the charge/discharge and/or transparent/bleach. The discharging process for the LDVR type single side pull up analog buffer can be done by the short of the thin film battery/EC window as shown in FIG. 36C and FIG. 36F. For the two-sided pull-up and pull-down analog buffer, the discharging process can be done by the pull-down of the analog buffer as shown in FIG. 36A and FIG. 36D by the short of the thin film battery/EC window as shown in FIG. 36C and FIG. 36F. For the SMPS buck converter, there is no discharging mechanism. However, as the polarity changes, the voltage becomes the negative. It still can use the SMPS to charge up in the discharging process as long as the voltage limit and the current limit is in the safe range. As shown in FIG. 35A and FIG. 35B, for the polarity switch, it can be applied to both voltage ramping and current charging method. For the charge/discharge and color/bleach switch, it is applied to the current charging method only.

There are two major algorithms to switch the thin film battery charger/EC window controller, the current-limited voltage-ramping and the voltage-limited current-charging. As shown in FIG. 38C1 is the charging process of the current-limited voltage-ramping. As shown in FIG. 38C2 is the discharging process of the current-limited voltage-ramping. As shown in FIG. 38D1 is the charging process of the voltage-limited current-charging. As shown in FIG. 38D2 is the discharging process of the voltage-limited current-charging. The current-limited voltage-ramping methodology is the conjugate of the voltage-limited current-charging. They are the general fundamental algorithms. They can be easily modified to fit for the different systems and architectures of the thin film battery charger/EC window controller.

As shown in FIG. 38C1, the voltage ramping up and the ramping rate is bounded by the constant current of current limit. The current is fed back to modify the voltage ramping up rate. The ramping voltage rate is reduced or increased for the ramping voltage. As shown in FIG. 38A2 and FIG. 38C1, for the embedded controller having the PWM signal to generate the voltage ramping signal, it can use the PWM signal to generate the voltage ramping signal. As shown in FIG. 38A2 and FIG. 38D1, for the current Switch battery/EC window controller, the current feedback is to adjust the PWM duty-cycle.

For the voltage ramping algorithm, as shown in FIG. 35C, the voltage ramping |W+−W−| signal is sent to the PWM generator. The RC filter filters out the digital switch and get the |W+−W−| analog signal. The |W+−W−| analog signal is sent to the analog buffer to generate the voltage ramping voltage source to drive the battery/EC window. As the voltage ramping voltage become zero, the polarity switch signals are generated to switch the H-Bridge. This is the feed forward system.

If the embedded controller uses the current-sensing resistor feedback current signal information to adjust the voltage ramping rate, it is the current-limited voltage ramping. Then it becomes the feed forward system with the addition of the feedback signal control. For the current limited algorithm, the duty-cycle signal is sent to the PWM generator to generate the corresponding PWM signal. The PWM signal is the switching signal of the Buck Converter type Switch Mode Power Supply SMPS. The current-sensing resistor senses the current and feedback to the embedded controller to adjust the duty-cycle. This is the feedback system.

If the embedded controller uses the feedback signal of W+−W− voltage to adjust and enable/disable the PWM signal due to the maximum voltage limit allowance, it becomes the voltage-limited current charging. Then it becomes the current feedback system with the addition of the voltage feedback signal control. As shown in the upper-right portion in the FIG. 38C2, the green technology integration system is made of the Voltage-Limited Current Charging circuit further comprising a buck converter to drive a H-bridge switch structure to drive a thin film battery/Electrochromic Window.

As shown in FIG. 38A, it is the design mistake in the conventional of battery charger/electrochromatic window driver, etc to use the unit gain amplifier as the driver. It not only causes the overheat of the chip and board, wastes a lot of power but also has no driving capability. As shown in FIG. 38B1, it is the combining switch mode power supply with analogy buffer having the input varying voltage capability. It is buck regulator with analog output voltage having no ripple to be the radio-RF-Noiseless buck regulator. As shown in FIG. 38B2. FIG. 38B3 and FIG. 38B4, comparing the conventional “SMPS & LDVR” with our unique “SMPS & Analog Buffer” and “SMPS & LDVR type Analog Buffer”, the conventional “SMPS & LDVR” has the constant voltage output with ripple; however, our unique “SMPS & Analog Buffer” and “SMPS & LDVR type Analog Buffer” having the varying output voltage being equal to varying input voltage and the output voltage having no ripple to be the RF-Noiseless. The building block diagram of Analog Buffer is shown in FIG. 38B5. The detailed schematic of Analog Buffer is shown in FIG. 38B6.

There are versatile combinatory innovations of our innovations of SMPS, analog buffer. LDO type analog buffer and H-Bridge. As shown in FIG. 38B4, FIG. 38B7, FIG. 38C1 and FIG. 38C2, they show the architecture and system made of the SMPS/Buck Converter, analog buffer and H-Bridge. The Analog Buffer accepts the output voltage of SMPS/BUCK converter as input power supply and the dynamic varying “signal input” Vi; the Analog Buffer output the output power Vo having power output Vo=Vi. A Wireless Window 5R System W5RS comprises a smart battery charger to drive battery and electrochromic window. The smart battery charger comprises switch mode power supply SMPS, low drop-offset LDO type analog buffer with the option of the addition of the H-Bridge for discharging. The switch mode power supply SMPS provides power to the low drop-offset LDO type analog buffer. The low drop-offset LDO type analog buffer provides power to the H-Bridge. The low drop-offset LDO type analog buffer being either analog buffer or LDO analog buffer. The H-Bridge means charging and discharging the battery and electrochromic window, etc with switches embedded in the H-Bridge.

As shown in FIG. 38B4 and FIG. 38B9, they show the alternative design of the architecture and system made of the SMPS/Buck Converter, LDO typed analog buffer and H-Bridge. As shown in FIG. 38B8, FIG. 38B10 and FIG. 38B11, they show the alternative design of the architecture and system made of the SMPS/Buck Converter, H-Bridge and LDO typed analog buffer. The analog buffers are embedded in the H-Bridge. A Wireless Window 5R System W5RS comprises a smart battery charger to drive battery, thin-film battery and electrochromic window, etc. The smart battery charger further comprises switch mode power supply SMPS and H-Bridge. The switch mode power supply SMPS provides power to the H-Bridge. The H-Bridge further comprises low drop-offset LDO type analog buffers and switches. The H-Bridge charges and discharges the battery and the electrochromic window with switches and low drop-offset LDO type analog buffer embedded in the H-Bridge. The low drop-offset LDO type analog buffer is either analog buffer or LDO analog buffer. The low drop-offset LDO type analog buffer further provides rippleless RF-Noiseless output power to the battery and the electrochromic window according to the specified input voltages of the low drop-offset LDO type analog buffer.

FIG. 38D1 and FIG. 38D2 show the application of FIG. 37D2 being applied to the thin film battery charger/EC window controller. As shown in FIG. 38D3, the green technology integration system is made of the Voltage-Limited Current Charging circuit further comprising H-bridge switching Buck Converter means to drive a thin film battery/Electrochromic Window means. The embedded window controller sends the polarity and SMPS switching signals to the H-Bridge. There are many different ways for the combination of the polarity and SMPS switching signals. For simplicity, only the PMOS signal to be the SMPS signal gated by the polarity signal and the NMOS is the polarity signal. For the high power efficiency, both the PMOS and NMOS signal can be SMPS signal gated by the polarity signal.

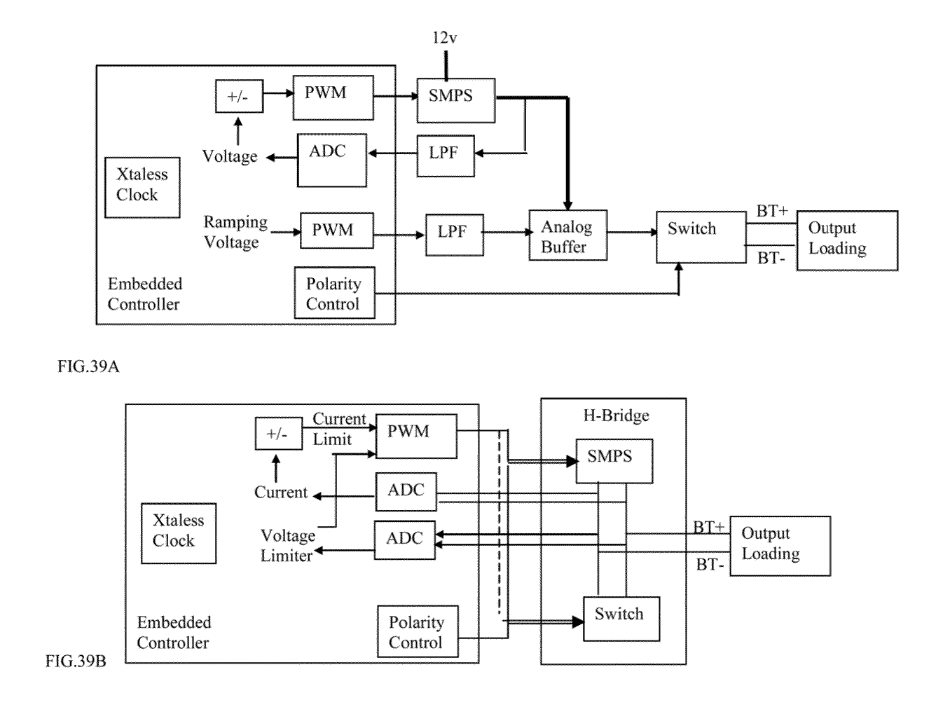

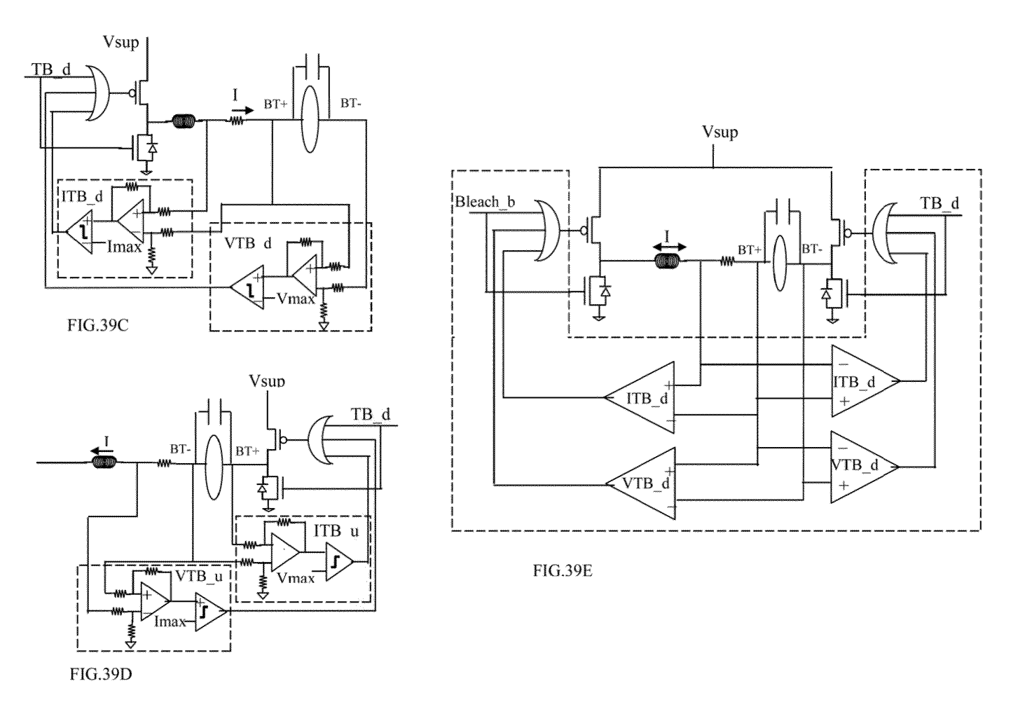

The Battery Charger and/or EC window controller, etc in the iPindow/Smart Window can be independent device. As shown in FIG. 1A, the smart Battery Charger and the smart EC window 20 can be operated as either the dimmer battery/window or bi-state battery/window. As shown in FIG. 39A and FIG. 39B, the battery charger/window controller adopts the embedded controller. FIG. 39A is the system block diagram for the current-limited voltage ramping Battery Charger/EC window controller. FIG. 39B is the system block diagram for the voltage-limited current charging Battery Charger/EC window controller. In the embedded controller, there are embedded ADC and embedded Xtaless Clock. In the embedded Xtaless Clock, there are the embedded current regulators.

As shown in FIG. 39C, during the discharge/bleach, the current flows in one direction. Bleach_b is the discharge/bleach signal. The ISW_b circuit is the current-limit detect circuit to switch of the switching gate. The VSW_b circuit is the voltage-limit detect circuit to switch of the switching gate. This is the event-driven switch mode buck converter. As shown in FIG. 39D, during the color, the current flows in the reverse direction. Color_b is the charge/Color signal. The ISW_c circuit is the current-limit detect circuit to switch of the switching gate. The VSW_c circuit is the voltage-limit detect circuit to switch of the switching gate. This is the event-driven switch mode buck converter. FIG. 39E are the combinatory circuit of the FIG. 39C and FIG. 39D to be the complete Battery Charger and/or EC window controller circuit.

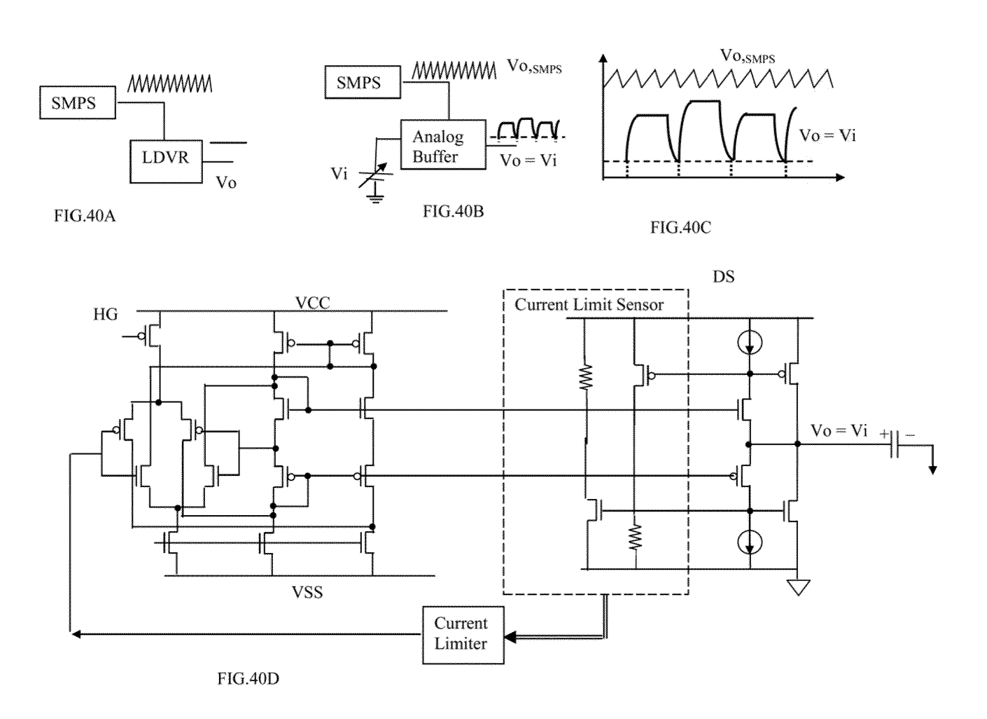

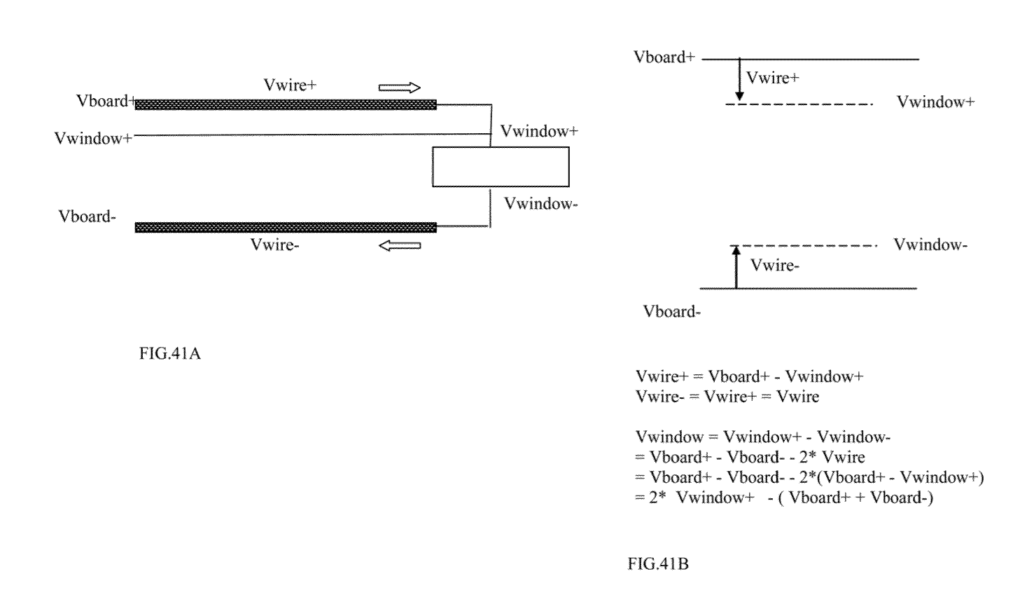

As shown in FIG. 21A and FIG. 40A, the Switch Mode Power supply SMPS provides the power to Low-Drop Voltage Regulator LDVR to generate the clean power. Similarly, as shown in FIG. 40B, the analog buffer of the EC window controller will filter out the switching noise of the SMPS. With the analog buffer in FIG. 40D and the H-Bridge operation in FIG. 36, the operation curve is shown as FIG. 40C. There are many ways to implement the current sensing technique. As shown in FIG. 38A, the current sensing resistor can feedback the current information to the embedded controller or the SMPS. Use the SMPS to control the current to be current-limited voltage ramping. We can also use the resistorless current sensing in the prior applications. As shown in FIG. 40D, we can also use the current limit sensor embedded in the analog buffer.

The green technology integration system is made of the Current-Limited Voltage Ramping circuit having a analog buffer to drive a H-bridge switch structure to drive the Electrochromic Window. As shown in FIG. 34E and FIG. 40C, the analog buffer can filter out the noise of the switch mode power supply. As shown in FIG. 40D, the analog buffer has the output stage serves as LDVR type operation. In other words, it is single side pull-up that no DC biasing current for the output stage. It will not burn the DC biasing current for the output stage as the conventional unit gain amplifier does. Furthermore, the current limit sensing mechanisms are implemented with the current mirror mechanism in the analog buffer.

As shown in FIG. 41A, the two power wires “Vboard+˜Vwindow+”, “Vboard−˜Vwindow−” and one single wire “Vwindow+˜Vwindow+” constituted to be one triple-wire. As shown in FIG. 41B, the window voltage Vwindow can be calculated as

Vwindow=2*Vwindow+−(Vboard++Vboard−)

A Wireless Window 5R System W5RS means further comprises a micro-inverter to convert Solar window harvesting solar energy to be electric energy. The micro-inverter means adopts in-phase power injection to inject the energy with in-phase micro-inverter to increase amplitude of injected energy waveform in phase to minimize phase interruption of said injected energy waveform. The amplitude in the AC oscillator is the energy of the AC oscillator. As the current injects into the AC oscillator, the phase of the AC oscillation will not be influenced to be In-Phase injection. FIG. 42A shows the “In-Phase Current Injection” into the AC oscillation. The amplitude of AC oscillation increases as “In-Phase Current Injection” into the AC oscillation. FIG. 42B1 is the circuit to have the “In-Phase Current Injection” into the AC oscillation at the peak voltage of the AC oscillation. FIG. 42B2 is the circuit to have the “In-Phase Current Injection” into the AC oscillation at the valley voltage of the AC oscillation. As shown in FIG. 42B1, the boost converter injects the current into the AC oscillation. As the Peak Detector detects the peak of AC waveform, the peak detector switches off the NMOS and switch on the PMOS, the inductor injects the inductor current into AC oscillator. As shown in FIG. 42B2, the buck-boost converter extracts the current out of the AC oscillation at the valley. As the Valley Detector detects the valley of AC waveform, the valley detector switches off the NMOS and switch on the PMOS, the inductor extracts the inductor current out of the AC oscillator to pull down the valley to increase the amplitude of the AC oscillation.

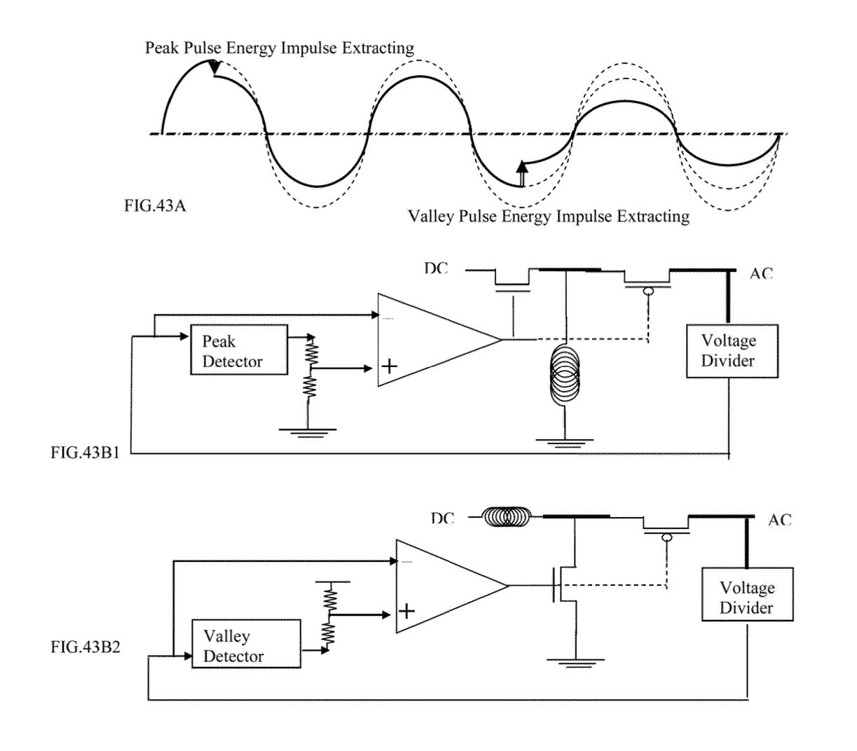

The same principle can be applied to the conjugated circuit to extract the energy from the AC oscillator. As the current extract the energy out of the AC oscillator at either the peak or valley of AC waveform, the phase of the AC oscillation will not be influenced to be In-Phase extraction. FIG. 43A shows the “In-Phase Current extraction” out of the AC oscillation. The amplitude of AC oscillation decreases as “In-Phase Current extraction” out of the AC oscillation. FIG. 43B1 is the circuit to have the “In-Phase Current extraction” out of the AC oscillation at the peak voltage of the AC oscillation. FIG. 43B2 is the circuit to have the “In-Phase Current Extraction” out of the AC oscillation at the valley voltage of the AC oscillation. As shown in FIG. 43B1, the buck-boost converter extracts the current out of the AC oscillation. As the Peak Detector detects the peak of AC waveform, the peak detector switches off the NMOS and switch on the PMOS, the inductor extracts the inductor current out of AC oscillator. As shown in FIG. 43B2, the buck converter injects the current into the AC oscillation at the valley. As the Valley Detector detects the valley of AC waveform, the valley detector switches off the NMOS and switch on the PMOS, the inductor injects the inductor current into the AC oscillator to push up the valley to decrease the amplitude of the AC oscillation.

W5RS is the platform for the multiple standards of Referring to FIG. 1L1, FIG. 44A and FIG. 44B, W5RS has the 5R: Resonant Resynchronization Rectifier Regulator 96% Power Efficiency. The circuit enclosed in the dotted lines are optional. As shown in FIG. 44A, FIG. 44B, FIG. 45H1, FIG. 45I1, FIG. 45J1 and FIG. 45K, the Wireless Window 5R System W5RS comprises a wireless power supply 5R Recycling Resonant Resynchronization Rectifier Regulator. The wireless power supply Recycling Resonant Resynchronization Rectifier Regulator 5R is connected between LC resonator means and DC output loading, etc. The wireless power supply Recycling Resonant Resynchronization Rectifier Regulator 5R converts energy in the LC resonator to be DC power to supply DC output loading. The wireless power supply Recycling Resonant Resynchronization Rectifier Regulator 5R has only one single stage to integrate conventional rectifier. DC/DC and LDO three stage to be single stage.

The wireless power supply Recycling Resonant Resynchronization Rectifier Regulator 5R further comprises capacitors biased at different level to have boost voltage to recycle resonating energy in the LC resonator to turn on switch devices in the wireless power supply Recycling Resonant Resynchronization Rectifier Regulator 5R synchronously. The capacitors have one end been connected to output terminal of the LC resonator means and another end being connected to switching MOS devices of rectifier.

A Wireless Window 5R System W5RS comprises a wireless power supply Recycling Resonant Resynchronization Rectifier. The capacitors are connected between the terminals of the LC resonator and switches. The switch means being weakly biased at proper biasing voltages. As said LC resonator means resonates, the capacitors means driving the switch with switching energy to switch-on and switch-off the switch device to perform rectifying function. Furthermore, the switching energy of said capacitor means being recycled through said LC resonator. As shown in FIG. 45A1, the W5RS is an LC oscillator made of L_{R} and C_{R}. As shown in FIG. 45A2, the W5RS is transformed to be the serial resonator made of L_{R} and C_{R}. As shown in FIG. 45A3, the W5RS is transformed to be the serial resonator made of L_{R}, C_{R} and C_{DC#}. The wireless power supply Recycling Resonant Resynchronization Rectifier further comprises LC resonator means, switch and capacitors. As shown in FIG. 45A4, the W5RS is transformed to be the serial resonator with the insertion of power-loss-less switches. Comparing FIG. 44A and FIG. 44B with FIG. 45A4, the W5RS is just “single stage” power conversion. Comparing with the conventional Rectifier, DC/DC buck converter and LDO “three-stage” power conversion mechanism, the single stage W5RS is super-power-efficient to have the power efficiency 96%.

Referring to FIG. 44C and FIG. 44A and FIG. 44B, the Cc has the multiple function to make the fine-tune of the Rectifier output voltage V_{DC} or V_{DC1}. The C_{DC} is fine-tuned according to the output voltage V_{DC} or V_{DC1} with the frequency fine-tuning relative the resonant frequency. In other words, there are three voltage fine-tuning mechanism, the rectifier output voltage fine-tuning mechanism, the DC/DC output voltage fine-tuning mechanism and the LDO output voltage fine-tuning mechanisms. The closer the output voltages are, the higher the power efficiency is. The smaller the capacitor C_{DC} and _{CDC#} are, the higher the power efficiency is. For the limited case, the capacitor C_{DC} and _{CD#} are eliminated that the rectifier, DC/DC and LDO are merged to be one single stage 5R Recycling Resonant Resynchronization Rectifier Regulator.

Referring to FIG. 45C2A and FIG. 44B, the threshold voltage Vth,n will decrease the power efficiency of the Rectifier and DC/DC conversion. Referring to FIG. 45C2A and FIG. 44C, VR_{U1}, VR_{U2}, V_{B1} and VR_{B2} are biased at the proper voltage. VR_{U1} and VR_{U2} are biased at the voltage to be the sum of the V_{DC} and Vth,n. VR_{U2} and VR_{B2} are biased at the voltage to be the sum of the Ground and Vth,n, i.e., Vth,n. With the proper bias of VR_{U1}, V_{U2}, VR_{B1} and VR_{B2}, under the boost kick of capacitors CR_{U1}, CR_{U2}, CR_{B1} and CR_{B2}. The Recycling Resonant Resynchronization Rectifier Regulator 5R power efficiency increases a lot FIG. 45C2B. Furthermore, as shown in FIG. 45B1 and FIG. 45B2, the S_{U1}, S_{U2}, S_{B1}, S_{B2}, S_{DC1} and S_{DC2} gates voltages are recycling with the synchronizing resonant energy. S_{U1}, S_{U2}, S_{B1} and S_{B2} are boosted by the recycling energy of L_{R} and C_{R}. S_{DC1} and S_{DC2} are boosted by the sampled and hold recycling energy of L_{R} and C_{R}. Therefore, the Recycling Resonant Resynchronization Rectifier Regulator 5R power efficiency can be as high as 96%.

The 5R Recycling Resonant Resynchronization Rectifying Regulator is compatible to both WPC Wireless Power Consortium Qi standard and A4WP Alliance for Wireless Power standard. (1) Due to 5R factors, the 5R Recycling Resonant Resynchronization Rectifying Regulator can be considered as “single-stage” power conversion. (2) Due to the power recycling, the switching loss of rectifier and DC/DC power conversion, etc are eliminated. (3) due to wave shaping, the Rectifier operation can be considered to be switching operation instead of analog operation. Due to the above three factors, from AC to DC, the 5R Recycling Resonant Resynchronization Rectifying Regulator has the highest power efficiency 96% in all the world.

FIG. 45D1 is the resonant voltage, current and power of the ideal resonant circuit as shown in FIG. 45D2. FIG. 45D2 is the ideal resonant circuit. The 5R can be transformed from the ideal resonant circuit to make the analysis and design. FIG. 45E1 is the resonant voltage, current and power of the resonant circuit having the diodes which emulates the rectifier circuit having H-bridge having Schottky diode. FIG. 45E2 is the resonant circuit having the diodes which emulates the rectifier circuit having H-bridge having Schottky diode. The Schottky diode reduces the power efficiency a lot.

To eliminate the power loss due to the Schottky diode, the active MOS devices are adopted. FIG. 45F1 is the resonant voltage, current and power of the resonant circuit having the active MOS which emulates the rectifier circuit having H-bridge having MOS. FIG. 45F2 is the resonant circuit having the MOS which emulates the rectifier circuit having H-bridge having MOS. The MOS device is not only to reduce the power loss due to the diode but also to have the power factor correction PFC effect. The current of MOS device increases with the voltage of MOS that the MOS device has the power factor correction effect.

To reduce the loss of MOS at low voltage, the resonant voltage of LC resonator needs to sharp the rising edge and falling edge. Therefore, the waveform shaper circuit is needed to shape up the analog sinusoidal voltage to be the digital switching voltage. FIG. 45G1 is the resonant voltage, current and power of the resonant circuit having the active MOS which emulates the rectifier circuit having H-bridge having MOS with wave-shaper switching driver. FIG. 45G2 is the resonant circuit having the MOS which emulates the rectifier circuit having H-bridge having MOS with wave-shaper switching driver.

Combing the above Rectifier Design & Analysis with Virtual Resonant, the Wireless Window 5R System W5RS comprises a wireless power supply Recycling Resonant Resynchronization Rectifier Regulator 5R. The wireless power supply Recycling Resonant Resynchronization Rectifier Regulator 5R further comprises wave-shaping and switches. The wave-shaping shapes up the switching voltage of switches to have sharp rising and falling edge to reduce on-resistance of the switches in switching transition process. FIG. 45H1 is the rectifier having regulated output voltage capability with H-bridge having MOS with wave-shaper switching driver as shown in FIG. 45H2. FIG. 45H2 is the fundamental wave-shaper. The rectifier has the voltage regulating capability with the frequency tuning of the capacitor C_{DC}. The rectifier has the regulating output voltage capability that the rectifier can stand alone as the power supply. There is no need for the DC/DC converter and regulator. FIG. 45I1 is the rectifier having regulated output voltage capability with H-bridge having MOS with wave-shaper switching driver as shown in FIG. 45I2. FIG. 45I2 is the mutual-latching enhanced wave-shaper.

To have multi-voltage supply capability, the inductor-free DC/DC converter technique is adopted. There is no need for the inductor for the DC/DC converter to recycle the energy. The DC/DC converter shares the inductor with the rectifier to recycle the energy. FIG. 45J1 is the rectifier with multi-voltage Inductor-Free DC/DC converter. FIG. 45J2 is the waveform of the multi-voltage Inductor-Free DC/DC converter. FIG. 45K is the complete set of 5R Recycling Resonant Resynchronization Rectifying Regulator having the rectifier, multi-voltage Inductor-Free DC/DC converter and Digital/Analog Programmable LDO integrated single power-conversion stage. FIG. 45L1 is the complete schematics of the 5R Recycling Resonant Re-synchronous Rectifier Register having the complete set of ASP/PFC wave shaper. FIG. 45O is the generic wave shaper of WS. FIG. 45P is the gate-activated switching buffer or driver type wave shaper. FIG. 45Q is the source-activated switch-energy recycling wave shaper WS2. FIG. 45R is the operational mechanism analysis of wave shaper. As VRm voltage is less than Vout+2Vth,n, the active rectifying MOS SWR is not turned on, where m represents 1 or 2 and Vout represents VDC. The oscillating current makes the VRm voltage rises up rapidly. As VRm voltage is larger than Vout+2Vth,n, the active rectifying MOS SWR is turned on and the oscillating current rushes into L_{WS} that the VRm voltage rises up rapidly due to L(di/dt) of rapid increase of current. As shown in FIG. 45Q, accordingly, the Sxm rapidly rises to switch on SWR and the on-resistance of SWR is minimized. As the resonant current reverses flowing direction and the L_{WS} continues flowing toward the output load, the VRm voltage falls down rapidly. As shown in FIG. 45Q, accordingly, the Sxm rapidly falls to switch off SWR. It is the “digital switch” mode of SMPS Switch Mode Power Supply. As The ASP/PFC wave shaper increases the slopes of the rising edge and falling edge that the on-resistance and power loss are reduced a lot. Based on the same wave shaping principle, FIG. L2 is the alternative design of 5R circuit with Schottky Diodes: FIG. L3 is the alternative design of 5R circuit with active MOS; FIG. L4 is the alternative design of 5R circuit with Schottky Diodes; FIG. L5 is the alternative design of 5R circuit with active MOS. It further shows the alternative design for the output voltage with the frequency tuning of the LC resonator. All the alternative and optional designs are circled with dotted lines. FIG. 45M is the complete schematics of the 5R Recycling Resonant Re-synchronous Rectifier Register having the complete set of ASP/PFC wave shaper, SMPS and A&D programmable LDO. FIG. 45N is the functional block diagram of the 5R Recycling Resonant Re-synchronous Rectifier Register having the complete set of ASP/PFC wave shaper. SMPS and A&D programmable LDO. It illustrate the most important key issue of the ASP/PFC Wave Shaper VI In-Phase Modulation. The ASP/PFC Wave Shaper VI In-Phase Modulation makes the necessary phase modulation of the V and I from 90 degree to be in-phase. The phase modulation from 90 degree to 0 in-phase, it increases the power-efficiency tremendously. If the voltages of V_{O,RECT}, V_{O,DC} and V_{O,LDO} are closed enough, it can consider the inductor sends the current through the series of switch gates of rectifier, DC/DC converter and LDO that the power resistance loss is minimized. Furthermore, with the enhanced wave shaped up switching type voltage waveform and recycling switching energy, the rectifier has very high power efficiency as more than 96%.

There are many way to manufacture the thin Film Battery/EC window. The Window 5R System W5RS further comprising thin film means being made of layer means being planarized with assistance of ultrasonic means and deposition means being cleaned with assistance of ultrasonic means. The thin films are deposited to be layers. The layer first deposited one interfacing layer, then plating and hardening the interfacing layer to form a well-crystallized foundation. Then, the Layer depositing on the well-crystallized foundation to grow the layer. For the mass production, the gas reaction sputtering process is preferred. The deposition comprises a gas reaction sputtering further comprising ultrasonic self-cleaning target to clean passion deposition on the target means.

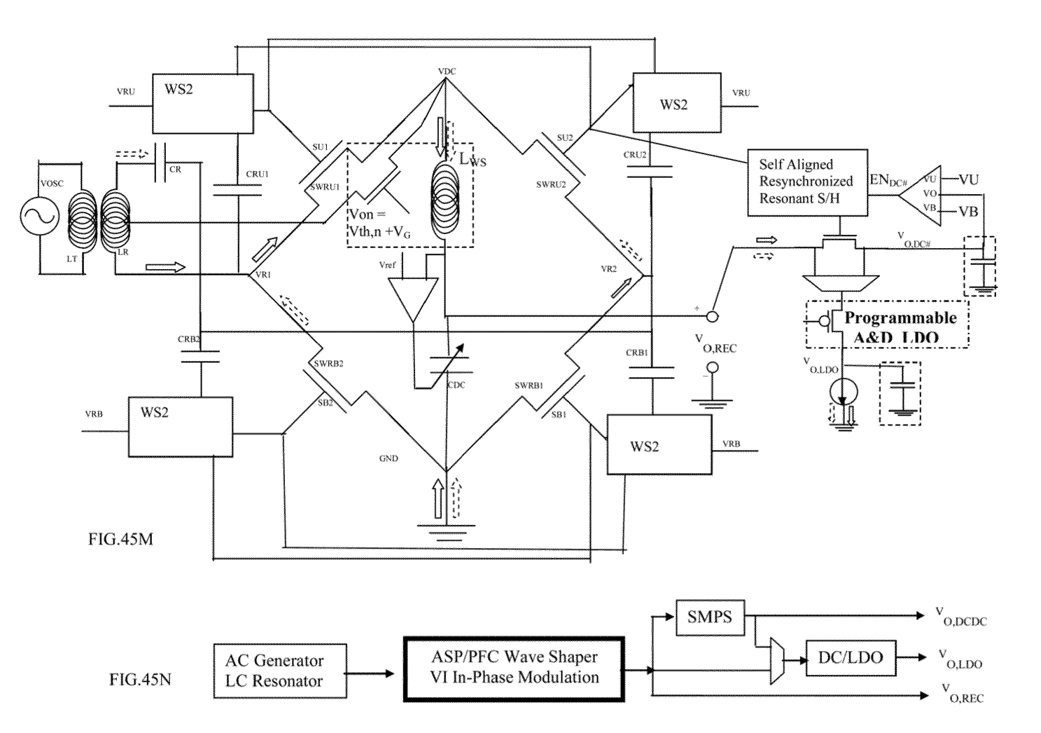

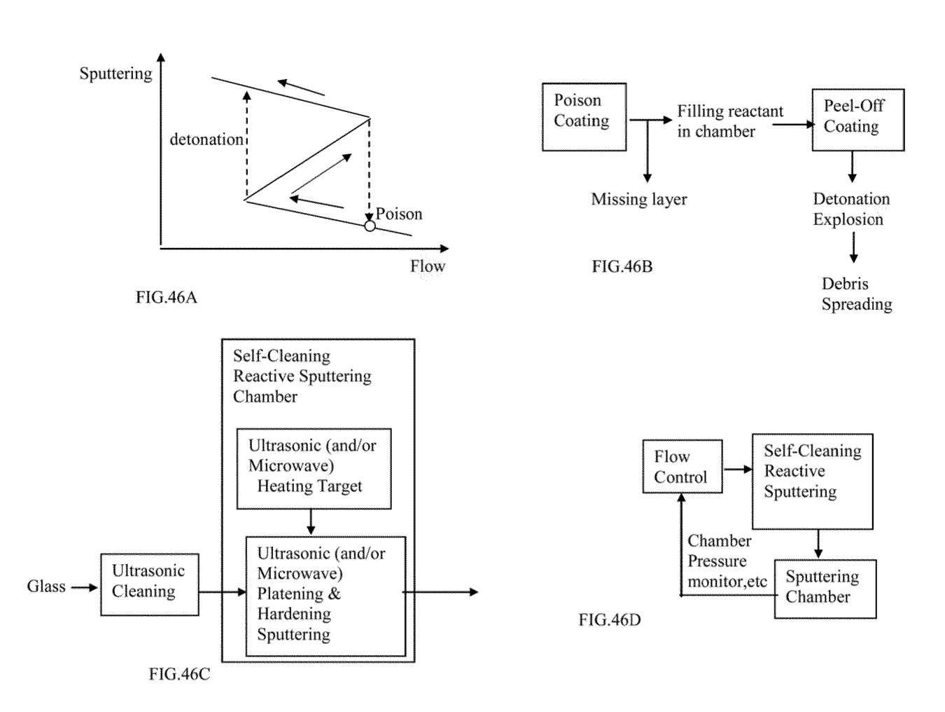

As shown in FIG. 46A, the gas reaction sputtering has the poison effect. The sputtering material will coat on the target. As shown in FIG. 46B, it causes the unstable operation of the sputtering chamber. It causes the missing layer and debris spreading problem. To avoid the poison problem in the sputtering chamber, it uses the ultrasonic to have the self-cleaning target. The sputtering material will be vaporized from the target instead of coating on the target. The system design of the self-cleaning sputtering chamber is as shown in FIG. 46D.

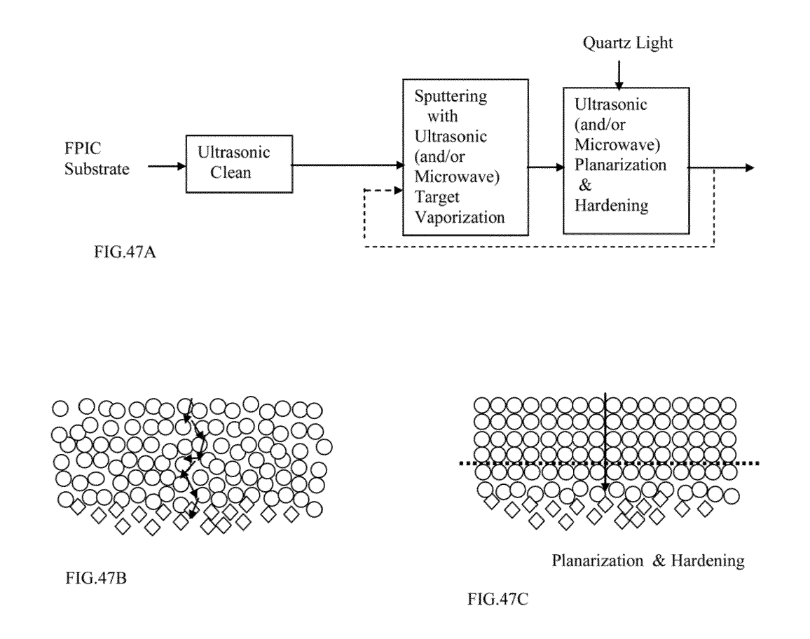

The general manufacture flow for the thin Film Battery/EC window is shown in FIG. 47A. Furthermore, as shown in FIG. 47A, the ultrasonic not only for the self-cleaning sputtering but also for the glass cleaning, plating and hardening, etc to enhance the performance of the EC window. The ion conduction layer is plating and hardening the layer with ultrasonic assisted means. As shown in FIG. 47B, the thin film battery, solar window and/or EC window layer grows the ion conduction layer without the plating and hardening. As shown by the solid line, the ion path zigzag and the ion has low speed. It causes the switch of the battery and/or EC window taking a much longer time. As shown in FIG. 47C, the EC window upper layer is deposited one thin layer. After the sputtering this thin layer, using the plating and hardening process to organized this thin interface layer. Then begin the formal sputtering of this layer. This layer will grow on the plating and hardening thin layer with the ordering way to form good crystal structure. As shown by the solid line, the ion movement is in straight line and the ion moves fast. The EC window can switch fast. The green technology integration system comprises the Layers. In general, the layers are deposited to be layers. The layer is first deposited to be one interfacing layer. Then apply the plating and hardening process to the interfacing layer to form a well-crystallized foundation. Then the Layer is deposited on the well-crystallized foundation to grow this layer. The layer is very much important for the ion conduction layer. It can increase the performance of the EC window a lot. Normally, the heating and hardening are done with the quartz light. The heating and hardening the layer with the versatile combination of the assisted ultrasonic and/or microwave have the plating effect, too. For example, the planarization platening is assisted with ultrasonic and the heating hardening is assisted with microwave.

FIG. 48 shows the application of the Anlinx & Milinx & Zilinx FSOC with the 18Less Green Technology for of Smart Window. As shown in FIG. 30B, FIG. 48A is the platform of the Anlinx & Milinx & Zilinx FSOC having the 18Less Green Technology for of Smart Window. As shown in FIG. 27C, FIG. 48B is the Anlinx & Milinx & Zilinx FSOC having the IP wrapper of Noise Isolation Technology for 18Less Green Technology for of Smart Window.

W5RS is the new standard promoted by the innovative company Tang System. “W5” represents “Wireless Wireline Weave Wishful Window”. “5R” represents “Recycling Resonant. Resynchronization Rectifying Regulator”. “W5RS” is the killer application product of Silicon Valley and “5R” is the killer core technology of Silicon Valley. Even for the WPC Qi and A4WP wireless power supply standards, the novel single stage 5R even can have the AC/DC power efficiency as high as 95% which is the highest record in all the world. S is System and Supply. While the invention has been particularly shown and described with reference to the preferred embodiments thereof, it will be understood by those skilled in the art that various changes in form and details may be made therein without departing from the spirit and scope of the invention.

We claim:

1. A Wireless Window 5R System W5RS means is constituted of Multimedia Window means, Electrochromic Window means and Solar Cell Panel said Solar Cell Panel means harvesting solar energy to be electric energy to provide power to said Multimedia Window means and Electrochromic Window means, said electrical energy further providing to smart grid and mobile means.

2. A Wireless Window 5R System W5RS means is constituted of Multimedia Window means and Solar Cell Panel, said Solar Cell Panel means harvesting solar energy to be electric energy to provide power to said Multimedia Window means.

3. A Wireless Window 5R System W5RS means is constituted of Electrochromic Window means and Solar Cell Panel, said Solar Cell Panel means harvesting solar energy to be electric energy to provide power to Electrochromic Window means.

4. A Wireless Window 5R System W5RS means according to claim 1 further comprising a micro-inverter means to convert said Solar Cell Panel means harvesting solar energy to be electric energy,
Said micro-inverter means adopting in-phase power injection to inject the energy with in-phase micro-inverter means to increase amplitude of injected energy waveform in phase to minimize phase interruption of said injected energy waveform.

5. A Wireless Window 5R System W5RS means according to claim 1 further comprising a micro-computer means to control said Multimedia Window means,
Said micro-computer means further comprising touching sensor means to have user interactive with said Multimedia Window means;

6. A Wireless Window 5R System W5RS means according to claim 1 further comprising a wireless power supply Recycling Resonant Resynchronization Rectifier Regulator 5R means;
said wireless power supply Recycling Resonant Resynchronization Rectifier Regulator 5R means being connected between LC resonator means and DC output loading means;
said wireless power supply Recycling Resonant Resynchronization Rectifier Regulator 5R means converting energy in said LC resonator means to be DC power to supply said DC output loading means;
said wireless power supply Recycling Resonant Resynchronization Rectifier Regulator 5R means having only one single stage to integrate conventional rectifier, DC/DC and LDO three stage to be single stage;
said wireless power supply Recycling Resonant Resynchronization Rectifier Regulator 5R means further comprising capacitors means biased at different level to have boost voltage to recycle resonating energy in said LC resonator means to turn on switch devices means in said wireless power supply Recycling Resonant Resynchronization Rectifier Regulator 5R means synchronously,
said capacitors means having one end been connected to output terminal of said LC resonator means and another end being connected to switching MOS devices means of rectifier means.

7. A Wireless Window 5R System W5RS means according to claim 1 further comprising a wireless power supply Recycling Resonant Resynchronization Rectifier means,
Said wireless power supply Recycling Resonant Resynchronization Rectifier means further comprising LC resonator means, switch means and capacitors means;
Said capacitor means being connected between said LC resonator means and said switch means,
Said switch means being weakly biased at proper biasing voltages;
As said LC resonator means resonating, said capacitors means driving said switch means with switching energy to switch-on and switch-off said switch device to perform rectifying function;
Said switching energy of said capacitor means being recycled through said LC resonator.

8. Wireless Window 5R System W5RS means according to claim 1 further comprising a wireless power supply Recycling Resonant Resynchronization Rectifier Regulator 5R means, said wireless power supply Recycling Resonant Resynchronization Rectifier Regulator 5R means further comprising wave-shaping means and switching means,
Said wave-shaping means shaping up switching voltage of said switching means to have sharp rising and falling edge to reduce on-resistance of said switching means in switching transition process.

9. A Wireless Window 5R System W5RS means according to claim 1 further comprising a overshootless LDO means to deliver said DC output power at an output voltage;
Said overshootless LDO means having one error amplifier means and voltage divider means;
said voltage divider means dividing said output voltage to generate a feedback voltage;
said error amplifier means having a reference voltage and said feedback voltage been connected as inputs;
a switching means connecting said reference voltage input terminal of said error amplifier means with feedback voltage input terminal of said error amplifier means as said feedback voltage being less than said reference voltage.

10. A Wireless Window 5R System W5RS means according to claim 1 further comprising a rippleless LDO means to deliver said DC output power at an output voltage;
said rippleless LDO means having one error amplifier means and voltage divider means;
said voltage divider means dividing said output voltage to generate a feedback voltage;
said error amplifier means having a reference voltage and said feedback voltage been connected as inputs;
biasing current injecting means modulating biasing current in said error amplifier means as said feedback voltage being not equal to said reference voltage to increase bandwidth of said error amplifier to speedup said error amplifier in correct direction in orthogonal conjugated common-mode accelerator mode.

11. A Wireless Window 5R System W5RS means according to claim 1 further comprising a programmable LDO which further comprising programmable analog LDO/digital LDO mechanism, brake mechanism, accelerator mechanism and steering-wheel mechanism,
Said programmable analog LDO/digital LDO being able to programmable to be high-gain for analog LDO and high-bandwidth for digital LDO;
Said brake mechanism being able to reduce the difference of input voltage of said steering-wheel mechanism;
Said accelerator mechanism being orthogonal conjugated with said steering-wheel mechanism to have fast reaction to ripple of output voltage.

12. A Wireless Window 5R System W5RS means according to claim 1 further comprising a smart battery charger means to drive battery means and said electrochromic window means,
Said a smart battery charger means further comprising switch mode power supply SMPS means, low drop-offset LDO type analog buffer means with the option of the addition of the H-Bridge means for discharging;
Said switch mode power supply SMPS means providing power to said low drop-offset LDO type analog buffer means, said low drop-offset LDO type analog buffer means providing power to said H-Bridge means;
said low drop-offset LDO type analog buffer means being either analog buffer means or LDO analog buffer means;
said H-Bridge means charging and discharging said battery means and said electrochromic window means with switches embedded in said H-Bridge means.

13. A Wireless Window 5R System W5RS means according to claim 1 further comprising a smart battery charger means to drive battery means and said electrochromic window means,
Said a smart battery charger means further comprising switch mode power supply SMPS means and H-Bridge means;
Said mode power supply SMPS means providing power to said H-Bridge means;
Said H-Bridge means further comprising low drop-offset LDO type analog buffer means and switches means;
said H-Bridge means charging and discharging said battery means and said electrochromic window means with said switches and said low drop-offset LDO type analog buffer embedded in said H-Bridge means;
said low drop-offset LDO type analog buffer means being either analog buffer means or LDO analog buffer means;
said low drop-offset LDO type analog buffer further providing rippleless RF-Noiseless output power to said battery means and said electrochromic window means according to specified input voltages of said low drop-offset LDO type analog buffer.

14. A Wireless Window 5R System W5RS means according to claim 1 further comprising Injectionless Locked PLL,
Said Injectionless Locked PLL further comprising a clock-divider means to divide clock and a phase frequency detector PFD means generate reset signal.
Said reset signal resetting said clock divider after each reset signal being generated by said phase frequency detector PFD means.

15. A Wireless Window 5R System W5RS means according to claim 1 further comprising ground-bounce-less output buffer,
Said ground-bounce less output buffer further comprising non-overlapping mechanism, tri-state mechanism and clamping mechanism,
Said clamping mechanism detecting undershoot of said ground-bounce-less output buffer and turning off said N type output device,
Said clamping mechanism detecting overshoot of said ground-bounce-less output buffer and turning off said P type output device.

16. Wireless Window 5R System W5RS means according to claim 1 further comprising substrate noiseless P&G plan having all the ground nets being connected together going through one LDO typed constant current source.

17. Window 5R System W5RS means according to claim 1 further comprising a high-power-efficiency conjugated power amplifier,
Said conjugated power amplifier taking analog signals of positive sliced data and negative sliced data to operate at amplifier B mode and/or amplifier C mode.

18. Window 5R System W5RS means according to claim 1 further comprising a high-power-efficiency conjugated power amplifier system,
Said conjugated power amplifier taking analog signals of positive sliced data and negative sliced data to operate at amplifier B mode and amplifier C mode,
Data stream coming from baseband being sliced to be said positive sliced data and said negative sliced data;
DACs converting said positive sliced data and said negative sliced data to be said analog signals of positive sliced data and negative sliced data.

19. Window 5R System W5RS means according to claim 1 further comprising smart fans:
said smart fans further comprising bladeless turbofan means and temperature sensor means;
said bladeless turbofan means circulating air for air conditioning;
said temperature sensor means detecting temperatures of air and said smart fans.

20. Window 5R System W5RS means according to claim 1 further comprising thin film means being made of layer means being planarized and hardening with option of assistance of versatile combination of ultrasonic means and microwave means and deposition means with option of being cleaned with assistance of ultrasonic means;
said thin film means being deposited to be layers
said layer first deposited one interfacing layer, then plating and hardening said interfacing layer to form a well-crystallized foundation means;
then said Layer depositing on said well-crystallized foundation means to grow said layer,
said deposition means comprising a gas reaction sputtering further comprising ultrasonic self-cleaning target means to clean passion deposition on said target means.
